(19) United States
(12) Patent Application Publication
(10) Pub. No.: US 2026/0253424 A1
(43) Pub. Date: Aug. 27, 2026

(54) Systems and Methods for Monitoring Trailing Objects

(71) Applicant: PERCIPIENT.AI INC., Santa Clara, CA (US)

(72) Inventors: Timo PYLVAENAEINEN, Menlo Park, CA (US); Ivan KOVTUN, San Joae, CA (US); Jerome BERCLAZ, San Jose, CA (US); Richard M. LANSKY, Boulder, CO (US); Mark A. SCIANNA, Campbell, CA (US); Mike HIGUERA, San Jose, CA (US); Yunfan YING, Princeton Junction, NJ (US); Atul KANAUJIA, San Jose, CA (US); Scott C. SUTTON, San Jose, CA (US); Girish NARANG, Santa Clara, CA (US); Vasudev PARAMESWARAN, Fremont, CA (US); Balan AYYAR, Oakton, VA (US)

(73) Assignee: PERCIPIENT.AI INC., Santa Clara, CA (US)

(21) Appl. No.: 18/909,809

(22) PCT Filed: Apr. 7, 2023
(86) PCT No.: PCT/US2023/017980

§ 371 Date: Oct. 8, 2024

Related U.S. Application Data
(60) Provisional application No. 63/329,327, filed on Apr. 8, 2022.
(60) Provisional application No. 63/337,595, filed on May 2, 2022.

(51) Int. Cl. G06V 20/58; G06T 11/65; G06V 10/774; G06V 20/40; G06V 20/62

(52) U.S. Cl. CPC G06V 20/58; G06T 11/65; G06V 10/774; G06V 20/41; G06V 20/49; G06V 20/625; G06T 2200/24; G06V 2201/08

(57) ABSTRACT

Method and system for identifying vehicles or other objects of interest along a route comprises at least one mobile data capture device capturing at least one data stream such as video of a rearward view as the vehicle, person or other object associated with the data capture device moves along a route. Detection and identification of objects as being of interest is determined by dividing a route into a plurality of route segments and determining whether a given candidate object or vehicle follows the lead object through multiple turns along the route. Unique identifiers such as license plates or anomalous object characteristics are used to determine whether an object appears in multiple route segments, permitting rapid analysis of a large volume of unstructured data to determine relationships between a lead object and one or more trailing objects.

### RELATED APPLICATIONS

This application is a conversion of U.S. Patent Application 63/329,327 filed 2022 Apr. 8. Further, this application is a continuation-in-part of PCT Application PCT/US21/13940, which in turn is a continuation-in-part of U.S. patent application Ser. No. 16/120,128 filed Aug. 31, 2018, which in turn is a conversion of U.S. Patent Application Ser. No. 62/553,725 filed Sep. 1, 2017. Still further, this application is a continuation-in-part of PCT Application No. PCT/US21/13940 filed Jan. 19, 2021, and also PCT Application No. PCT/US21/13932, both of which in turn claim the benefit of U.S. Patent Applications Ser. No. 62/962,928 and Ser. No. 62/962,929, both filed Jan. 17, 2020, and also U.S. Patent Application Ser. No. 63/072,934, filed Aug. 31, 2020. The present application claims the benefit of each of the foregoing, all of which are incorporated herein by reference.

### FIELD OF THE INVENTION

The present invention relates generally to computer vision systems configured for object detection and recognition and more particularly relates to computer vision systems including mobile systems configured to detect one or more objects including mobile objects in near real time and scale from a volume of multisensory unstructured data such as audio, video, still frame imagery, or other identifying data and further configured to analyze the data to determine the relationship of the detected objects such as sensors, vehicles and people to an operator or to previously processed data and patterns established for the route or area, to inform the operator including the routing of a mobile data capture device and identification of trailing objects including but not limited to sensors, people and vehicles. In a further aspect, synthetic data is generated for training of the system, and can include development of synthetic data sets configured to assist in identifying license plate characters or to assist in identifying object anomalies to facilitate distinguishing objects of interest from other similar objects. A still further aspect provides a user interface configured to permit a user to modify the weighting or other characteristics of data used in determining the aforesaid relationships whereby the automated processes of the invention yields refined assessments.

### BACKGROUND OF THE INVENTION

Conventional computer vision and machine learning systems are configured to identify objects, including people, cars, trucks, etc., by providing to those systems a quantity of training images that are evaluated in a neural network, for example by a convolutional neural network such as shown in FIG. 1. In the absence of such training images, these conventional systems are typically unable to identify the object of interest. In many situations it remains desirable to identify an individual or other object even if there is no picture or similar training image that enables the computer vision system to distinguish the object of interest from other objects having somewhat similar characteristics or features. For example, an observer who has seen an event, such as a person shoplifting, can probably identify the shoplifter if shown a picture, but the shoplifter's face is just one of many images contained in the video footage of the store's security system and there is no conventional way to extract the shoplifter's image from those hundreds or thousands of faces. Conventionally, given the dearth of better data, a sketch artist or a modern digital equivalent would be asked to create a composite image that resembles the suspect. However, this process is time consuming and, often, far from accurate.

Many, if not most, conventional object identification systems that employ computer vision attempt facial recognition where the objects of interest are people. Most such conventional systems have attempted to identify faces of people in the video feed by clustering images of the object, such that each face or individual in a sequence of video footage is represented by selecting a single picture from that footage. While conventional systems implement various embedding approaches, the approach of selecting a single picture typically results in systems that are highly inaccurate because they are typically incapable of selecting an optimal image when the face or individual appears multiple times throughout the video data, but with slight variations in head or body angle, position, lighting, shadowing, etc. Further, such conventional systems typically require significant time to process the volume of images of faces or other objects that may appear in a block of video footage, such as when those faces number in the thousands.

Another challenge faced by conventional facial recognition systems using conventional embedding techniques is the difficulty of mapping all images of the same person or face to exactly the same point in a multidimensional space. Additionally, conventional systems operate under the assumption that embeddings from images of the same person are closer to each other than to any embedding of a different person. In reality, there exists a small chance that embeddings of two different people are much closer than two embeddings of the same person, which conventional facial recognition systems fail to account for. In such instances, conventional systems can generate false positives that lead to erroneous conclusions.

Detecting and identifying objects presents additional challenges if the multiple objects have essentially identical appearance, such as a vehicle. In such cases conventional training techniques are inadequate. The challenges become even greater when the image capture device is mobile.

The result is that there has been a long felt need for a system that can synthesize accurately a representation of a face, a vehicle, or other object by extracting relevant data from video footage, still frame imagery, or other data feed. There has been a further long felt need for the ability to detect and identify objects that appear repeatedly in that data even when the data capture device is mobile. There has been a still further need to provide a system and method by which unique object details can be used to distinguish an object of interest from otherwise identical objects.

### SUMMARY OF THE INVENTION

The present invention is a multisensor processing platform for detecting, identifying and tracking any of entities, objects and activities, or combinations thereof through computer vision algorithms machine learning for the purpose of detecting surveillant environments, including routes and potentially surveilling objects including sensors, vehicles and people, and determining either in real time or from stored data whether an individual or object operating at least the data capture portion of the invention, including while traveling along a route, is being actively followed by one or more objects such as a vehicle or a team of vehicles, a person or a team of people, one or more UAV's, or similar. The multisensor data can comprise various types of unstructured data, for example, full motion video, still frame imagery, InfraRed sensor data, communication signals, geo-spatial imagery data, etc. In an embodiment, the present invention provides a computer vision-based solution that filters and organizes the unstructured data in a manner that enables a human operator to perform rapid assessment and decision-making including alerting by providing a sufficiently reduced and sorted data set that accurately summarizes the relevant elements of the data stream for decision making by a user. Embodiments can be either native or web-based.

In an embodiment, the system of the present invention includes a mobile data capture device that collects unstructured data representative of at least a substantially rearward view of the route that capture device has traveled, although multiple views may be captured in other embodiments. Depending upon the implementation, the data capture device (or, optionally, devices) can be mounted to any mobile object, whether a person, a vehicle, or other device. If the mobile capture device is linked to a lead pedestrian, the rearward view can be configured to monitor other pedestrians or any other object following the lead pedestrian. Similarly, if the camera is associated with a lead vehicle, the rearward view can be configured to monitor trailing vehicles. In at least some embodiments, GPS data representative of the route is also captured

The data stream and GPS data captured by the mobile device is then analyzed by, first, determining the route along which the lead pedestrian or vehicle travels and then, second, identifying turns in that routing. For further clarity, in some embodiments the routing can be compared to maps to confirm the turns in the route. The route is then divided into route segments based on the turns in the route. Each segment is then analyzed in order, beginning with the start of the route, by detecting the objects of interest, e.g., people or vehicles, appearing in that segment. As each segment is analyzed, a cumulative total is made of the number of segments in which a given object of interest appears.

Where the trailing objects are people, the detection and identification of those following the lead pedestrian are detected and identified in the manner taught by parent application PCT/US21/13940, referenced above, incorporated herein by reference, and further as taught hereinafter. However, if the trailing objects are vehicles, where multiple vehicles have substantially identical appearance, a different approach must be taken. In an embodiment, license plates can be read to better identify a given vehicle. However, license plates can be difficult to read at distance. To improve accuracy, license plates are analyzed character-by-character, and synthetic data is used to train the neural network that detects and identifies each character.

In some images, the license plate cannot be read, but the vehicles contain unique or anomalous characteristics that allow them to be identified accurately when sorted by the invention in accordance with a criteria, for example a confidence metric, and presented for further decision-making, such as by an operator. For example, a vehicle may have decals, paint defects, stripes, dents, or other unique characteristics. In addition, through the use of synthetic data, the neural network can be trained to recognize such anomalous characteristics.

Once the trailing objects have been identified, and a tally made of the number of segments in which a given vehicle appears, clustering and grouping steps are performed. In some embodiments, for each group of images identified as the same vehicle, a representative image is selected. By selection of such representative images and groupings, the captured data is distilled sufficiently that it can be presented to a user in a way that permits the user to rapidly assess the data and thus allows human analysts to contextualize their understanding of the multisensor data. Identification of potential vehicles of interest that have been captured across different segments of the route allows a human operator to quickly determine whether the vehicle in which both they and are in (with the mobile capture device are traveling) is being actively followed.

To assist a human analyst is assessing the data presented, in an embodiment a user interface displays the route traveled by the lead object, a timeline of the route, and a plurality of representative images organized according to the objects that appeared most frequently among the segments. Similar user interface screens permit various other user interactions as discussed in greater detail hereinafter.

It is one object of the present invention to provide a system, method and device by which large volumes of unstructured data representing objects trailing a lead object can be sorted and inspected, and animate or inanimate objects can be found and tabulated.

A still further object of the present invention is to detect a route traveled by an object such as a person or vehicle and to divide that route into segments based on turns in the route.

Yet another object of the invention is to store routing information together with correlated information including detected vehicles and objects of interest for use in subsequent instances where that same geographic area is traversed.

Yet a further object of the present invention is to group images of objects identified as the same in a plurality of frames, to choose a single image from those images, and to present that single image as representative of that object in that plurality of frames.

Another object of the present invention is to use synthetic data to train the system to recognize each character of a license plate and to analyze images of license plates on a character by character basis.

Still another object of the present invention is to train the system to recognize anomalous features of a vehicle through the use of synthetic data.

A still further object of the present invention is to provide a summary search report to a user comprising a plurality of representative images arranged by level of confidence in the accuracy of the search results.

Yet a further object of the invention is to provide a user interface by which an operator can revise and refine the detections, identifications and summarizations of the data performed by the system.

These and other objects of the invention can be better appreciated from the following Detailed Description of the Invention, taken together with the appended Figures briefly described below.

### THE FIGURES

FIG. 1 [Prior Art] describes a convolutional neural network typical of the prior art.

FIG. 2A shows in generalized block diagram form an embodiment of the overall system as a whole comprising the various inventions disclosed herein.

FIG. 2B illustrates in circuit block diagram form an embodiment of a system suited to host a neural network and perform the various processes of the inventions described herein.

FIG. 2C illustrates in generalized flow diagram form the processes comprising an embodiment of the invention.

FIG. 2D illustrates an approach for distinguishing a face from background imagery in accordance with an aspect of the invention.

FIG. 3A illustrates a single frame of a video sequence comprising multiple frames, and the division of that frame into segments where a face snippet is formed by placing a bounding box placed around the face of an individual appearing in a segment of a frame.

FIG. 3B illustrates in flow diagram form the overall process of retrieving a video sequence, dividing the sequence into frames and segmenting each frame of the video sequence.

FIG. 4 illustrates in generalized flow diagram form the process of analyzing a face snippet in a first neural network to develop an embedding, followed by further processing and classification.

FIG. 5A illustrates a process for evaluating a query in accordance with an embodiment of an aspect of the invention.

FIG. 5B illustrates an example of a query expressed in Boolean logic.

FIG. 6 illustrates a process in accordance with an embodiment of the invention for detecting faces or other objects in response to a query.

FIG. 7A illustrates a process in accordance with an embodiment of the invention for creating tracklets for summarizing detection of a person of interest in a sequence of frames of unstructured data such as video footage.

FIG. 7B illustrates how the process of FIG. 7A can result in grouping tracklets according to confidence level.

FIG. 8 is a graph of two probability distribution curves that depict how a balance between accuracy and data compression can be selected based on embedding distances, where the balance, and thus the confidence level associated with a detection or a series of detections, can be varied depending upon the application or the implementation.

FIG. 9A illustrates a process in accordance with an aspect of the invention for determining a confidence metric that two or more individuals are acting together.

FIG. 9B illustrates an example of a parse tree of the type interpreted by an embodiment of an aspect of the invention.

FIG. 10 illustrates the detection of a combination of faces and objects in accordance with an embodiment of an aspect of the invention.

FIG. 11 illustrates in generalized flow diagram form an embodiment of the second aspect of the invention.

FIG. 12 illustrates a process in accordance with an embodiment of an aspect of the invention for developing tracklets representing a record of an individual or object throughout a sequence of video frames, where an embedding is developing for each frame in which the individual or object of interest is detected.

FIG. 13 illustrates a process for determining a representative embedding from the tracklet's various embeddings.

FIGS. 14A-14B illustrate a layout optimization technique for organizing tracklets on a grid in accordance with an embodiment of the invention.

FIG. 15A illustrates a simplified view of clustering in accordance with an aspect of the invention.

FIG. 15B illustrates in flowchart form an exemplary embodiment for localized clustering of tracklets in accordance with an embodiment of the invention.

FIG. 15C illustrates a visualization of the clustering process of Figure of FIG. 15B.

FIG. 15D illustrates the result of the clustering process depicted in the embodiment of FIGS. 15B and 15C.

FIG. 16A illustrates a technique for highlighting similar tracklets in accordance with an embodiment of the invention.

FIGS. 16B-16C illustrate techniques for using highlighting and dimming as a way of emphasizing tracklets of greater interest in accordance with an embodiment of the invention.

FIG. 17 illustrates a curation and optional feedback technique in accordance with an embodiment of the invention.

FIGS. 18A-18C illustrate techniques for incorporating detection of color through the use of histograms derived from a defined color space.

FIG. 19 illustrates a report and feedback interface for providing a system output either to an operator or an automated process for performing further analysis.

FIG. 20 illustrates in simplified block diagram form an embodiment of a system capturing data such as a video stream and GPS data to monitor objects that may be trailing a lead object.

FIG. 21 depicts at a high level an embodiment of a system and process for monitoring tailing objects, for example, vehicles.

FIG. 22 illustrates an example of the segmentation of the route of a lead vehicle, person or other object.

FIG. 23 illustrates an embodiment of process for reading license plates including the use of synthetic data.

FIG. 24 illustrates an embodiment of a process for using synthetic data to train a system to detect anomalous details of a vehicle or other object

FIG. 25 illustrates an embodiment of a process for reading license plates using a fuzzy string approach.

FIG. 26 illustrates an embodiment of a process for reading license plates including aligning characters and computing character level confidence.

FIG. 27 illustrates a process for identifying tracklets of a vehicle that appear in multiple segments.

FIG. 28A illustrates in simplified form the user interface including the system output provided to a user for further action.

FIG. 28B illustrates a more robust version of FIG. 28A.

FIG. 29 illustrates in flow diagram form a generalized process in accordance with an embodiment of the present invention including certain optional elements.

FIG. 30 illustrates in flow diagram form an embodiment of a user interface to the system comprising certain of the functions available to an operator of the system.

FIG. 31 illustrates in flow diagram form a generalized view of an embodiment of one aspect of the invention, involving the interoperation of the man-machine interface and an embodiment of the automated system.

FIG. 32 illustrates in flow diagram form a generalized view of an aspect of the invention involving detecting stops of an object along a route.

FIG. 33 illustrates in generalized flow diagram form an embodiment of the edit functions of the operator interface of an aspect of the present invention.

FIG. 34 illustrates in generalized flow diagram form several aspects of functions available via the operator interface in accordance with an embodiment of an aspect of the invention.

FIG. 35 illustrates in generalized flow diagram form the iterative operation of an embodiment of the invention in response to inputs provided by an operator.

### DETAILED DESCRIPTION OF THE INVENTION

The present invention comprises multiple aspects, the overall goal of which is to identify people, vehicles or objects that may be following a lead person, vehicle or object where, in at least some embodiments, both the lead and the monitored trailing objects are mobile. In an aspect, the system captures data representative of an environment over time, incorporating multiple routes, and analyzing that data to help an operator distinguish among normal patterns of movement along routes in that environment and anomalous behavior that requires further consideration.

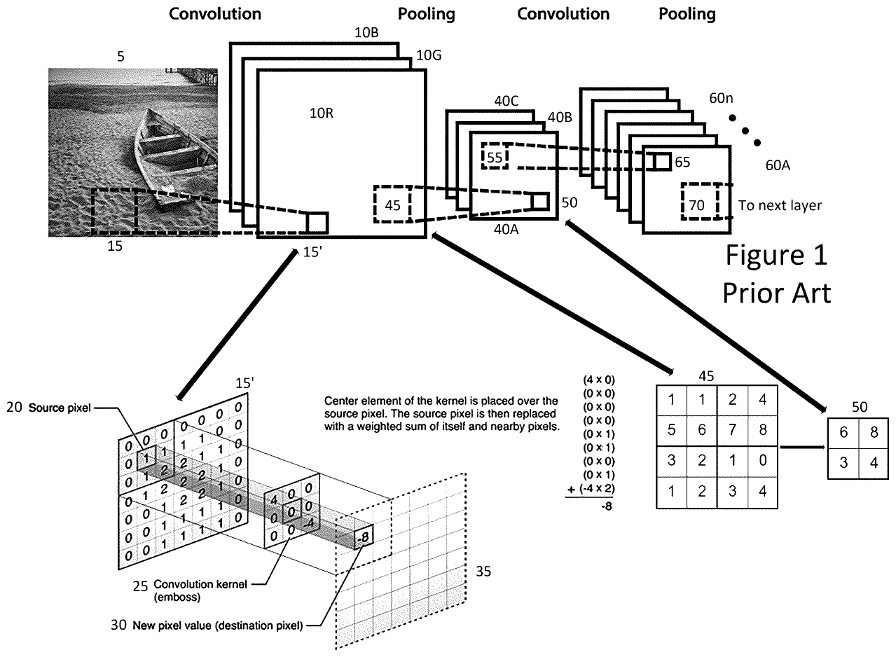

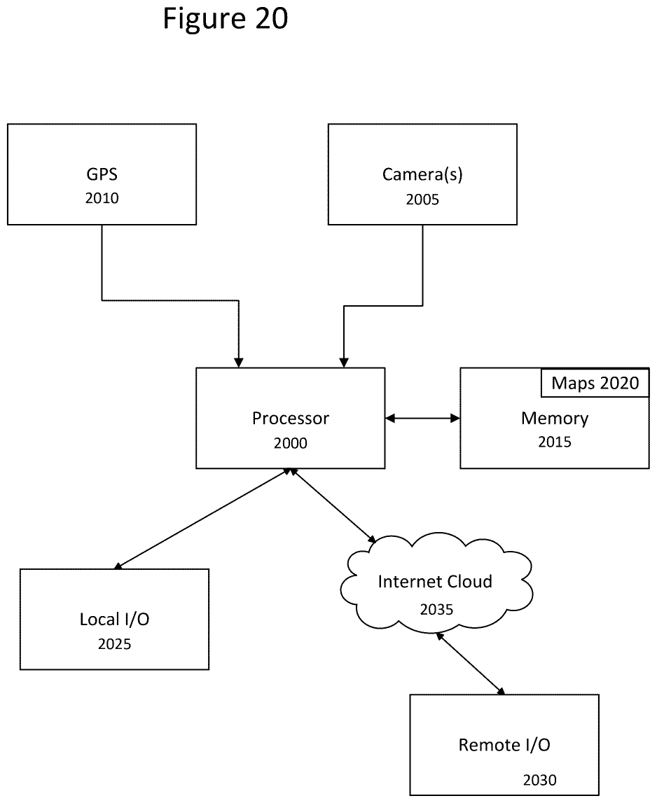

As discussed in more detail beginning with FIG. 20, one key aspect involves detecting turns in the lead's route and dividing the route into segments where the segments are defined as the route between turns. A related aspect of the invention involves the use of synthetic data to better train the system, including developing training data for, first, assisting in a character-by-character reading of license plates, and second for training the system to detect anomalous changes to a vehicle that provide substantial uniqueness to the vehicle. Other aspects involve identification and grouping of images of the same trailing object as a tracklet together with developing a count for the number of segments in which a trailing object is identified, including as appropriate clustering and identification of a representative image of a tracklet. A further aspect involves ranking the identified trailing objects and presenting them to a user in ranked fashion. These aspects of the present invention can be best appreciated when taken together with the following discussion of FIGS. 1-19.

As discussed briefly above, aspects of the present invention comprises a platform for quickly analyzing the content of a large amount of unstructured data, as well as executing queries directed to the content regarding the presence and location of various types of entities, inanimate objects, and activities captured in the content. For example, in full motion video, an analyst might want to know if a particular individual is captured in the data and if so the relationship to others that may also be present. An aspect of the invention is the ability to detect and recognize persons, objects and activities of interest using multisensor data in the same model substantially in real time with intuitive learning.

Viewed from a high level, the platform of the present invention comprises an object detection system which in turn comprises an object detector and an embedding network. The object detector is trainable to detect any class of objects, such as faces as well as inanimate objects such cars, backpacks, and so on.

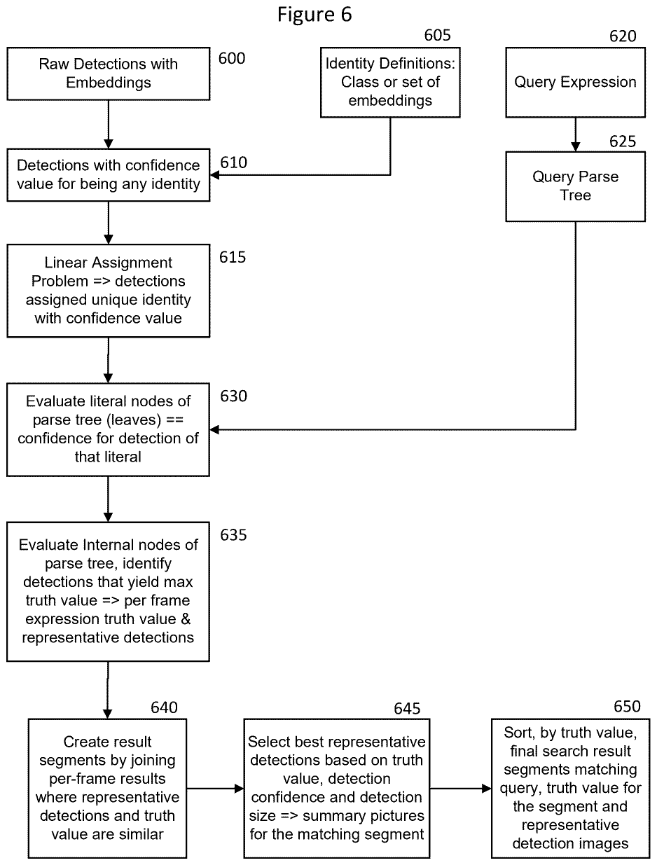

Drilling down, an embodiment of the platform comprises the following major components: a chain of processing units, a data saver, data storage, a reasoning engine, web services, report generation, and a User Interface. The processing units comprise a face detector, an object detector, an embedding extractor, clustering, an encoder, and person network discovery. In an embodiment, the face detector generates cropped bounding boxes around faces in an image such as a frame, or a segment of a frame, of video. In some such embodiments, video data supplemented with the generated bounding boxes may be presented for review to an operator or a processor-based algorithm for further review, such as to remove random or false positive bounding boxes, add bounding boxes around missed faces, or a combination thereof. It will be appreciated by those skilled in the art that the term “segment” is used herein in three different contexts, with a different meaning depending upon the context. As noted above, a frame can be divided into multiple pieces, or segments. Further, as discussed in connection with FIGS. 6A-6B et seq., a sequence of video data is sometimes described as a segment. Then, as more particularly described in connection with FIG. 20 et seq., a portion of a route, such as might be traveled by a vehicle or a pedestrian, is sometimes referred to as a “route segment.”

As noted above, in an embodiment the facial images within each frame are inputted to the embedding network to produce a feature vector for each such facial image, for example a 128-dimensional vector of unit length. The embedding network is trained to map facial images of the same individual to a common individual map, for example the same 128-dimensional vector. Because of how deep neural networks are trained if the training involves the use of gradient descent, such an embedding network is a continuous and differentiable mapping from image space (e.g. 160×160×3 tensors) to, in this case, S¹²⁷, i.e. the unit sphere embedded in 128-dimensional space. Accordingly, the difficulty of mapping all images of the same person to exactly the same point is a significant challenge experienced by conventional facial recognition systems.

Although there are two major aspects to the present invention, both aspects share a common origin in the multisensor processing system and many of the functionalities extant in that system. Thus, the platform and its functionalities are discussed first hereinafter, followed by a discussion of the first major aspect and then the second major aspect, as described in the Summary of the Invention, above.

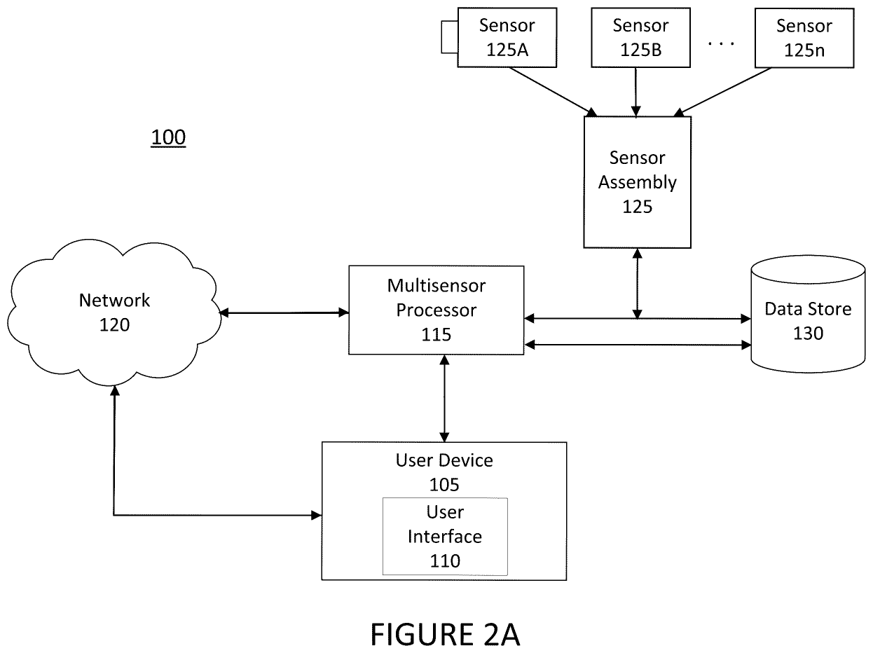

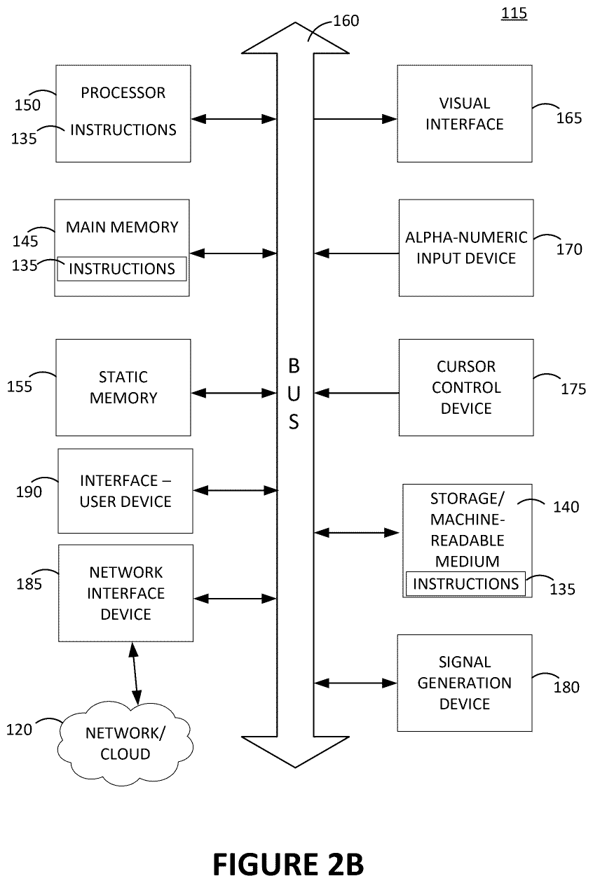

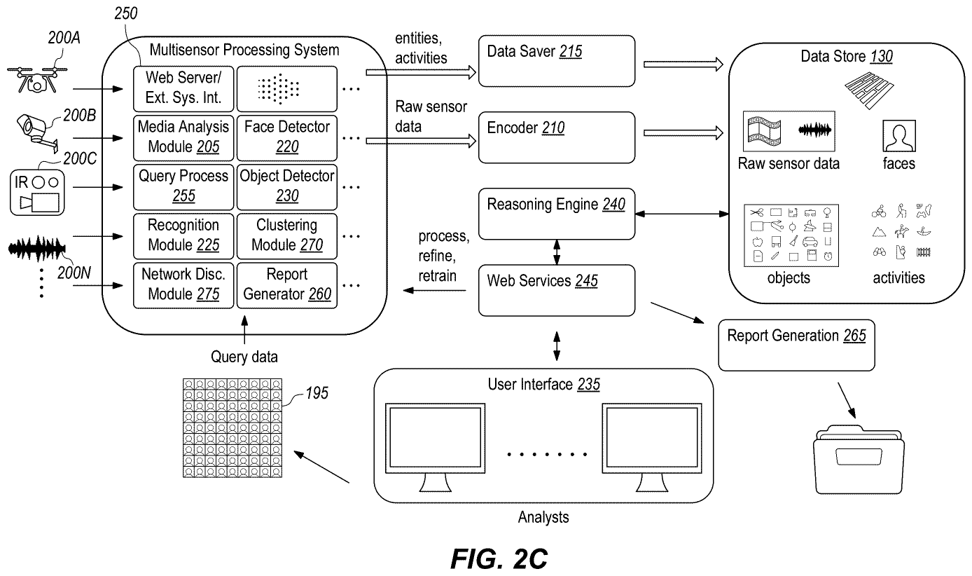

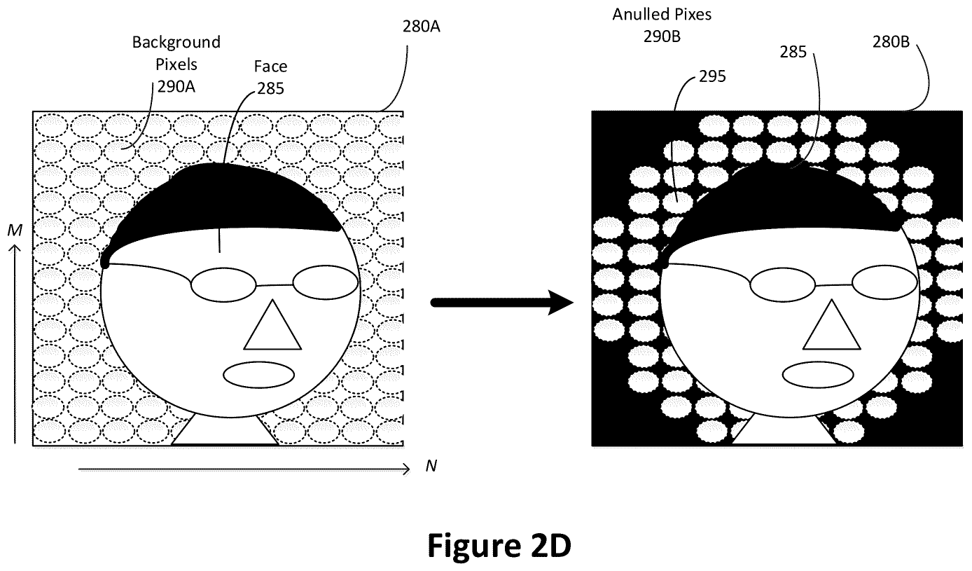

Referring first to FIG. 2A, shown therein is a generalized view of an embodiment of a system 100 and its processes comprising the various inventions as described hereinafter. The system 100 can be appreciated in the whole. The system 100 comprises a user device 105 having a user interface 110. A user of the system communicates with a multisensor processor 115 either directly or through a network connection which can be a local network, the internet, a private cloud or any other suitable network. The multisensory processor, described in greater detail in connection with FIG. 2B, receives input from and communicates instructions to a sensor assembly 125 which further comprises sensors 125A-125n. The sensor assembly can also provide sensor input to a data store 130, and in some embodiments can communicate bidirectionally with the data store 130.

Next with reference to FIG. 2B, shown therein in block diagram form is an embodiment of the multisensor processor system or machine 115 suitable for executing the processes and methods of the present invention. In particular, the processor 115 of FIG. 2B is a computer system that can read instructions 135 from a machine-readable medium or storage unit 140 into main memory 145 and execute them in one or more processors 150. Instructions 135, which comprise program code or software, cause the machine 115 to perform any one or more of the methodologies discussed herein. In alternative embodiments, the machine 115 operates as a standalone device or may be connected to other machines via a network or other suitable architecture. In a networked deployment, the machine may operate in the capacity of a server machine or a client machine in a server-client network environment, or as a peer machine in a peer-to-peer (or distributed) network environment. In some embodiments, system 100 is architected to run on a network, for example, a cloud network (e.g., AWS) or an on-premise data center network. Depending upon the embodiment, the application of the present invention can be web-based, i.e., accessed from a browser, or can be a native application.

The multisensor processor 115 can be a server computer such as maintained on premises or in a cloud network, a client computer, a personal computer (PC), a tablet PC, a set-top box (STB), a personal digital assistant (PDA), a cellular telephone, a smartphone, a web appliance, a network router, switch or bridge, or any machine capable of executing instructions 135 (sequential or otherwise) that specify actions to be taken by that machine. Further, while only a single machine is illustrated, the term “machine” shall also be taken to include any collection of machines that individually or jointly execute instructions 135 to perform any one or more of the methods or processes discussed herein.

In at least some embodiments, the multisensor processor 115 comprises one or more processors 150. Each processor of the one or more processors 150 can comprise a central processing unit (CPU), a graphics processing unit (GPU), a digital signal processor (DSP), a controller, one or more application specific integrated circuits (ASICs), one or more radio-frequency integrated circuits (RFICs), or any combination of these. In an embodiment, the machine 115 further comprises static memory 155 together with main memory 145, which are configured to communicate with each other via bus 160. The machine 115 can further include one or more visual displays as well as associated interfaces, all indicated at 165, for displaying messages or data. The visual displays may be of any suitable type, such as monitors, head-up displays, windows, projectors, touch enabled devices, and so on. At least some embodiments further comprise an alphanumeric input device 170 such as a keyboard, touchpad or touchscreen or similar, together with a pointing or other cursor control device 175 such as a mouse, a trackball, a joystick, a motion sensor, a touchpad, a tablet, and so on), a storage unit or machine-readable medium 140 wherein the machine-readable instructions 135 are stored, a signal generation device 180 such as a speaker, and a network interface device 185. A user device interface 190 communicates bidirectionally with user devices 120 (FIG. 2A). In an embodiment, all of the foregoing are configured to communicate via the bus 160, which can further comprise a plurality of buses, including specialized buses, depending upon the particular implementation.

Although shown in FIG. 2B as residing in storage unit or machine-readable medium 140, instructions 135 (e.g., software) for causing the execution of any of the one or more of the methodologies, processes or functions described herein can also reside, completely or at least partially, within the main memory 145 or within the processor 150 (e.g., within a processor's cache memory) during execution thereof by the multisensor processor 115. In at least some embodiments, main memory 145 and processor 150 also can comprise, in part, machine-readable media. The instructions 135 (e.g., software) can also be transmitted or received over a network 120 via the network interface device 185.

While machine-readable medium or storage device 140 is shown in an example embodiment to be a single medium, the term “machine-readable medium” should be taken to include a single medium or multiple media (e.g., a centralized or distributed database, or associated caches and servers) able to store instructions (e.g., instructions 135). The term “machine-readable medium” includes any medium that is capable of storing instructions (e.g., instructions 135) for execution by the machine and that cause the machine to perform any one or more of the methodologies disclosed herein. The term “machine-readable medium” includes, but is not limited to, data repositories in the form of solid-state memories, optical media, and magnetic media. The storage device 140 can be the same device as data store 130 (FIG. 2A) or can be a separate device which communicates with data store 130.

FIG. 2C illustrates, at a high level, an embodiment of the software functionalities implemented in an exemplary system 100 shown generally in FIG. 2A, including an embodiment of those functionalities operating in the multisensor processor 115 shown in FIG. 2B. Thus, inputs 200A-200n can be video or other sensory input from a drone 200A, from a security camera 200B, a video camera 2000, or any of a wide variety of other input device 200n capable of providing data sufficient to at least assist in identifying an animate or inanimate object. It will be appreciated that combinations of different types of data can be used together for the analysis performed by the system. For example, in some embodiments, still frame imagery can be used in combination with video footage. In other embodiments, a series of still frame images can serve as the gallery. Still further, while organizing the input feed chronologically is perhaps the most common, arranging the input data either by lat/long or landmarks or relative position to other data sources, or numerous other methods, can also be used in the present invention. Further, the multisensor data can comprise live feed or previously recorded data. The data from the sensors 200A-200n is ingested by the processor 115 through a media analysis module 205. In addition to the software functionalities operating within the multisensor processor 115, described in more detail below, the system of FIG. 2C comprises encoders 210 that receive entities (such as faces and/or objects) and activities from the multisensor processor 115. Further, a data saver 215 receives raw sensor data from processor 115, although in some embodiments raw video data can be compressed using video encoding techniques such as H.264 or H.265. Both the encoders and the data saver provide their respective data to the data store 130 in the form of raw sensor data from data saver 210 and faces, objects, and activities from encoders 205. Where the sensor data is video, the raw sensor data can be compressed in either the encoders or the data saver using video encoding techniques, for example, H.264 & H.265 encoding.

Where the multisensor data from inputs 200A-200n includes full motion video from terrestrial or other sensors, the processor 115 can, in an embodiment, comprise a face detector 220 chained with a recognition module 225 which comprises an embedding extractor, and an object detector 230. In an embodiment, the face detector 220 and object detector 230 can employ a single shot multibox detector (SSD) network, which is a form of convolutional neural network. SSD's characteristically perform the tasks of object localization and classification in a single forward pass of the network, using a technique for bounding box regression such that the network both detects objects and also classifies those detected objects. Using, for example, the FaceNet neural network architecture, the face recognition module 225 represents each face with an “embedding”, which is a 128-dimensional vector designed to capture the identity of the face, and to be invariant to nuisance factors such as viewing conditions, the person's age, glasses, hairstyle, etc. Alternatively, various other architectures, of which SphereFace is one example, can also be used. In embodiments having other types of sensors, other appropriate detectors and recognizers may be used. Machine learning algorithms may be applied to combine results from the various sensor types to improve detection and classification of the objects, e.g., faces or inanimate objects. In an embodiment, the embeddings of the faces and objects comprise at least part of the data saved by the data saver 210 and encoders 205 to the data store 130. The embedding and entities detections, as well as the raw data, can then be made available for querying, which can be performed in near real time or at some later time.

Queries to the data are initiated by analysts or other users through a user interface 235 which connects bidirectionally to a reasoning engine 240, typically through network 120 (FIG. 2A) via a web services interface 245, although in some embodiments the data is all local and the software application operates as a native app. In an embodiment, the web services interface 245 can also communicate with the modules of the processor 115, typically through a web services external system interface 250. The web services comprise the interface into the back-end system to allow users to interact with the system. In an embodiment, the web services use the Apache web services framework to host services that the user interface can call, although numerous other frameworks are known to those skilled in the art and are acceptable alternatives. Likewise, the system can be implemented in a local machine, which may include a GPU, so that queries from the UI and processing all execute on the same machine.

Queries are processed in the processor 115 by a query process 255. The user interface 235 allows querying of the multisensor data for faces and objects (collectively, entities) and activities. One exemplary query can be “Find all images in the data from multiple sensors where the person in a given photograph appears”. Another example might be, “Did John Doe drive into the parking lot in a red car, meet Jane Doe, who handed him a bag”. Alternatively, in an embodiment, a visual GUI can be helpful for constructing queries. The reasoning engine 240, which typically executes in processor 115, takes queries from the user interface via web services and quickly reasons through, or examines, the entity data in data store 130 to determine if there are entities or activities that match the analysis query. In an embodiment, the system geo-correlates the multisensor data to provide a comprehensive visualization of all relevant data in a single model. Once that visualization of the relevant data is complete, a report generator module 260 in the processor 115 saves the results of various queries and generates a report through the report generation step 265. In an embodiment, the report can also include any related analysis or other data that the user has input into the system.

The data saver 215 receives output from the processing system and saves the data on the data store 130, although in some embodiments the functions may be integrated. In an embodiment, the data from processing is stored in a columnar data storage format such as Parquet that can be loaded by the search backend and searched for specific embeddings or object types quickly. The search data can be stored in the cloud (e.g. AWS S3), on premise using HDFS (Hadoop Distributed File System), NFS, or some other scalable storage. In some embodiments, web services 245 together with user interface (UI) 235 provide users such as analysts with access to the platform of the invention through a web-based interface. The web based interface provides a REST API to the UI. The web based interface, in turn, communicates with the various components with remote procedure calls implemented using Apache Thrift. This allows various components to be written in different languages.

In an embodiment, the UI is implemented using React and node.js, and is a fully featured client side application. The UI retrieves content from the various back-end components via REST calls to web service. The User Interface supports upload and processing of recorded or live data. The User Interface supports generation of query data by examining the recorded or live data. For example, in the case of video, it supports generation of face snippets from uploaded photograph or from live video, to be used for querying. Upon receiving results from the Reasoning Engine via the Web Service, the UI displays results on a webpage.

In some embodiments, the UI allows a human to inspect and confirm results. When confirmed the results can be augmented with the query data as additional examples, which improves accuracy of the system. The UI augments the raw sensor data with query results. In the case of video, results include keyframe information which indicates—as fractions of the total frame dimensions—the bounding boxes of the detections in each frame that yielded the result. When the corresponding result is selected in the UI, the video is overlaid by the UI with visualizations indicating why the algorithms believe the query matches this portion of the video. An important benefit of this aspect of at least some embodiments is that such summary visualizations support “at a glance” verification of the correctness of the result. This ease of verification becomes more important when the query is more complex. Thus, if the query is “Did John drive a red car to meet Jane, who handed him a bag”, a desirable result would be a thumbnail, viewable by the user, that shows John in a red car and receiving an object from Jane. One way of achieving this is to display confidence measures as reported by the Reasoning Engine. Using fractions instead of actual coordinates makes the data independent of the actual video resolution, which makes it easier to provide encodings of the video at various resolutions.

Continuing the use of video data as an example, in an embodiment the UI displays a bounding box around each face, creating a face snippet. As the video plays back, the overlay is interpolated from key-frame to key-frame, so that bounding box information does not need to be transmitted for every frame. This decouples the video (which needs high bandwidth) from the augmentation data (which only needs low bandwidth). This also allows caching the actual video content closer to the client. While the augmentations are query and context specific and subject to change during analysts' workflow, the video remains the same.

In some embodiments, certain pre-filtering of face snippets may be performed before face embeddings are extracted. For example, the face snippet can be scaled to a fixed size, typically but not necessarily square, of 160×160 pixels. In many instances, the snippet with the individual's face will also include some pixels from the background, which are not helpful to the embedding extraction. Likewise, it is desirable for the embeddings to be as invariant as possible to rotation or tilting of the face. This is best achieved by emphasizing the true face of the individual, and de-emphasizing the background. Since an individual's face typically occupies a central portion of the face snippet, one approach is to identify, during training, an average best radius which can then be used during run time, or recognition. An alternative approach is to detect landmarks, such as eyes, nose, mouth, ears, using any of the face landmark detection algorithms known to those skilled in the art. Knowledge of the eyes, for example, will allow us to define a more precise radius based upon the eye locations. For example, we might set the radius as R=s*d_e, where d_e is the average distance of each eye from the center of the scaled snippet, and s is a predetermined scaling factor.

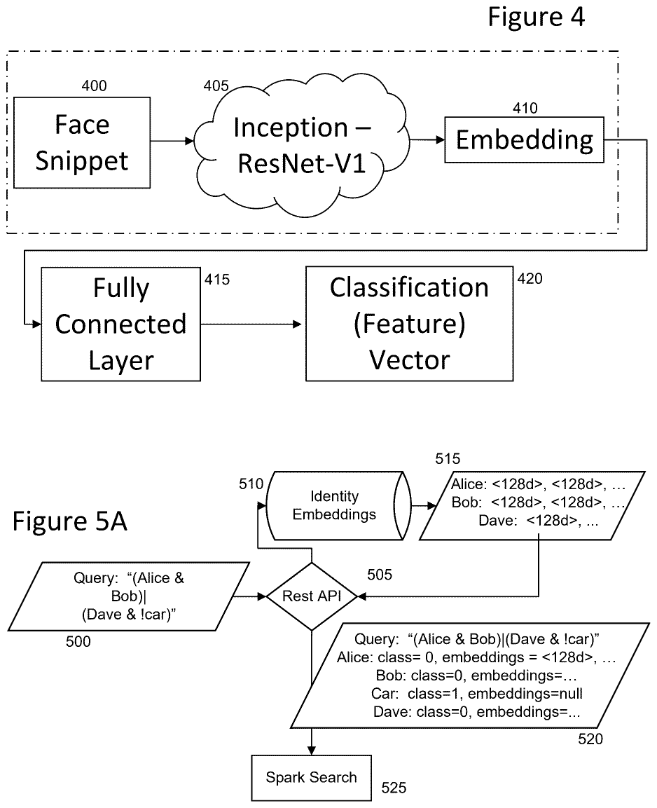

Regardless of the method used to identify background from the actual face, once that is complete, the background is preferably eliminated or at least deemphasized. Referring to FIG. 2D, a vignetting or filtering technique used in connection with the aforementioned bounding boxes and face snippets can be better appreciated. In most segments of a video frame, the bounding box that surrounds a detected face includes aspects of the background that are not relevant to the detection. Through a vignetting or filtering technique, that irrelevant data is excised. Thus, bounding box 280A includes a face 285 and background pixels 290A. By applying a vignetting filter or other suitable algorithmic filter, the background pixels 290A are annulled, or “zeroed out”, and bounding box 290A becomes box 290A where face 285 is surrounded by 290B. A separation layer 295, comprising a few pixels for example, can be provided between the face 285 and the annulled pixels 290A to help ensure that no relevant pixels are lost through the filtering step. The annulled pixels can be the result of any suitable technique, for example being darkened, blurred, or converted to a color easily distinguished from the features of the face or other object. More details of the sequence for isolating the face will be discussed hereinafter in connection with FIG. 4.

The video processing platform for recognition of objects within video data provides functionality for analysts to more quickly, accurately, and efficiently assess large amounts of video data than historically possible and thus to enable the analysts to generate reports 265 (FIG. 2C) that permit top decision-makers to have actionable information more promptly. The video processing platform for recognition within video data enables the agent to build a story with his notes and a collection of scenes or video snippets. Each of these along with the notes provided can be organized in any order or time order. The report automatically provides a timeline view or geographical view on a map.

To better understand the operation of the system of the first major aspect of the invention, where the objective is to identify appearances of a known person in unstructured data, and where at least one image of the person of interest is available, consider the example of an instantiation of the multisensor processor system where the multisensor data includes full motion video. In such an instance and again referring in part to FIG. 2C, the relevant processing modules include the face detector 220, the recognition module 225, the object detector 230, a clustering module 270 and a person network discovery module 275. The instantiation also includes the encoders 210, the data saver 215, the data store 130, the reasoning engine 240, web services 245, and the user interface 235.

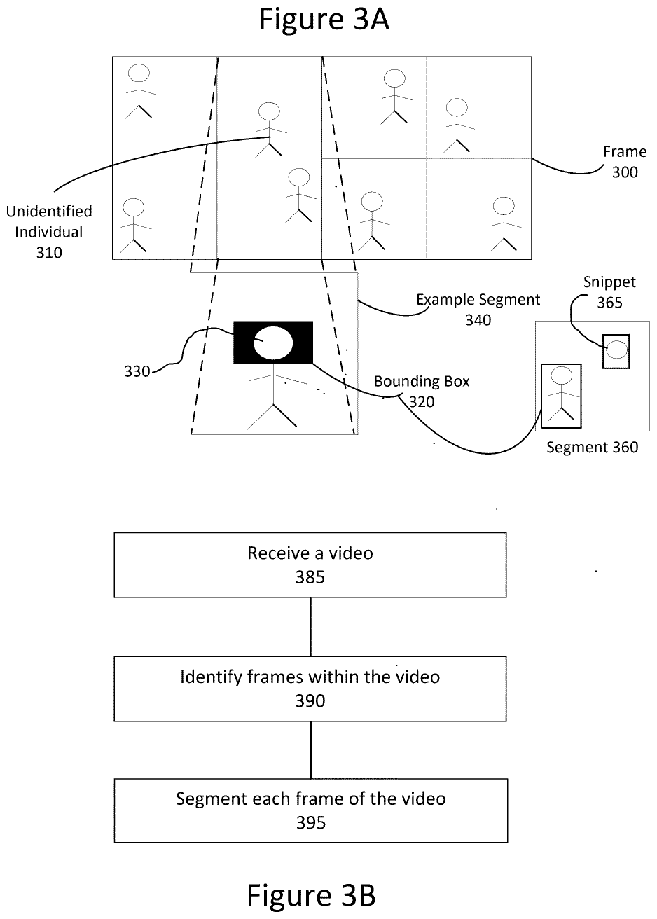

In this example, face detection of faces in the full motion video is performed as follows, where the video comprises a sequence of frames and each frame is essentially a still, or static, image or photograph. An object recognition algorithm, for example an SSD detection algorithm as discussed above, is trained on a wide variety of challenging samples for face detection. Using this approach, and with reference to FIGS. 3A-3C, an embodiment of the face detection method of the present invention processes a frame 300 and detects one or more unidentified individuals 310. The process thereupon produces a list of bounding boxes 320 surrounding faces 330. In an embodiment, the process also develops a detection confidence, and notes the temporal location in the video identifying the frame where each face was found. The spatial location within a given frame can also be noted.

To account for the potential presence of faces that appear small in the context of the entire frame, frames can be cropped into n images, or segments 340, and the face recognition algorithm is then run on each segment 340. The process is broadly defined by FIG. 3B, where a video is received at step 345, for example as a live feed from sensor 2000, and then divided into frames as shown at step 350. The frames are then segmented at step 355 into any convenient number of segments, where, for example, the number of segments can be selected based in part on the anticipated size of a face.

In some instances, the face detection algorithm may fail to detect a face because of small size or other inhibiting factors, but the object detector (discussed in greater detail below) identifies the entire person. In such an instance the object detector applies a bounding box around the entire body of that individual, as shown at 360 in FIG. 2A. For greater accuracy in such an instance, portions of a segment may be further isolated by selecting a snippet 365, comprising only the face. The face detection algorithm is then run on those snippets.

Again with reference to the system of FIG. 2C, in an embodiment object detection is performed using an SSD algorithm in a manner similar to that described above for faces. The object detector 230 can be trained on synthetic data generated by game engines. As with faces, the object detector produces a list of bounding boxes, the class of objects, a detection confidence metric, and a temporal location identifying the frame of video where the detected object was found.

In an embodiment, face recognition as performed by the recognition module 225, or the FRC module, uses a facial recognition algorithm, for example, the FaceNet algorithm, to convert a face snippet into an embedding which essentially captures the true identity of the face while remaining invariant to perturbations of the face arising from variables such as eye-glasses, facial hair, headwear, pose, illumination, facial expression, etc. The output of the face recognizer is, for example, a 128 dimension vector, given a face snippet as input. In at least some embodiments, during training the neural network is trained to classify all training identities. The ground truth classification is represented with a one-hot vector. Other embodiments can use triplet loss or other techniques to train the neural network.

Training from face snippets can be performed by any of a number of different deep convolutional networks, for example Inception-Resnet101_v1d or similar, where residual connections are used in combination with an Inception network to improve accuracy and computational efficiency. Such an alternative process is shown in FIG. 4 where a face snippet 400 is processed using Inception-ResNet-V1, shown at 405, to develop an embedding vector 410. For detection and classification during training, the embedding 410 is then processed through a convolutional neural network having a fully connected layer, shown at 415, to develop a classification or feature vector 420. Rectangular bounding boxes containing a detected face are expanded along one axis to a square to avoid disproportionate faces and then scaled to the fixed size as discussed above. During recognition, only steps 400-405-410 are used. In an embodiment, classification performance is improved during training by generating several snippets of the same face.

The reasoning engine 240 (FIG. 2C) is, in an embodiment, configured to query the detection data produced by the face and object detectors and return results very fast. To this end, the reasoning engine employs a distributed processing system such as Apache Spark in a horizontally scalable way that enables rapid searching through large volumes, e.g. millions, of face embeddings and object detections. In an embodiment, queries involving identities and objects can be structured using Boolean expression. For specific identities, the cohort database is queried for sample embeddings matching the specified name. A designator such as a colon (“:”) allows identification of a class of objects rather than a person. Class terms, in the example “:car”, do not carry embeddings but instead are generic terms: any car matches “:car”. Similarly, any face in the data store will match “:face”. Specific examples of an item in a class can be identified if the network is trained to produce suitable embeddings for a given class of objects. As one example, a specific car (as identified e.g. by license plate), bag or phone could be part of the query if a network is trained to produce suitable embeddings for a given class.

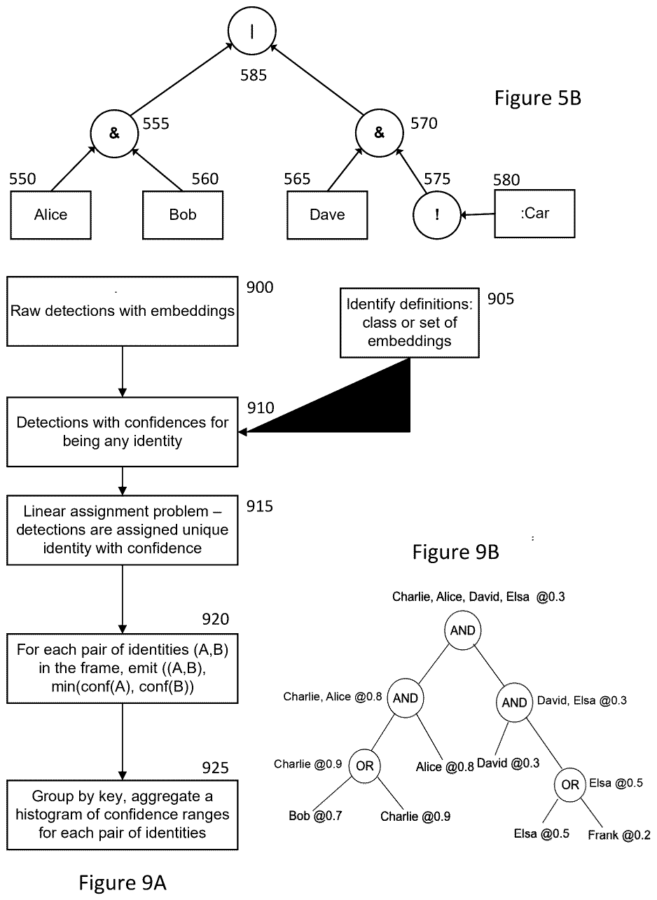

As noted above, in an embodiment the search data contains, in addition to the query string, the definitions of every literal appearing in the query. [It will be appreciated by those skilled in the art that a “literal” in this context means a value assigned to a constant variable.] Each token level detection, that is, each element in the query, is processed through a parse-tree of the query. For example, and as illustrated in FIG. 5A, the query “(Alice & Bob)|(Dave & !:car)”, shown at 500, will first be received by the REST API back-end 505, and will be split into operators to extract literals. Responsive embeddings in the data store or other memory location are identified at 515 and the response returned to the REST API. Embeddings set to null indicate that any car detection is of interest. Response to the class portion of the query is then added, resulting in the output seen at 520. The result is then forwarded to the SPARK-based search back-end 525.

The process of FIG. 5A is illustrated in Boolean form in FIG. 5B, where detections for each frame are evaluated against the literals in parse tree order, from bottom to top: Alice, Bob, Dave and :car. The query is first evaluated for instances in which both Alice (550) and (“&”, 555) Bob (560) are present, and also Dave (565) and (“&”, 570) any (“!”, 575) car (“:car”, 580) are present. The Boolean intersection of those results is determined at 585 for the final result. In an embodiment, detections can only match if they represent the same class.

If embeddings for the specific entities are provided, then a level of confidence in the accuracy of the match is determined by the shortest distance between the embedding for the detection in the video frame to any of the samples provided for the literal. It will be appreciated by those skilled in the art that ‘distance’ in context means vector distance, where both the embedding for the detected face and the embedding of the training sample are characterized as vectors, for example 128-bit vectors as discussed above. In an embodiment, an empirically derived formula can be used to map the distance into a confidence range of 0 to 1 or other suitable range. This empirical formula is typically tuned/trained so that the confidence metric is statistically meaningful for a given context. For example, the formula may be configured such that a set of matches with confidence 0.5 is expected to have 50% true matches. In other implementations, perhaps requiring that a more rigorous standard be met for a match to be deemed reliable, a confidence of 0.5 may indicate a higher percentage of true matches. Less stringent standards may also be implemented by adjusting the formula. It will be appreciated by those skilled in the art that the level of acceptable error varies with the application. In some cases it is possible to map the confidence to a probability that a given face matches a person of interest by the use of Bayes rule. In such cases the prior probability of the person of interest being present in the camera view may be known, for example, via news, or some other data. In such cases, the prior probability and the likelihood of a match can be used in Bayes rule to determine the probability that the given face matches the person of interest.

In an embodiment, for literals not carrying sample embeddings, the match confidence is simply the detection confidence. This should represent the likelihood that the detection actually represents the indicated class and again should be tuned to be statistically meaningful. As noted above, for implementation simplicity, in an embodiment detections can only match if they are of the same class, so the confidence value for detections in different classes is zero. Alternatively, in some embodiments, detections are created that exhibit a probability of being an instance of one or more classes. In such an alternative embodiment, for any given frame the system gives the “best guess” for any given class, which can, for example, be articulated as: “If there was a car in this frame, where would it be, and how confident are we that it is actually there”. For all detections in the same class, there is a non-zero likelihood that any detection matches any identity. In other embodiments, such as those using geospatial imagery, objects may be detected in a superclass, such as “Vehicle”, but then classified in various subclasses, e.g, “Sedan”, “Convertible”, “Truck”, “Bus”, etc. In such cases, a probability/confidence metric might be associated with specific subclasses instead of the binary class assignment discussed above. Other embodiments may operate by first detecting candidate regions with high “objectness score” which are consequently assigned confidences as being specific classes of objects by a network that focuses on just that area. The Faster-RCNN detector can be used in such an embodiment. In such a design, the region can be thought of as having some probability of being any given class. This can further be extended in other embodiments, where the regions considered objects by the system are not collapsed up front, but instead the literals are evaluated only after a determination is made as to what constitutes the object being searched for. For example, if the search query includes a term such as “CAR”, all that is needed is a mechanism to assign a probability that there is a CAR in the given input. Further, the presence can be extended to be, as just some examples, a picture, a sequence of pictures, or a more esoteric signal like audio, e.g., “there is the sound of a car at this time in the timeline of the input.” While in one embodiment, described above, the frames are collapsed to a list of detections where each detection has a singular class and confidence, other embodiments can relax this across a spectrum, first to each detection having a probability attached to it for being of any known class, to an abstract embedding space from which one can construct, for any region, a probability of it containing a car and then maximize over all possible regions to assign the literal a confidence value.

Referring to FIG. 6, an embodiment of a query process is shown from the expression of the query that begins the search until a final search result is achieved. The embodiment illustrated assumes that raw detections with embeddings have previously been accumulated, such as in Data Store 130 (FIG. 2B). Alternatively, the development of raw detections and embeddings can occur concurrently with the evaluation of the query. For purposes of simplicity and clarity, it is assumed that each identity can appear only once in any given frame. This is not always true, for example a single frame could include faces of identical siblings could, or a reflection in a mirror. Similarly, there can be numerous identical objects, such as “blue sedan”, in a single frame. However, in most instances, especially involving faces, the assumption will be true and, at least for many embodiments, the final truth value of the expression of the query is derived from the best possible instance. This permits the expression to be solved as a linear assignment problem where standard solvers, for example the Hungarian algorithm, can be used to yield a solution.

Thus, for FIG. 6, at step 600 a collection of raw detections (e.g., faces, objects, activities) with embeddings is made available for evaluation in accordance with a query 620 and query parse tree 625. Identity definitions, such as by class or set of embedding, are defined at step 605, and the raw detections are evaluated accordingly at step 610. The result is solved with any suitable linear assignment solver as discussed above, where detections are assigned unique identity with a confidence value, shown at 615. In some embodiments, for example those where it might be desirable to rigorously avoid false positives, a solution is a one-to-one assignment of literals to detections in the frame, which requires there to be exactly the same number of literals and detections in the frame. In other embodiments, a more relaxed implementation of the algorithm can yield better results. For example, if the query is (Alice & blue sedan)|(purple truck), in an embodiment it may be useful to match “blue sedan” and “purple truck” literals to a single vehicle detection in the frame rather than forcing a linear assignment that prevents one or the other from matching at all. This enables a more considered evaluation of the truthfulness of (Alice & blue sedan|(purple truck). If, in the example, the probability of Alice is low, then even though the vehicle might be more blue than purple, and more sedan than truck, the evaluation of the final query would get a higher truth value as matching “purple truck”. Depending upon the nature of the literal, matching multiple literals to the same detection can be either allowed or disallowed. As one example, an embodiment can have all face detections matched one-to-one to named persons in the query, while all other detections allow many-to-many matching. Alternatively, any object can be associated with a color such that a detection is evaluated for color and the result impacts the confidence of the match. For embodiments discussed above, where detections are assigned a best-guess class during initial processing, and no other classes are considered for matching, no match would be found if “truck” and “sedan” were defined as different classes, regardless of color. The greedy collapsing of detections to just one class, and assignment to the literals that yield an optimal or at least desirable “sum of confidences” can be viewed as a heuristic optimization that makes the problem computationally more tractable, especially when run at scale. While the foregoing approach is desirable in some embodiments, in alternative embodiments where combinatorial complexity is acceptable, these limitations can be relaxed so that every feasible assignment of detections to literals is considered and ranked. In at least some of such embodiments, one approach is to assign detections to literals in the query term based on which assignment yields the best confidence for the query. However, consistent among the alternatives is that the same face detection cannot simultaneously be both “Alice” and “Bob” where the query is searching for the combination of “Alice” and “Bob” since that would yield a single face where the query expects two different—albeit potentially quite similar—faces. To assist the operator, there is an explicit assumption that two different detections were present, which is enforced in some way for each embodiment of the overall algorithm. The linear assignment problem is one example of an embodiment that achieves this.

When this is not the case a priori, either dummy detections or literals can be introduced. These represent “not in frame” and “unknown detection”, respectively. A fixed confidence value, for example −1, can be assigned to any such detections. The linear assignment problem maximizes the sum of confidences of the assignments, constrained to one-to-one matches. In this case, it gives the maximum sum of confidences. Since there must be |#detections-#literals| assignments to dummy entries, there will be a fixed term in the cost, but the solution still yields the strongest possible assignment of the literals.

As noted above, steps 600 to 610 can occur well in advance of the remaining steps, such as by recording the data at one time, and performing the searches defined by the queries at some later time.

The total frame confidence is then evaluated through the query parse tree, step 630, using fuzzy-logic rules: a & b=>min(a,b), a|b=>max(a,b), !a=>1−a. Additionally, a specific detection box is associated to each literal. These boxes are propagated through the parse tree. Each internal node of the parse tree will represent a set of detection boxes. For “&”, it is the union of the detection boxes of the two children. For “|”, it is the set on the side that yields the maximum confidence. For “!” (not), it is an empty set, and may always be an empty set. In the end, this process yields, for each frame, a confidence value for the expression to match and a set of detection boxes that has triggered that confidence, 635.

For example, assume that the query asks “Are both Alice and Bob in a scene” in the gallery of images. The analysis returns a 90% confidence that Alice is in the scene, but only a 75% confidence that Bob is in the scene. Therefore, the confidence that both Bob and Alice are in the scene is the lesser of the confidence that either is in the scene—in this case, the 75% confidence that Bob is in the scene. Similarly, if the query asks “Is either Alice or Bob in the scene”, the confidence is the maximum of the confidence for either Alice or Bob, or 90% because there is a 90% confidence that Alice is in the scene. If the query asks “Is Alice not in the scene”, then the confidence is 100% minus the confidence that Alice is in the scene, or 10%.

The per-frame matches are pooled into segments of similar confidence and similar appearance of literals. Typically the same identities, e.g., “Alice & Bob”, will be seen in multiple consecutive frames, step 640. At some point, this might switch and while the expression still has a high confidence of being true, it is true because Dave appears in the frame, without any cars. When this happens, the first segment produces a separate search result from the second. Also, if there is empty space where the query is true with a much lower confidence, in an embodiment that result is left out or moved into a separate search result, and in either case may be discarded due to a low confidence value (e.g., score). As noted hereinabove, the term “segment” in this context refers to a sequence of video data, rather than parts of a single frame as used in FIGS. 3A-3B.

Finally, for each segment, the highest confidence frame is selected and the detection boxes for that frame are used to select a summary picture for the search result, 645. The segments are sorted by the highest confidence to produce a sorted search response of the analyzed video segments with thumbnails indicating why the expression is true, 650.

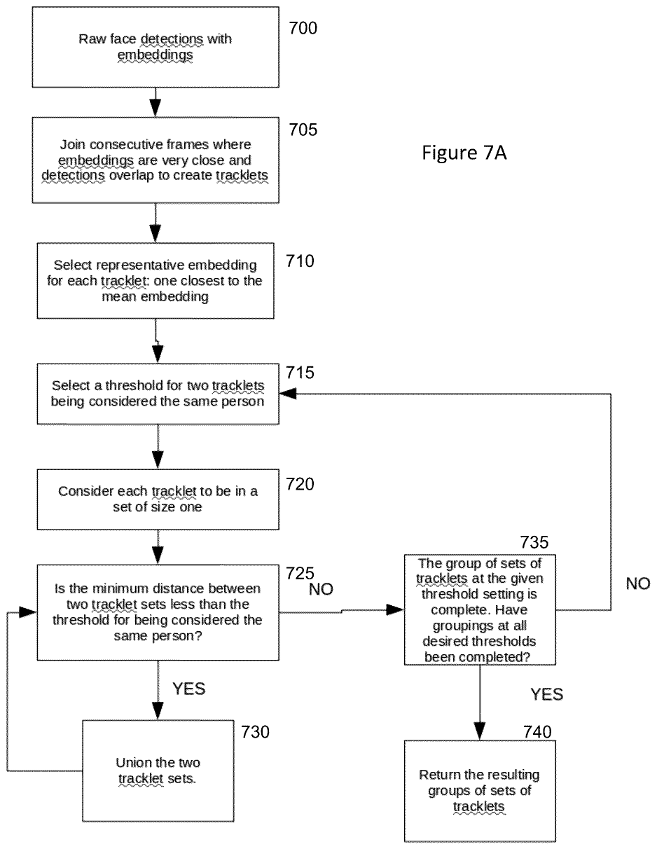

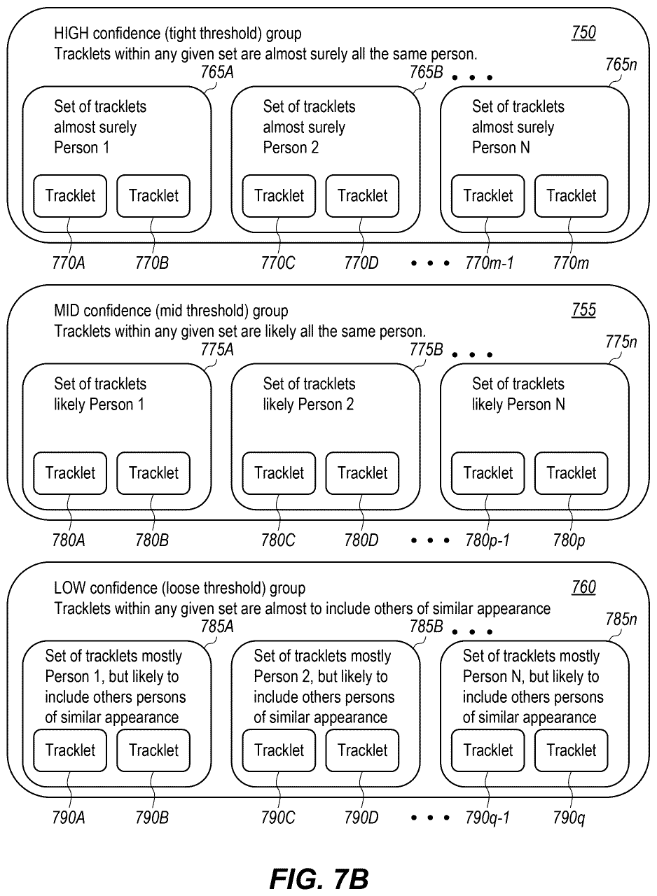

The foregoing discussion has addressed detecting movement through multiple frames based on a per-frame analysis together with a query evaluated using a parse tree. In an alternative embodiment, tracking movement through multiple frames can be achieved by clustering detections across a sequence of frames. The detection and location of a person of interest in a sequence of frames creates a tracklet (sometimes called a “streak” or a “track”) for that person (or object) through that sequence of data, in this example a sequence of frames of video footage. In such an embodiment, clusters of face identities can be discovered algorithmically as discussed below, and as illustrated in FIGS. 7A and 7B.

In an embodiment, the process can begin by retrieving raw face detections with embeddings, shown at 700, such as developed by the techniques discussed previously herein, or by the techniques described in the patent applications referred to in the first paragraph above, all of which are incorporated by reference in full. In some embodiments, and as shown at 705, tracklets are created by joining consecutive frames where the embeddings assigned to those frames are very close (i.e., the “distance” between the embeddings is within a predetermined threshold appropriate for the application) and the detections in those frames overlap. Next, at 710 a representative embedding is selected for each tracklet developed as a result of step 705. The criteria for selecting the representative embedding can be anything suitable to the application, for example, the embedding closest to the mean, or an embedding having a high confidence level, or one which detects an unusual characteristic of the person or object, or an embedding that captures particular invariant characteristics of the person or object, and so on.

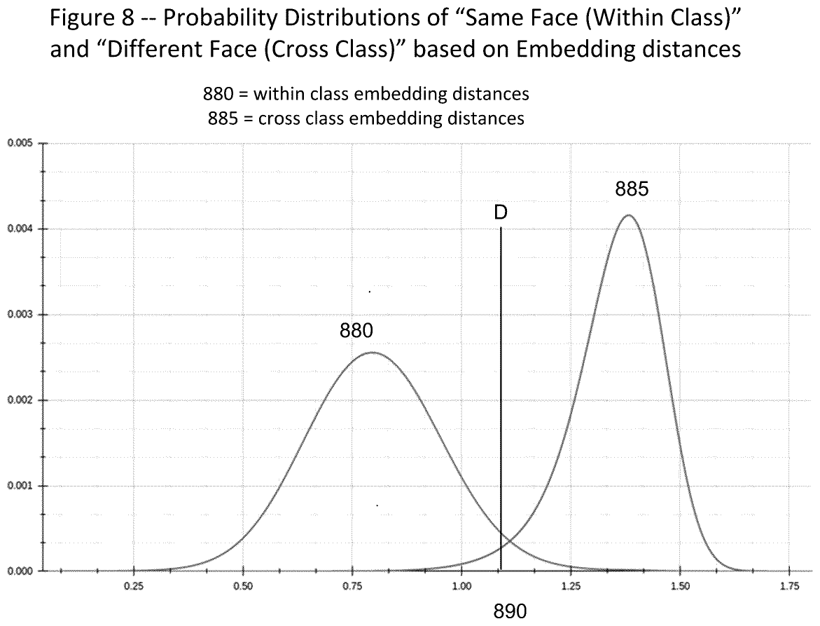

Next, as shown at 715, a threshold is selected for determining that two tracklets can be considered the same person. As discussed previously, and discussed further in connection with FIG. 8, the threshold for such a determination can be set differently for different applications of the invention. In general, every implementation has some probability of error, either due to misidentifying someone as a person of interest, or due to failing to identify the occurrence of a person of interest in a frame, The threshold set at step 715 reflects the balance that either a user or an automated system has assigned. Moreover, multiple iterations of the process can be performed, each at a different threshold such that groupings at different confidence levels can be presented to the user, as shown better in FIG. 7B. Then at step 720, each tracklet is considered to be in a set of tracklets of size one (that is, the tracklet by itself) and at 725 a determination is made whether the distance between the embeddings of two tracklet sets is less than the threshold for being considered the same person. If yes, the two tracklet sets are unioned as shown at 730 and the process loops to step 725 to consider further tracklets. If the result at 725 is no, then at 735 the group of sets of tracklets at a given threshold setting is complete and a determination is made whether additional groupings, for example at different thresholds, remain to be completed. If so, the process loops to step 715 and another threshold is retrieved or set and the process repeats. Eventually, the result at step 735 is “yes”, all groupings at all desired thresholds have been completed, at which time the process returns the resulting groups of sets of tracklets as shown at 740.

The result of the process of FIG. 7A can be better appreciated from FIG. 7B. In FIG. 7B, three groups 750, 755, 760 are shown, each representative of a different confidence level of detection. Thus, group 750 represents sets of tracklets where each set comprises one or more tracklets of an associated person or object. FIG. 7B shows sets 765A-765n of tracklets 770A-7770m for Person 1 through Person N to which the system has assigned a high level of confidence that each tracklet in the set is in fact the person identified. As illustrated, there is one set of tracklets per person, but, since the number of tracklets in any set can be more than one, sets 765A-765n can comprise, in total, tracklets 770A-770m.

Then, at 755 is shown a group of tracklets that have been assigned only a midlevel confidence value, that is, in sets 775A-775n, it is likely but not certain that each of the tracklets 780A-780p corresponds to the identified person or object. Finally, at 760 is a group of sets 785A-785n of tracklets 790A-790q where detection and filtering has been done only to a low confidence level, such as where only gross characteristics are important. Thus, while the tracklets 790A-790q are probably primarily associated with the person or object of interest, e.g., Person 1-Person N, they are likely to include other persons of similar appearance or, in the case of objects, other objects of similar appearance. It will be appreciated that, in at least some embodiments, when the tracklets are displayed to a user, each tracklet will be depicted by the representative image for that tracklet, such that what the user sees is a set of representative images by means of which the user can quickly make further assessments.

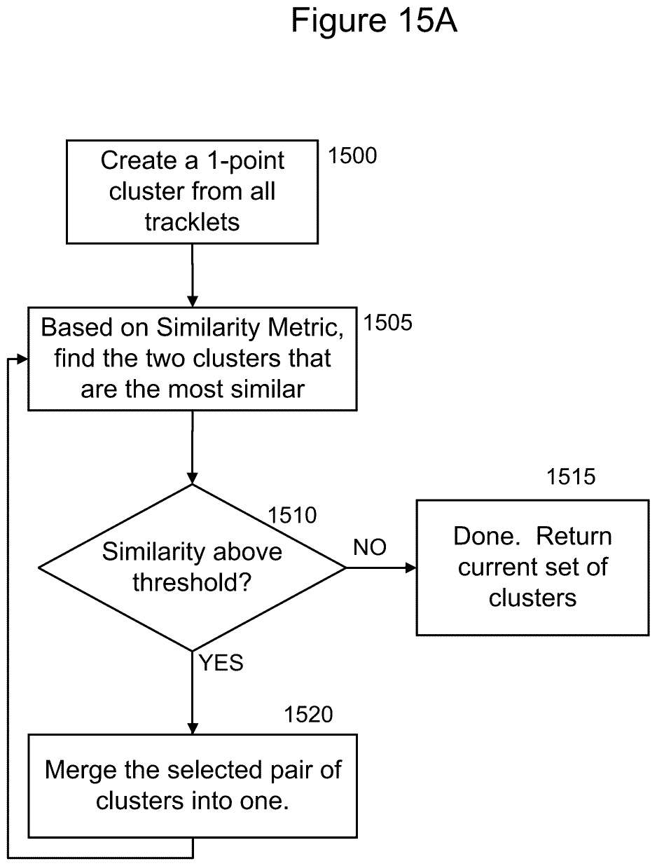

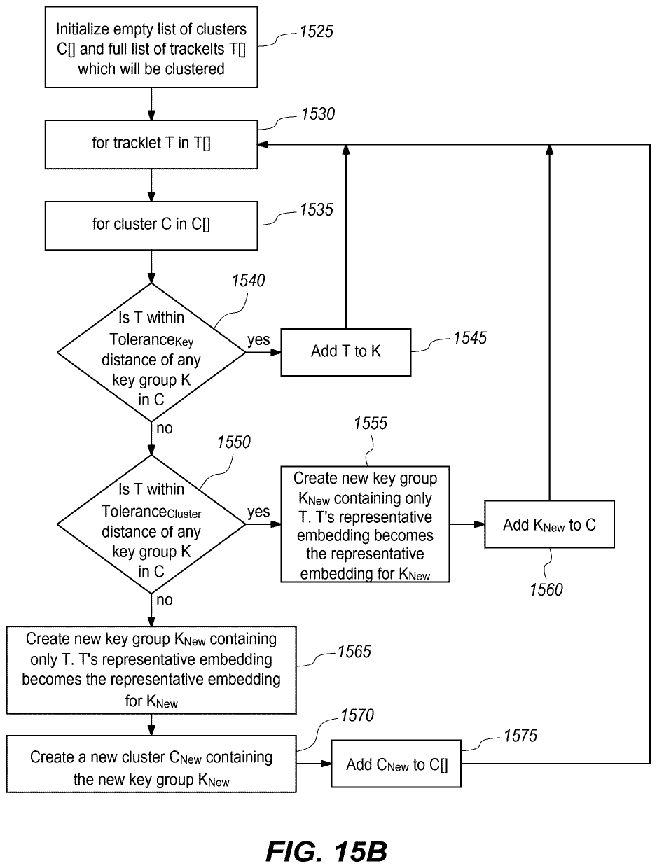

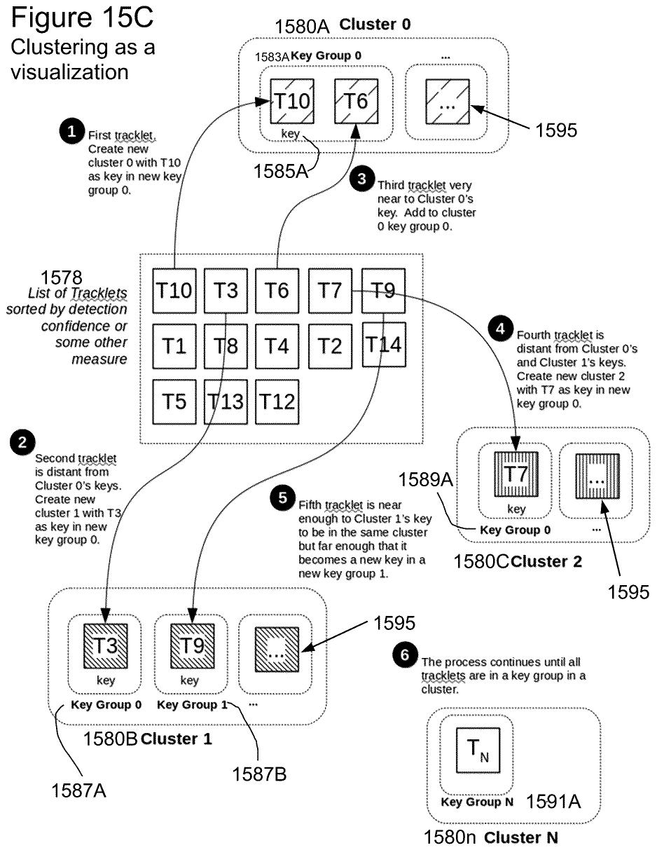

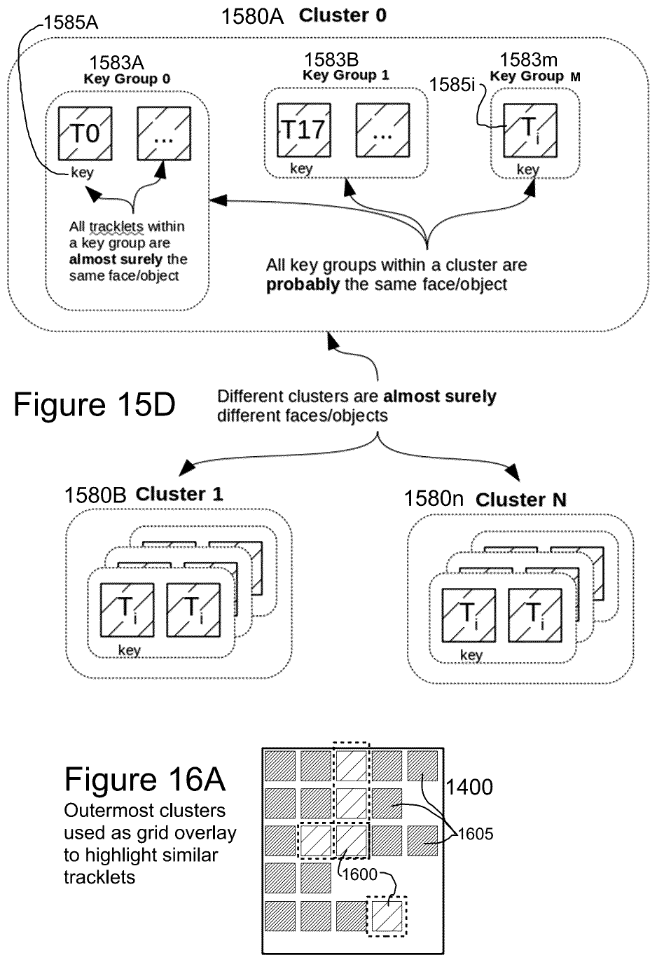

Referring next to FIG. 8, an important aspect of some embodiments of the invention can be better appreciated. As noted previously, in some applications of the present invention, greater accuracy or greater granularity is preferred at the expense of less compression of the data, whereas in other applications, greater compression of the data is preferred at the expense of reduced accuracy and reduced granularity. Stated differently, in some applications permitting missed recognitions of an object or person of interest may be preferred over false matches, i.e., wrongly identifying a match. In other applications, the opposite can be preferred. The probability distribution curves 880 and 885 of FIG. 8 illustrate this trade-off, in terms of choosing an optimal embedding distance that balances missed recognitions on the one hand and false matches on the other. In FIG. 8, curve 880 (the left, flatter curve) depicts “in class” embedding distances, while the curve 885 (the right curve with the higher peak) depicts cross class embedding distances. The vertical line D depicts the embedding distance threshold for a given application. The placement of vertical line D along the horizontal axis depicts the balance selected for a particular application. As an example, for the vertical line D indicated at 890, the area of curve 880 to the right of the line D represents the missed recognition probability while the area under the curve 885 to the left of the line D, 890, represents the false recognition probability. It will be appreciated by those skilled in the art that selection of that threshold or balance point can be implemented in a number of different ways within the systems of the present invention, including during training, at selection of thresholds as shown in FIG. 7A, or during clustering as discussed hereinafter in connection with FIGS. 15A-15D, or at other convenient steps in processing the data.

Referring next to FIGS. 9A-9B, an aspect of the invention relating to assigning a confidence value to a detection can be better appreciated. More specifically, FIG. 9A illustrates a novel capability to discover the strength of relationships among one or more objects, e.g., actors, around an object of interest such as a person or vehicle through analysis of the multisensor data. For example, where the relationship of interest is whether two people are interacting, one approach is to assume that the probability, or strength, of a relationship is proportional to the amount of time those people appear together in the same frame in the videos, the strength of the relationship between two detected faces or bodies can be automatically computed for every individual defined by sample embeddings. Alternatively, the relationship of interest can be the proximity of one or more objects, for example people, to a location or an object. Still further, the relationship of interest can combine both temporal and spatial aspects in determining the strength of the relationship. A relationship of interest can also comprise either temporal or spatial proximity of one or more individuals or other objects to one or more locations.

For clarity of explanation, the following assumes a relationship of interest based on temporal proximity. Starting with retrieving raw detections with embeddings, shown at 900, and identity definitions, 905, in an embodiment every frame of the video is evaluated for presence of individuals in the same way as if searching for (A & B & . . . )—e.g. the appearance of any identity as discussed above. Every frame then produces a set of key value pairs, where the key is a pair of names, and the value is confidence, shown at 910 and 915. For example, if a frame is deemed to have detections of A, B and C, with confidences c_a, c_b, c_c, respectively, then three pairs exist: ((A,B),min(c_a,c_b)), ((A,C), min(c_a,c_c), ((B,C), min(c_b, c_c)) as shown at 920.

These tuples are then reduced (for example, in Spark, taking advantage of distributed computing) according to the associated key into histograms of confidences, shown at 925, with some bin size, e.g. 0.1 (producing 10 bins). In other words, for any pair of people seen together, the count of frames where they appear together at a given confidence range can be readily determined.

From this, the likelihood or strength of connection between the individuals can be inferred. Lots of high confidence appearances together indicate a high likelihood that the individuals are connected. However, this leaves an uncertainty: are ten detections at confidence 0.1 as strong a single detection at confidence 1.0? This can be resolved from the histogram data, by providing the result to an artificial intelligence algorithm or to an operator by means of an interactive tool and receiving as a further input the operator's assessment of the connections derived with different settings. As noted above, the level of acceptable error can vary with the particular application, as will the value/need for user involvement in the overall process. For example, one application of at least some aspects of the present invention relate to customer loyalty programs, for which no human review or intervention may be necessary.

For some detected individuals, the objective of searching for companions may be to find any possible connection, such as looking for unlikely accomplices. For example, certain shoplifting rings travel in groups but the individuals appear to operate independently. In such a case, a weaker signal based on lower confidence matches can be acceptable. For others, with many strong matches, higher confidence can be required to reduce noise. Such filtering can easily be done at interactive speeds, again using the histogram data.

Other aspects of the strength of a connection between two detected individuals are discussed in U.S. patent application Ser. No. 16/120,128 filed Aug. 31, 2018 and incorporated herein by reference. In addition, it may be the case that individuals within a network do not appear in the same video footage, but rather within a close time proximity of one another in the video. Other forms of connection, such as geospatial, with reference to a landmark, and so on, can also be used as a basis for evaluating connection. In such cases, same-footage co-incidence can be replaced with time proximity or other relevant co-incidence. Using time proximity as an example, if two persons are very close to each other in time proximity, their relationship strength would have a greater weight than two persons who are far apart in time proximity. In an embodiment, a threshold can be set beyond which the connection algorithm of this aspect of the present invention would conclude that the given two persons are too far apart in time proximity to be considered related.

As noted earlier in the discussion of FIGS. 5A-5B et seq., in some embodiments the present invention can identify an entity, i.e., a person, in combination with a specific object. Similarly, FIG. 9B illustrates an example of a parse tree that concludes the confidence of a relationship among Charlie, Alice, David and Elsa is 0.3. At the first “or” of the left main branch, Charlie is selected over Bob because the confidence that Charlie has been accurately identified is greater than the confidence that Bob has been accurately identified. At the next junction up, an “and”, the confidence that there is a relationship between Charlie and Alice is only 0.8 because the confidence assigned to Alice's identification is only 0.8, or the lesser of Charlie and Alice. On the right main branch, the “or” yields Elsa, at a confidence of 0.5, and the “and” between Frank and Elsa yields a confidence of 0.3 because that is the confidence that Frank has been correctly identified. At the top “and”, the confidence of 0.3 for Frank controls, and so the overall confidence is 0.3. An aspect of the invention that is important in at least some embodiments is the propagation of thumbnail evidence. For example, with reference to FIG. 9B, when evaluating OR nodes, only one thumbnail is kept, typically the thumbnail with the highest confidence. Thus, for “Bob or Charlie”, the thumbnail for Charlie has the higher confidence and is kept, while for “Elsa or Frank”, the thumbnail for Elsa is kept. For AND nodes, both thumbnails are kept so that the user can confirm that both sides of the query were true.

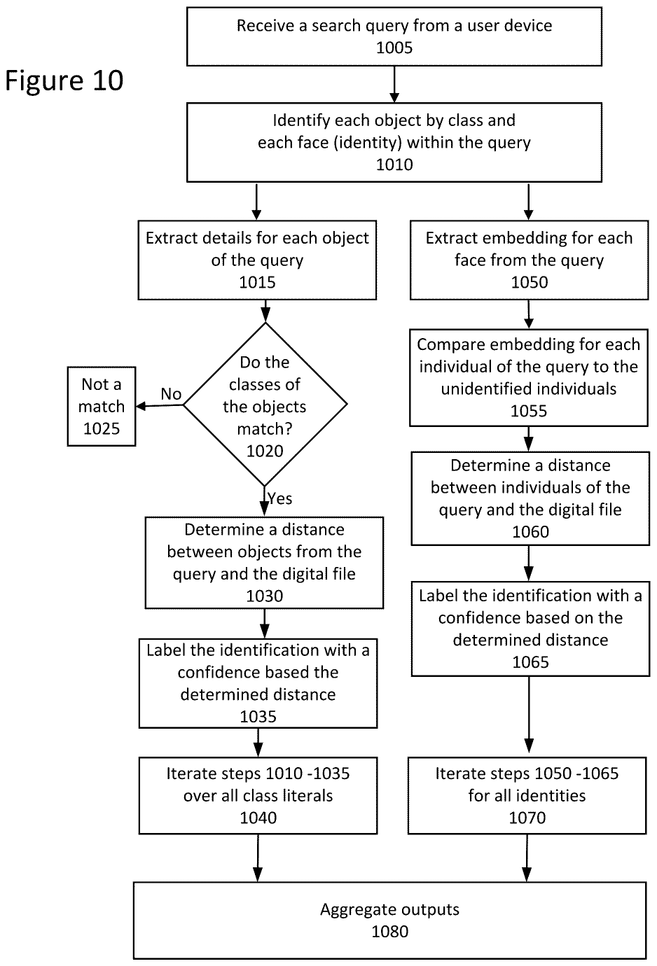

FIG. 10 shows an example flowchart describing the process for detecting matches between targets received from a query and individuals identified within a selected portion of video footage, according to an example embodiment. As described above, the techniques used to match target individuals to unidentified individuals within a sequence of video footage may also be applied to match target objects to unidentified objects within a sequence of video footage. From a high level, FIG. 10 can be seen to describe an embodiment for assessing a query such as either of two Persons of Interest (“POI”) and a car, which may for example be written as (POI1 or POI2 and :car:) and frame with detections. The process can be described as:

```
output = [ ]
for obj in *detections*
  if obj is face
    do 1050 to 1065
  else
    do 1015 to 1035
return output [1080]
```

where “face” can be any identity with embeddings, steps 1050-1065 append (POI1, obj, conf) and (POI2, obj, conf) into output, or, stated differently, steps 1050-1065 are applied to all detections for which POI matching by embedding is relevant, typically faces or vehicles in some embodiments. Steps 1015-1035 append (:car:, obj, conf) into the output, or, stated differently, steps 1015 to 1035 are applied to all detections for which confidence will be based purely on the object detector confidence of that object even being correctly classified, and those outputs are aggregated in step 1080. Thus, any face detection is compared to the reference embeddings that correspond to each of the POI's in the query. The confidences of a detected face being a match to any one of the POI's are recorded, followed by applying Hungarian algorithm matching (or equivalent) to resolve which POI matches which detection, thus producing the values needed to fill the cost matrix of the linear assignment problem analogous to that discussed above.

With the above discussion in mind, and still referring to FIG. 10, at 1005 a search query is received from a user device and at 1010 the process, by which each target object and each target individual within the query is identified, branches. The branch beginning with step 1015 identifies objects that do not have an embedding, i.e., “class literals”, while the branch beginning with 1050 identifies objects with embedding, i.e., “identity literals”. Class literals get a confidence based on the confidence value collected from the deep net-based object detector, while identity literals get their confidence based on embedding distances. In some embodiments, identity literals can only be faces, while in other embodiments identity literals can be faces, vehicles, or other objects. This process produces all the possible confidences that are needed to construct the linear assignment cost matrix. For example, for a query “Car & Bob & Alice”, where “car” is understood to be a class literal, and Alice and Bob are identity literals) the process will, for “car”, produce the possible matches to all car detections, each one with the class confidence of being a car. Meanwhile, both Bob and Alice have all the detections with class “face” as candidates, with confidences coming from embedding distances to Bob and Alice, respectively. Thus, for the class literals branch of FIG. 10, for each target object, at step 1015 the query processor extracts details for each object of the query by which they are assigned to a class. The classes of the two objects are compared at step 1020. If the object classes do not match the process branches to step 1025 and the process advances to analyze the next unidentified object within the file. If the objects do match, the process advances to step 1030 where the distance is calculated between the query object and the object from the digital file. Each identification is labeled at step 1035 with a confidence score based on the determined distance. Steps 1010 to 1035 are then iterated over all class literals, indicated at 1040. For queries involving both class literals and identify literals, such as “Car & Bob & Alice”, simultaneously following step 1010, embeddings are extracted at step 1050 for each face from the query. The embeddings of each individual in the query are then compared at step 1055 to the unidentified individuals in the data file. At step 1060 a distance is determined between the individuals in the query and the individuals identified from the digital file to identify matches. At step 1065 each match is labeled with a confidence based on the determined feature distance. Steps 1050-1065 are then iterated over all identities, indicated at 1070. Finally, at step 1080 the outputs are aggregated as described above.

For queries involving both class literals and identify literals, such as “Car & Bob & Alice”, simultaneously following step 1010, embeddings are extracted at step 1050 for each face from the query. The embeddings of each individual in the query are then compared at step 1055 to the unidentified individuals in the data file. At step 1060 a distance is determined between the individuals in the query and the individuals identified from the digital file to identify matches. At step 1065 each match is labeled with a confidence based on the determined feature distance. Finally, the recognition module aggregates at step 1080 the matches detected for objects and the matches detected for faces in each grouping into pools pertaining to individual or combinations of search terms and organizes each of the aggregated groupings by confidence scores.

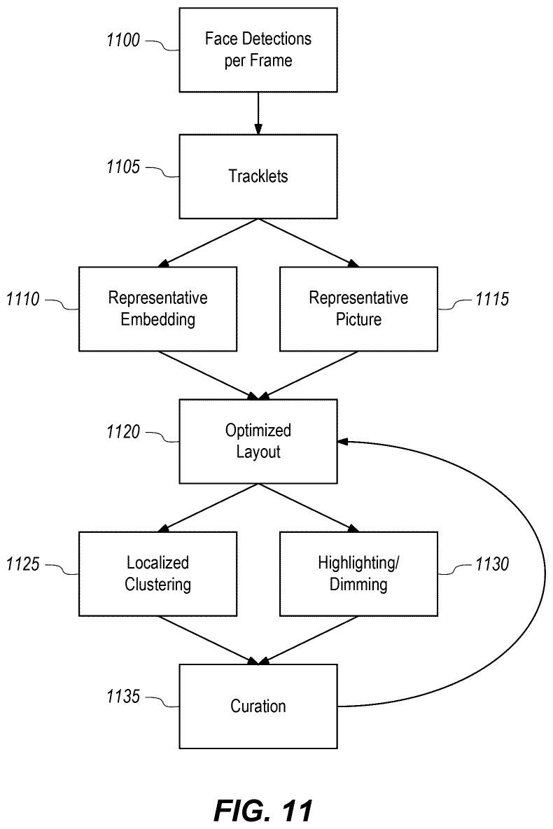

Referring next to FIG. 11, details of the second major aspect of the present invention can be better appreciated from the following. As summarized above, the second major aspect differs from the first in that the detections are made without the use of a probe or reference image, although both rely on the same basic multisensor processing platform. Fundamentally, the objective of this aspect of the invention is to simplify and accelerate the review of a large volume of sequential data such as video footage by an operator or appropriate algorithm, with the goal of identifying a person or persons of interest where the likeness of the those individuals is known only in a general way, without a photo. As will be appreciated from the following discussion, this goal is achieved by compressing the large volume of unstructured data into representative subsets of that data. In addition, in some embodiments, frames that reflect no movement relative to a prior frame are not processed and, in other embodiments, portions of a frame that show no movement relative to a prior frame are not processed.

This is accomplished by dividing the footage into a plurality of sequences of video frames, and then identifying all or at least some of the persons detected in a sequence of video frames. The facial detection system comprises a face detector and an embedding network. The face detector generates cropped bounding boxes around faces in any image. In some implementations, video data supplemented with the generated bounding boxes may be presented for review to an operator. As needed, the operator may review, remove random or false positive bounding boxes, add bounding boxes around missed faces, or a combination thereof. In an embodiment, the operator comprises an artificial intelligence algorithm rather than a human operator.

The facial images within each network are input to the embedding network to produce some feature vector, for example a 128-dimensional vector of unit length. The embedding network is trained to map facial images of the same individual to a common individual map, for example the same 128-dimension vector. Because of how deep neural networks are trained in embodiments where the training uses gradient descent, such an embedding network is a continuous and differentiable mapping from image space (e.g. 160×160×3 tensors) to, in this case, S127, i.e. the unit sphere embedded in 128 dimensional space. Accordingly, the difficulty of mapping all images of the same person to exactly the same point is a significant challenge experienced by conventional facial recognition systems. Additionally, conventional systems operate under the assumption that embeddings from images of the same person are closer to each other than to any embedding of a different person. However, in reality, there exists a small chance that embeddings of two different people are much closer than two embeddings of the same person, which conventional facial recognition systems fail to account for.

To overcome those limitations of conventional systems, the facial recognition system interprets images of the same person in consecutive frames as differing from each other much less than two random images of that person. Accordingly, given the continuity of the embedding mapping, the facial recognition system can reasonably expect embeddings to be assigned much stronger face detections between consecutive frames compared to the values assigned to two arbitrary pictures of the same person.

Still referring to FIG. 11, the overall process of an embodiment of this aspect of the invention starts at 1100 where face detections are performed for each frame of a selected set of frames, typically a continuous sequence although this aspect of the present invention can yield useful data from any sequence. The process advances to 1105 where tracklets are developed as discussed hereinabove. Then, at 1110 and 1115, a representative embedding and representative picture is developed. The process advances to laying out the images developed in the prior step, 1120, after which localized clustering is performed at step 1125 and highlighting and dimming is performed substantially concurrently at step 1130. Curation is then performed at step 1135, and the process loops back to step 1120 with the results of the newly curated data. Each of these general steps can be better appreciated from the following discussion. It will be appreciated that, in at least some embodiments, when the tracklets are displayed to a user, such as at the layout step, each tracklet will be depicted by the representative image or picture for that tracklet, such that what the user sees is a set of representative images by means of which the user can quickly make further assessments.

As touched on hereinabove, in at least some embodiments the system of the present invention can join face detections in video frames recorded over time using the assumption that each face detection in the current frame must match at most one detection in the preceding frame. As noted previously, a tracklet refers to a representation or record of an individual or object throughout a sequence of video frames. The system may additionally assign a combination of priors/weights describing a likelihood that a given detection will not appear in the previous frame, for example based on the position of a face in the current frame. For example, in some implementations new faces may only appear from the edges of the frame. The facial recognition system may additionally account for missed detections and situations in which one or more faces may be briefly occluded by other moving objects/persons in the scene.

For each face detected in a video frame, the facial recognition system determines a confidence measure describing a likelihood that an individual in a current frame is an individual in a previous frame and a likelihood that the individual was not in the previous frame. For the sake of illustration, the description below describes a simplified scenario. However, it should be understood that the techniques described herein may be applied to video frames with much larger amounts of detections, for example detections on the order of tens, hundreds or thousands. In a current video frame, individuals X, Y, and Z are detected. In a previous frame, individuals A and B are detected. Given the increase in detections from the previous frame to the current frame, the system recognizes that at least one of X, Y, and Z were not in the previous frame at all, or at least were not detected in the previous frame. Accordingly, in one implementation, the facial recognition system approaches the assignment of detection A and B to two of detections X, Y, and Z using linear assignment techniques, for example the process illustrated below.

| | Detection X | Detection Y | Detection Z |
|---|---|---|---|
| Detection A | s(A, X) | s(A, Y) | s(A, Z) |
| Detection B | s(B, X) | s(B, Y) | s(B, Z) |
| Not In This Frame | k | k | k |

An objective function may be defined in terms of match confidences. In one embodiment, the objective function may be designed using the embedding distances given that smaller embedding distances correlate with a likelihood of being the same person. For example, if an embedding distance between detection X and detection A is less than an embedding distance between detection Y and detection A, the system recognizes that, in general, the individual in detection A is more likely to be the same individual as in detection X than the individual in detection Y. To maintain the embedding network, the system may be trained using additional training data, a calibration function, or a combination thereof.

In another embodiment, the probability distributions that define the embedding strength are

$$P ( d ( x , y ) \vert Id ( x ) = Id ( y ) )$$

$$and$$

$$P ( d ( x , y ) \vert Id ( x ) \neq Id ( y ) ) ,$$

where d(x,y) is the embedding distance between two samples x,y and Id(x) is the identity (person) associated with sample x. These conditional probability distribution functions of the embedding distance are independent of the prior probability P(Id(x)=Id(y)), which is a critical feature of the validation data that would be reflected in typical Receiver Operating Characteristic (ROC) curves used to evaluate machine learning (ML) systems. However, these conditional probabilities can also be estimated using validation data, for example using validation data that represents sequences of faces from videos to be most representative of the actual scenario

Given the prior probability p_{T}=P(Id(A)=Id(X)), the following can be defined:

$$s ( A , X ) = P ( Id ( A ) = Id ( X ) \vert d ( A , X ) ) = \frac{P ( d ( A , X ) \vert Id ( A ) = Id ( X ) ) {p}_{T}}{\begin{matrix}P ( d ( A , X ) \vert Id ( A ) = Id ( X ) ) {p}_{T} + \\ P ( d ( A , X ) \vert Id ( A ) \neq Id ( X ) ) ( 1 - {p}_{T} )\end{matrix}}$$

where the Bayes theorem is used to obtain the last equality.

Continuing from the example scenario described above, the facial recognition system can estimate the probability distribution (p_{T}) from the number of detections in the current frame and the previous frame. If there are N detections (e.g., 3) in current frame and M (e.g., 2) in the previous frame, then the probability distribution may be modeled as

$${p}_{T} \approx \frac{min ( M , N )}{M N} - ε$$

where ε represents the adjustment made based on missed or incorrect detections.

In an embodiment, initially the active tracklets T are represented as an empty feature vector [ ]. In one embodiment, tracklet IDs are assigned to detections D in a new frame using the following process:

$$Define N = max ( len ( T ) , len ( D ) )$$

$$Define {p}_{T} = ( min ( len ( T ) , len ( D ) ) / ( len ( T ) * len ( D ) ) - ε$$

$$Generate an N \times N matrix D such that D ( i , j ) = s ( D ( i ) , T ( j ) ) if i \leq len ( D ) and j \leq len ( T ) and k otherwise$$

Based on the generated matrix, compute a one-to-one mapping f(i): [1,N]→[1,N] such that

$${\sum }_{i = 1}^{N} D ( i , f ( i ) )$$

is maximized.
For i∈[1,N], assign a tracklet Id of T(f(i)) to detection i, if f(i)≤len(T). Otherwise generate a new tracklet ID for the detection.
Replace T with the detections from D with the assigned tracklet IDs.
   These values represent the probability that a tracklet had a missed detection or the subject walked out of the frame (when j>len(T)) or that a detection represents an identity that is not yet tracked (when i>len(D)). In some embodiments this can just be proportional to the a priori probability that any two detections are NOT of the same identity, in which case a reasonable choice for k is 1−p_t.

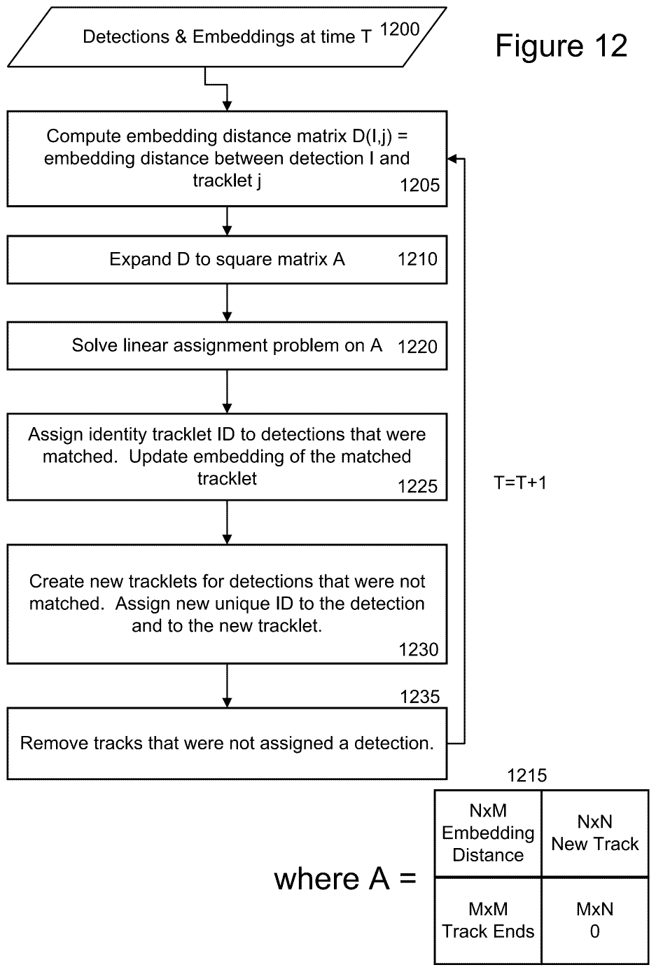

Referring next to FIG. 12, a technique for extracting tracklets in accordance with an embodiment of the invention can be better appreciated. Beginning at 1200, detections and embeddings at time T are retrieved. The embedding distance matrix D(l,j) is computed from the embedding distance between detection l and tracklet j, shown at 1205. Matrix D is then expanded into square matrix A, step 1210, where A is as shown at 1215 and discussed below, after which the linear assignment problem on A is solved, step 1220, to determine matches. For detections that were matched, an identity tracklet ID is either assigned or carried over from the matching detection in the preceding frame and the embedding of the matched tracklet is updated, 1225. New tracklets are created for detections that were not matched, 1230, with a new unique ID assigned to the detection and to the new tracklet. Finally, at step 1235, remove tracklets that were not assigned a detection. The process then loops back to step 1205 for the next computation.

As will be appreciated by those skilled in the art, for N detections and M active tracks, D is an N×M matrix. The matrix A will be (N+M)×(N+M) square matrix. The linear assignment problem is understood to produce a permutation P of [1, . . . , N+M] such that the sum over A[i, P(i)] for i=1 . . . N+M is minimized. The padded regions simply represent detections that represent identities that appear, identities that disappeared or are simply computational overhead as depicted on the right. Constant values, e.g., k as discussed above, are used for these regions and they represent the minimum distance required for a match. The linear assignment problem can be solved using standard, well known algorithms such as the Hungarian Algorithm.

To improve run time, a greedy algorithm can be used to find a “good enough” solution, which for the purposes of tracking is often just as good as the optimal. The greedy algorithm simply matches the pair (i,j) corresponding to minimum A(i,j) and removes row i and column j from consideration and repeats until every row is matched with something.

Each track is assumed to represent some identity, and that identity needs to be characterized somehow so that tracks can be compared to detections and other tracks. In one embodiment, the track identity can be represented as a single representative embedding. A number of update rules can be used to produce the representative embedding. Alternatives to representative embedding include storing multiple samples for each track, or using a form of k-means clustering to produce a meaningful sample-based machine learning solution. RANSAC or other forms of outlier detection can be used to further clean up the representation.

In an embodiment, for each tracklet, the facial recognition system constructs a single embedding vector to represent the entire tracklet, hereafter referred to as a representative embedding. In one embodiment, the representative embedding is generated by averaging the embeddings associated with every detection in the tracklet. In another implementation, the facial recognition system determines a weighted average of the embeddings from every detection in the tracklet, where each of the weights represent an estimate of the quality and usefulness of the sample for constructing an embedding which may be used for recognition. The weight may be determined using any one or more combination of applicable techniques, for example using a Long Short-term Recurrent Memory (LSTM) network trained to estimate weights that produce optimized aggregates.

In another embodiment, the facial recognition system generates a model by defining a distance threshold in the embedding space and selecting a single embedding for the tracklet that has the largest number of embeddings within the threshold. In other embodiments, for example those in which multiple embeddings are within the distance threshold, the system generates a final representative embedding by averaging all embeddings within the threshold.

For purposes of illustration, in an embodiment a representative embedding is determined using the following process:

```
Define max_count = 0
  For e embeddings for the tracklet
  Define cnt = count ( d(e,x) < th for x in embeddings ) − 1
  If cnt > max_count:
  Define max_count = cnt
  Define center = e
Determine the output as:
  avg(x for x in embeddings if d(x,center) < th)
```

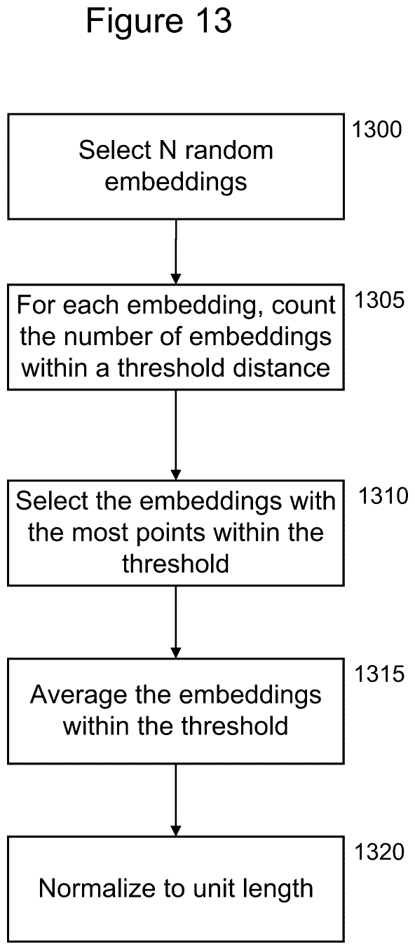

With reference to FIG. 13, a process for selecting a representative embedding is illustrated in flow diagram form. Beginning at step 1300, the process initiates by selecting N random embeddings. Then, at 1305, for each embedding, a count is made of the number of other embeddings within a predetermined threshold distance. The embedding with the highest count is selected, 1310, and at 1315 an average is calculated of the embeddings within the threshold. The result is normalized to unit length and selected as the representative embedding, 1320.

Selection of a representative picture, or thumbnail, for each tracklet can be made in a number of ways. One exemplary approach is to select the thumbnail based on the embedding that is closest to the representative embedding, although other approaches can include using weighted values, identification of a unique characteristic, or any other suitable technique.

Once a representative picture and representative embedding have been selected, an optimized layout can be developed, per step 1120 of FIG. 11. In an embodiment, for each face detected in a sequence of video frames, the facial recognition system generates a tracklet with a thumbnail image of the individual's face, a representative embedding, and a time range during which the tracklet was recorded. In such an embodiment, the facial recognition system thereafter generates an interface for presentation to a user or AI system by organizing the group of tracklets based on the time during which the tracklet was recorded and the similarity of the tracklet embedding to the representative embedding.

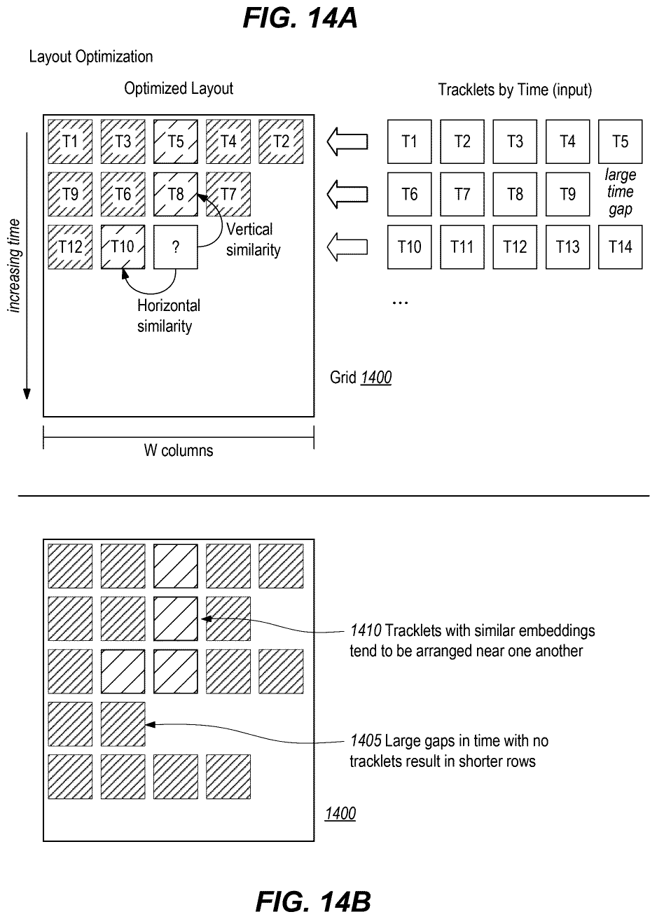

The results of such an approach can be appreciated from FIGS. 14A-14B. In the embodiment illustrated there, the vertical axis of the interface is designated as the time axis. Accordingly, scrolling down and up is equivalent to moving forward and back in time, respectively. By vertically scrolling through an entire interface of tracklets, shown as T1 to T10 arranged on grid 1400, a user can inspect the entirety of the footage of video data. Reviewing the tracklets by scrolling through the interface vertically may provide a user with a sense of progress as you scroll down the grid.

Additionally, each tracklet is positioned on the interface such that a first occurrence of a person may never be earlier to any appearing tracklet positioned higher on the interface.

Based on a fixed width of the display, a number of tracklets W can be displayed along the horizontal rows of the interface where the number W is defined as W=window_width/(thumbnail_width+padding). Images on the same row may be displayed in arbitrary order. Accordingly, in an embodiment designed to facilitate quick visual scanning, images can be ordered based on similarity using the following algorithm.

Given a list of tracklets T, sorted by their start time:

| | |
|---|---|
| | let P = [ ] |
| (2) | let S = T[:W], and T = T[W:], i.e. S is the first W tracklets taken |
| | out of T |
| | If P is not empty, set N[0] to the tracklet in S closest to P[0] in |
| | embedding, otherwise N[0] = S[0] |
| | Remove N[0] from S |
| | For i in range(1, W): |
| | Find the element j in S such that d(S[j], N[i−1]) + d(S[j], P[j]) is |
| | minimized where the latter term is zero if there is no element |
| | P[j] available. |
| | N[i] = S[j] |
| | Remove element j from S |
| | add row N to the grid. |
| | P = N |
| | if T is not empty, goto 2 |

The foregoing algorithm attempts to minimize embedding distance between adjacent face pictures, such as shown at 1405 and 1410 of FIG. 14B. Accordingly, individuals with similar facial features, for example glasses or a beard, may be clustered together. In another implementation, the system may generate a globally optimal arrangement.

It may be the case that the same face appears multiple times within a layout such as shown in FIGS. 14A-14B, where tracklets T1-T14 represent a chronology of captured images intended for layout in a grid 1400. Even within a small section of video, the same face/object may appear in multiple distinct tracklets. This could be due to a number of reasons, such as occlusions that interrupted the continuity of the face/object from one frame to the next, the face/object exiting then re-entering the frame, or the inner workings of neural networks whereby two faces/objects which are the same to the human observer are not recognized as such by the system based on their embeddings. Because many people's faces look somewhat different depending upon the camera angle at which a person's image is captured, or the lighting conditions, or other physical or environmental factors, it is possible for images of the face of a single person to be categorized by the present invention as several different faces, and to have tracklets developed for each of those faces. In the present invention, those different perspectives of the same person are referred to as “key faces”. In an embodiment, tracklets with similar embeddings, e.g. 1405, can be arranged near one another while those that are dissimilar, e.g. 1410, are placed at the outer portions of the layout. As noted above, while the tracklets shown are depicted as shaded squares, in some embodiments each tracklet presented for review by a user will display the representative image or picture for that tracklet.

Combining tracklets that are of the same person effectively reduces, or compresses, the volume of data a user must go through when seeking to identify one or more persons from the throng of people whose images can be captured in even just a few minutes of video taken at a busy location. To aid in identifying cases where two or more tracklets are in fact the same face/object and thus enable further compression of the number of distinct data points that the user must review, the system may employ clustering, and particularly agglomerative clustering.

In simplified terms, agglomerative clustering begins with each tracklet being a separate cluster. The two closest clusters are iteratively merged, until the smallest distance between clusters reaches some threshold. Such clustering may take several forms, one of which can be a layer of chronologically localized clustering. One algorithm to achieve such clustering is as follows:

```
Given a list of tracklets T for a small section of footage (e.g. 5-10
minutes)
ordered by confidence descending:
  let C = = [T[0]]
  For i in range(1, len( T):
    let t = T[i]
    Calculate the distance D between t and c for
    each cluster c in C as follows:
      For k in c where k is a “key face” tracklet
      which is part of the cluster:
        Calculate the distance between t and k
      Return the minimum distance
    If D < same-cluster tolerance:
      Add tracklet t to cluster c and re-compute “key faces”
      (see below)
    Otherwise:
      Create a new cluster c, add tracklet t to it as a key
      face, and add c to C
Key face algorithm for tracklets t in cluster c
  let K = [C[0]]
  For t in range(1, c): (2)
    For key face tracklet k in K:
      Calculate the distance D between t and k
      If D < same-key face tolerance, goto (2)
      Otherwise add t to K
```

The narrower the band of time, the more performant such a clustering algorithm will be. This can be tuned depending on how many faces are displayed in the grid at any given time such that the faces within the current frame of view are covered by the clustering algorithm. The results of such a clustering algorithm are embodied visually in the grid 1400. As shown there, in an embodiment, when one of the faces is selected (either by clicking or by hovering), all faces within the same cluster are highlighted within the grid. There is no guarantee that all faces within the cluster are indeed the same person, so this is an aid to the user and not a substitute for their own review and discretion.

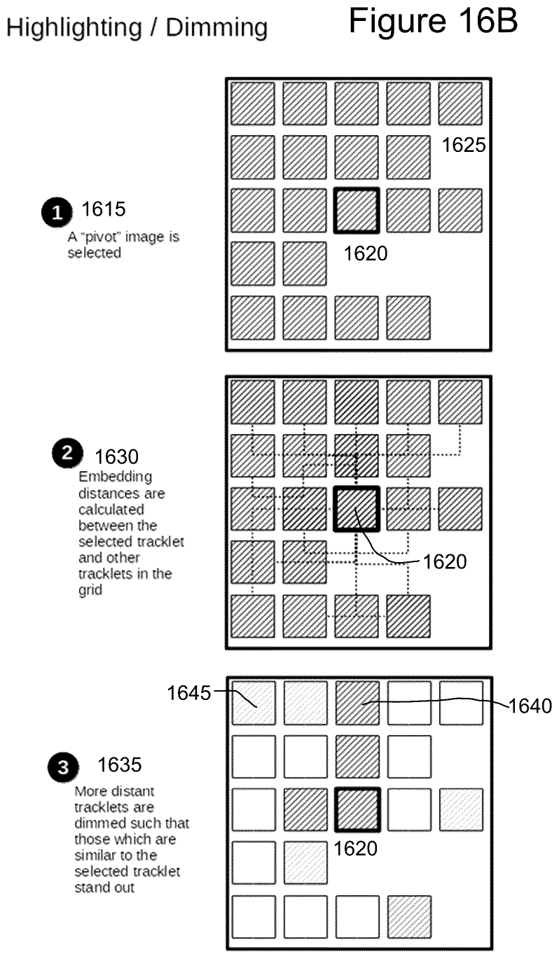

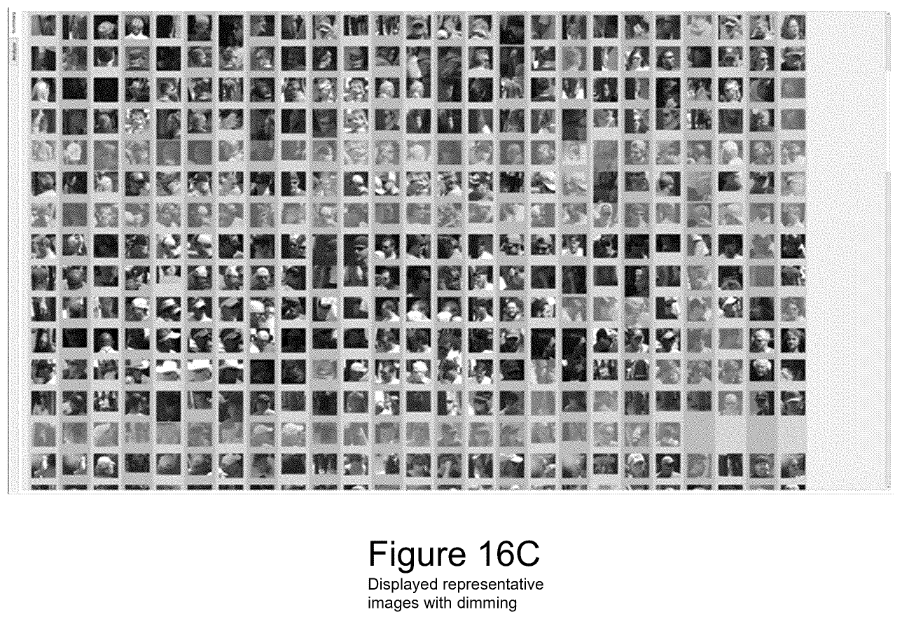

To elaborate on the foregoing, it will be appreciated by those skilled in the art that a distance between two clusters can be defined in various ways. Embedding vectors can be compared by various distance metrics, including Euclidean, Manhattan and inner product. Cluster can be represented by a single representative embedding, or by multiple embedding samples. In the case of multiple samples, various ways comparing two sets of embeddings can be used, such as set distance defined as min_i,j (a_i, b_j), where a_i and b_i are samples from clusters a and b, respectively, and the minimum is taken over all possible pairings. Other set distance measures are available as well. In at least some embodiments of the present invention, averaging the embedding works well. Further, various methods of outlier removal can be used to select a subset of embeddings to include in computing the average. One approach, used in some embodiments is to exhaustively test, or randomly (RASNAC-like) select points and find how many other points are within some threshold of that point. The point that has the largest number of neighbors by this rule is selected as the “pivot” (see FIG. 16) and all the points within threshold of the pivot are then averaged, with points beyond the threshold being discarded as outliers.

FIG. 15A illustrates a simplified representation of localized clustering. Thus, at 1500, a single point cluster is created from all tracklets under consideration. Then, at 1505, using a similarity metric, a search is made for the two clusters that are the most similar. At 1510, the similarity of the two clusters is compared to a predetermined threshold. If the similarity is sufficiently high that it exceeds the threshold value, the two clusters are merged (agglomerated) at 1520. Conversely, if similarity between the two clusters is less than the threshold, the process is done and the current set of clusters is returned. It will be understood that, because the threshold can be varied, in accordance with the probability distribution curves discussed at FIG. 8, more or less merging of clusters will occur depending upon how the balance between the level of granularity of result and the level of data compression desired for a particular embodiment, and a particular application.

Referring next to FIGS. 15B-15D, a more detailed exposition of clustering in accordance with some embodiments of the present invention can be appreciated. As discussed above, clustering could be for the entire video or for a small section. For greater performance, it might be applied only to a narrow band of time in the video corresponding to what the system is currently reporting to the user in the aforementioned grid. If the goal is to more comprehensively analyze the entire video, then clustering could be applied to all tracklets or at least larger sections of the video.

Further, clustering can be hierarchical. Outer tiers in the hierarchy yield the most compression and least accuracy, i.e., the highest likelihood that two tracklets that represent different underlying faces/objects are erroneously grouped together in the same cluster. Inner tiers yield the least compression but the most accuracy. One such hierarchical embodiment comprises three tiers as follows, and as depicted in FIGS. 15C and 15D:

Outer Tier (Cluster), 1580A-1580n: Each cluster C contains multiple key groups K. Key groups within a cluster are probably the same face/object. Different clusters C are almost surely different faces/objects.

Middle Tier (Key Group), 1585A (in Cluster 0), 1587A-1587B (in Cluster 1), 1589A (in Cluster 2), and 1591A (in Cluster N): A key group is simply a group of tracklets where the group itself has a representative embedding. In its simplest form, the group's representative embedding is the same as the representative embedding of the first tracklet added to the group. Tracklets within the key group are almost surely the same face/object. In an embodiment, when a key group is presented to a user, the key face is displayed as representative of that key group.

Inner Tier (Tracklet), T1-Tm: Each tracklet T is as described previously. Detections within a tracklet are substantially certain to be the same face/object.

One algorithm to generate such a hierarchical set of clusters is shown in flow chart form in FIG. 15B, and is further described as follows with reference numerals as indicated, with the first four steps below being collectively designated at 1525 on FIG. 15B:

```
  Let C[ ] be an empty set of clusters representing the outermost tier
  Let Tolerance_{Cluster} be the tolerance threshold for determining when two key
  groups belong in the same cluster
  Let Tolerance_{Key} be the tolerance threshold for determining when two
  tracklets belong in the same key group
  Given a list of tracklets T[ ]
```

| | |
|---|---|
| For each tracklet Tᵢ: | (1530) |

```
    For each cluster Cᵢ in C[ ]:
      For each key group Kᵢ in Cᵢ:
(1540)
        Calculate the vector distance Dᵢ between the
      representative embedding of Tᵢ and the representative
      embedding of the key tracklet in Kᵢ
      If Dᵢ < Tolerance_{Key} then add Tᵢ to the key group Kᵢ and
```

| | |
|---|---|
| continue with the next tracklet T in step (1530) | (1545) |

```
    If min(D₁₋ₙ) < Tolerance_{Cluster}:
      Create a new key group K with tracklet Tᵢ as the key tracklet
      and add K to Cᵢ then continue with the next
```

| | |
|---|---|
| tracklet T in step (1530) | (1560) |

```
  T was not within tolerance of any given cluster C, so create a new key
  group K with T as the key tracklet, add to a new cluster C, and add C to the
  list of all outer clusters C[ ] and continue with next tracklet T in step (1530)
```

(1565-1575)

To assist in understanding, the foregoing process can be visualized with reference to FIG. 15C. A group of tracklets T1-Tn, indicated collectively at 1578, is available for clustering. Each cluster, indicated at 1581A-n and captioned Cluster 0 through Cluster n, comprises one or more key groups, indicated at 1580A-n and captioned Key Group 0 through Key Group n. Through the process discussed above and shown in FIG. 15B, each tracklet is assigned to a Key Group, such as key group 1583A of Cluster 1580A. Each Cluster may have more than one Key Group, and the first tracklet assigned to each Key Group is the key tracklet for that group, as indicated at 1585A in Cluster 0. Each Key Group can have more than one tracklet. Embedding distance, calculated by any approach suitable to the application, is used to determine which key group a particular tracklet is assigned to.

In the example shown, the first tracklet, selected randomly or by any other convenient criteria and in this case T10, is assigned to Cluster 0, indicated at 1580A, and more specifically is assigned as the key tracklet 1585A in Cluster 0's Key Group 0, indicated at 1583A. The embedding of a second tracklet, T3, is distant from Cluster 0's key (i.e., the embedding of T10), and so T3 is assigned to Cluster 1, indicated at 1580B. As with tracklet T10, T3 is the first tracklet assigned to Cluster 1 and so becomes the key of Cluster 1's key group 0, indicated at 1587A. A third tracklet, T6, has an embedding very near to the embedding of T10—i.e., the key for key group 0 of Cluster 0—and so joins T10 in key group 0 of Cluster 0. A fourth tracklet, T7, has an embedding distance that is far from the key of either Cluster 0 or Cluster 1. As a result, T7 is assigned to be the key for Key Group 0 of Cluster 2, indicated at 1589A and 1580C, respectively. A fifth tracklet, T9, has an embedding distance near enough to Cluster 1's key, T3, that it is assigned to the same Cluster, or 1580B, but is also sufficiently different from T3's embedding that it is assigned to be the key for a new key group in Cluster 1's Key Group 1 indicated at 1587B. Successive tracklets are assigned as determined by their embeddings, such that eventually all tracklets, ending with tracklet Tn, shown assigned to Key Group N, indicated at 1591A of Cluster N, indicated at 1580n, are assigned to a cluster and key group. At that time, spaces 1595, allocated for tracklets, are either filled or no longer needed.

The end result of the processes discussed above and shown in FIGS. 15B and 15C can be seen in FIG. 15D, where each tier—Group of Clusters, Cluster, Key Group—can involve a different levels of granularity or certainty. Thus, each cluster typically has collected images of someone different from each other cluster. For example, Cluster 0 may have collected images that are probably of Bob but almost certainly not of either Mike or Charles, while Cluster 1 may have collected images of Mike but almost certainly not of either Bob or Charles, and Cluster N may have collected images of Charles but almost certainly not of either Bob or Mike. That's the first tier.

Then, within a given cluster, for example Cluster 0, while all of the images are probably of Bob, it remains possible that one or more key groups in Cluster 0 has instead collected images of Bob's doppelganger, Bob2, such that Key Group 1 of Cluster 0 has collected images of Bob2. That is the second tier of granularity.

The key group is the third level of granularity. Within a key group, for example Key Group 0 in Cluster 0, every tracklet within that Key Group 0 almost surely comprises images of Bob and not Bob2 nor anyone else. In this manner, each cluster represents a general area of the embedding space with several centers of mass inside that area. Using keys within each cluster reduces computational cost since it allows the system to compare a given tracklet with only the keys in a cluster rather than every tracklet in that cluster. It also produces the helpful side-effect of a few representative tracklets for each cluster. Note that, while three tiers of granularity have been used for purposes of example, the approach can be extended to N tiers, with different decisions and actions taken at each different tier. This flexibility is achieved in at least some embodiments through the configuration of various tolerances.

More specifically, and referring to steps 1540 and 1550 of FIG. 15B, the settings of Tolerance_{key} and Tolerance_{cluster} are used in at least some embodiments to configure the system to achieve a balance between data compression and search accuracy at each tier. This approach is an efficient variant of agglomerative clustering based on the use of preset fixed distance thresholds to determine whether a tracklet belongs in a given cluster and, further, whether a tracklet constitutes a new key within that cluster. As discussed above, each unassigned tracklet is compared to every key within a given existing cluster. The minimum distance of those comparisons is compared against Tolerance_{key}. If that minimum distance is less than or equal to Tolerance_{key}, then that tracklet is assigned to that key group within that cluster. If the minimum distance is greater than Tolerance_{key} for every key group within a cluster, but smaller than or equal to Tolerance_{cluster} for that cluster, then the unassigned tracklet is designated a key for a new key group within that cluster. If, however, the minimum distance for that unassigned tracklet is greater than Tolerance_{cluster} then the unassigned tracklet is not assigned to that cluster and instead is compared to the keys in the next cluster, and so on. If that unassigned tracklet remains unassigned after being compared with all existing clusters, either a new cluster (cluster N, step 1575 of FIG. 15B) is defined or, in some embodiments, the unassigned cluster is rejected as an outlier.

Such a hierarchy allows for different degrees of automated decision making by the system depending on how trustworthy and accurate the clustering is at each tier. It also allows the system to report varying degrees of compressed data to the user. At outer tiers, the data is more highly compressed and thus a user can review larger sections of data more quickly. The trade off, of course, is the chance that the system has erroneously grouped two different persons/objects into the same cluster and thus has obfuscated from the user unique persons/objects. The desired balance between compression of data, allowing more rapid review of large amounts of data, versus the potential loss of granularity is different for different applications and implementations and the present invention permits adjustment based on the requirements of each application.

As noted initially, there are two main aspects to the present invention. In some applications, an embodiment which combines both aspects can be desirable. Those skilled in the art will recognize that the first aspect, discussed above, uses a per-frame analysis followed by aggregation into groups. The per-frame approach to performing a search has the advantage that it naturally segments to a query in the sense that a complex query, particularly those with OR terms, can match in multiple ways simultaneously. As objects and identities enter and leave the scene—or their confidences change due to view point—the “best” reason to think the frame matched the query may change. It can be beneficial to split results so that these alternative interpretations of the data can be shown. The second main aspect of the invention, involving the use of tracklets, allows for more pre-processing of the data. This has advantages where no probe image exists although this also means that detections of objects are effectively collapsed in time up front.

In at least some embodiments of the invention, the system can combine clustering with the aforementioned optimized layout of tracklets as an overlay layer or other highlighting or dimming approach, as illustrated in FIGS. 16A-16C. As before, for some embodiments, while the tracklets in the grid 1400 are shown in the figures as shaded squares, when displayed to a user the tracklets will display the representative image for that tracklet. This can be appreciated from FIG. 16C, which shows how data in accordance with the invention may actually be displayed to a user, including giving a better sense of how many representative images might be displayed at one time in some embodiments.

Thus, to provide a visual aid to the user, all tracklets within a given cluster, e.g. tracklets 1600 can be highlighted or outlined together and differently than tracklets of other clusters, e.g. tracklets 1605, to serve to allow a human user to easily associate groups of representative faces/objects and thus more quickly review the data presented to them. Alternatively, the less interesting tracklets can be dimmed or blanked. The system in this sense would emphasize its most accurate data at the most granular tier (tracklets) while using the outermost tier (clusters) in an indicative manner to expedite the user's manual review.

Referring particularly to FIG. 16B, a process for selecting tracklets for dimming or highlighting can be better appreciated. At 1615, a “pivot” tracklet 1620 with its representative image is selected from a group of tracklets 1625 in the grid 1400. At 1630, embedding distances are calculated between the pivot tracklet and the other tracklets in the grid. Then, at 1635, tracklets determined to have an embedding distance less than a threshold, indicated at 1640, are maintained while tracklets determined to have an embedding distance greater than a threshold, indicated at 1645, are dimmed.

To further aid the visualization and readability of the generated interface, the facial recognition system may dim certain faces on the interface based on anticipated features of the suspect, as shown in FIG. 16C. When only an embedding is available, selecting (by clicking on them) similar looking faces may yield a set of close matches. For example, other samples in the grid that are close to this set can be highlighted making it easier to visually spot more similar faces. This implementation is illustrated in the following illustrated interface.

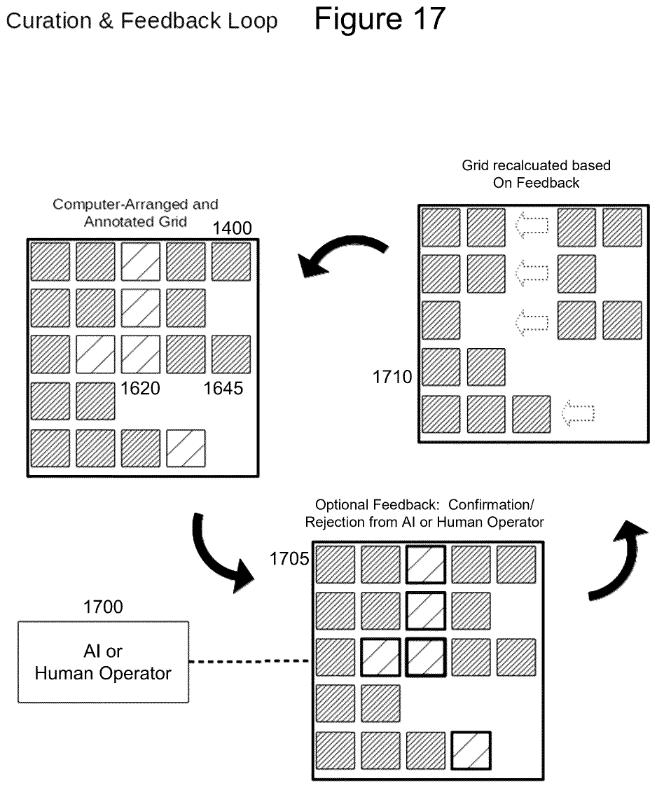

As a further aid to the user, a curation and feedback process can be provided, as shown in FIG. 17. Using the aforementioned visual aids, a human operator 1700 can identify sets of faces within the grid 1400 which they can confirm are the same person, e.g. as shown at 1705. Selecting a set of faces (e.g., by clicking) enables extraction of those faces from the grid as a curated person of interest, whereupon the grid re-adjusts as shown at 1710. In an embodiment, rows in the grid where faces were extracted are reduced in size, or eliminated altogether. In an alternative embodiment the grid is recalculated based on the operator's action. In this way, the grid becomes interactive and decreases in noisiness as the operator engages with the data.

In an embodiment, curated persons of interest appear in a separate panel adjacent to the grid. Drilling into one of the curated persons (by clicking) will update the grid such that only faces deemed similar to that person (within a threshold) are displayed. Faces in the drilled-down version of the grid have a visual indicator of how similar they are to the curated person. One implementation is highlighting and dimming as described above. Another implementation is an additional visual annotation demarcating “high”, “medium”, and “low” confidence matches.

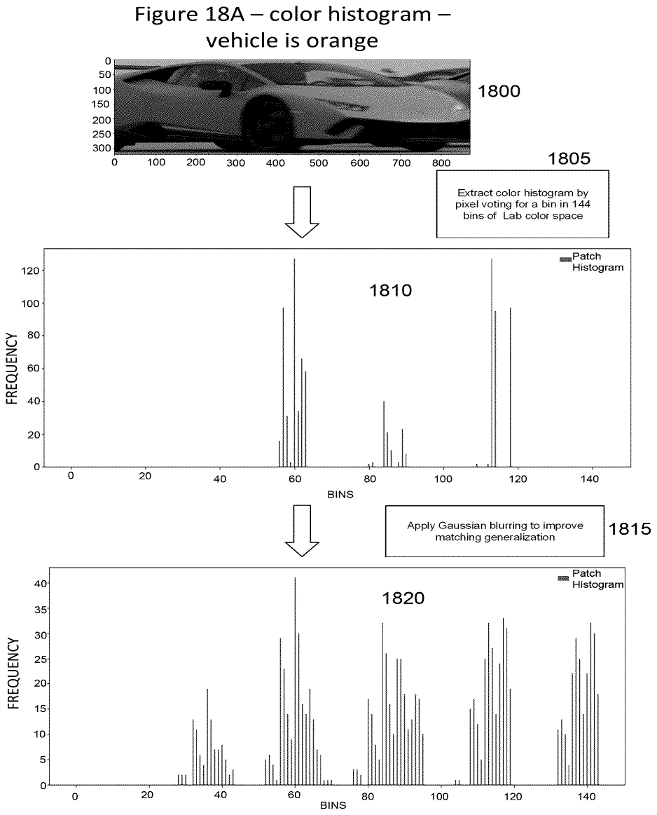

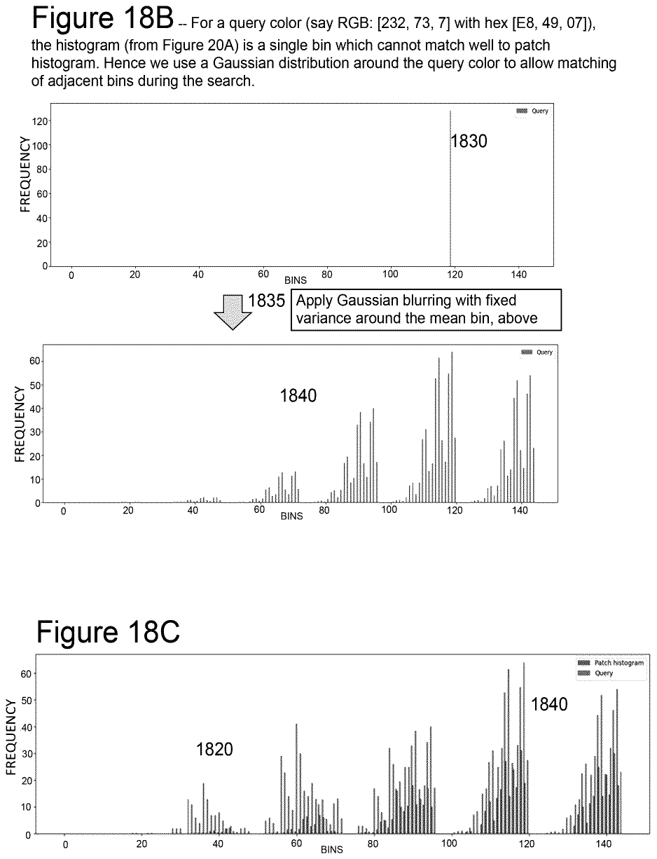

It will be appreciated that, in some embodiments, no human operator 1700 is involved and the foregoing steps where a human might be involved are instead fully automated. This can be particularly true for applications which tolerate lower thresholds of accuracy, such as fruit packing, customer loyalty programs, and so on. Referring next to FIGS. 18A-18C, a still further aspect of some embodiments of the present invention can be better appreciated. FIGS. 18A-18C illustrate the use of color as an element of a query. In many searches for objects, color is a fundamental requirement for returning useful search results. Color is usually defined in the context of a “color space”, which is a specific organization of colors. The usual reference standard for defining a color space is the CIELAB or CIEXYZ color space, often simply referred to as Lab. In the Lab color space, “L” stands for perceptual lightness, from black to white, while “a” denotes colors from green to red and “b” denotes colors from blue to yellow. Representation of color in the Lab color space can thus be thought of as a point in three-dimensional Space, where “L” is one axis, “a” another, and “b” the third.

In an embodiment, a 144-dimensional histogram in Lab color space is used to perform a color search. Lab histograms use four bins in the L axis, and six bins in each of the “a” and “b” axes. For queries seeking an object where the query includes color as a factor, such as a search for an orange car of the sort depicted at 1800 in FIG. 18A, a patch having the color of interest is selected and a color histogram is extracted, again using Lab color space. For convenience of illustration, in FIG. 18A Lab color space is depicted on a single axis by concatenating the values. This appears as a plurality of different peaks as shown at 1810.

Because colors from patches will have natural variance due to the variety of lighting conditions under which the image was captured, whereas a query color typically is a point in Lab color space with zero variance, artificial variance is added to the query to allow matching with colors that are close to the query color. This is achieved by using Gaussian blurring on the query color, 1815, which results in the variety of peaks shown at 1820 in FIG. 18A.

The query color, essentially a single point in Lab color space, is plotted at 1830. Again Gaussian blurring is applied, such that the variety of peaks shown at 1840 result. Then, at FIG. 18C, the Gaussian plot of the patch histogram is overlaid on the Gaussian plot of the query color, with the result that a comparison of the query color and patch color can be made. Matching between the two 144-dim histograms h1 and h2 is performed as:

$$\sum i [ 0.5 * min ( h 1 [ i ] , h 2 [ i ] 2 / ( h 1 [ i ] + h 2 [ i ] ) ]$$

Depending upon how a threshold for comparison is selected, the object that provided the patch—e.g., the car 1800—is either determined to be a match to the query color or not.

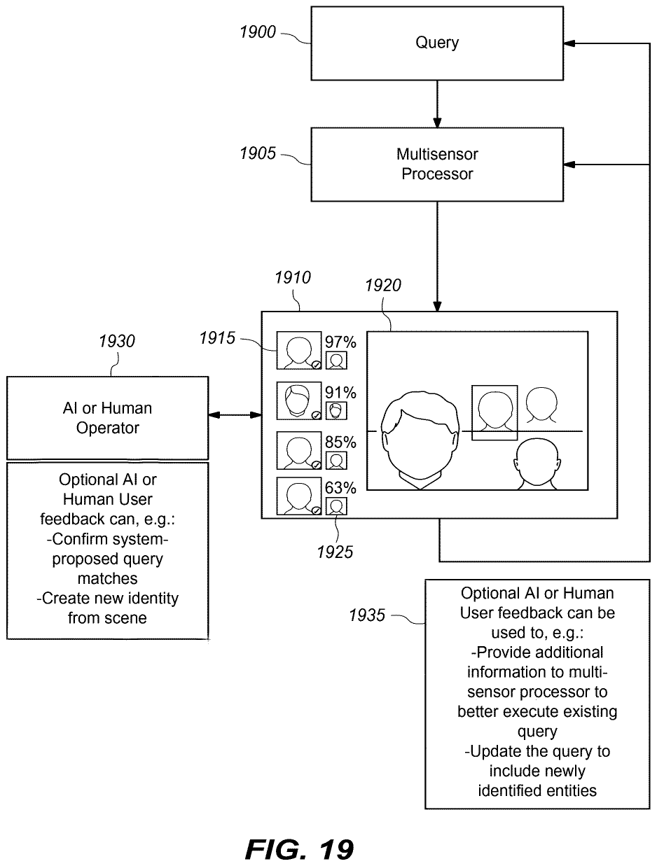

Referring next to FIG. 19, a report and feedback interface to a user can be better appreciated. A query 1900 is generated either automatically by the system, such as in response to an external event, or at a preset time, or some other basis, or by human operator 1915. The query is fed to the multisensor processor 1905 discussed at length herein, in response to which a search result is returned for display on the device 1910. The display of the search results can take numerous different forms depending upon the search query and the type of data being searched. In some embodiments as discussed herein, the search results will typically be a selection of faces or objects 1915 that are highly similar to a known image, and in such instances the display 1910 may have the source image 1920 displayed for comparison to the images selected by the search. In other embodiments, the presentation of the search results on the display may be a layout of images such as depicted in FIGS. 16A-16C, including highlighting, dimming or other audio or visual aids to assist the user. In any case, system confidence in the result can be displayed as a percentage, 1925. If operator feedback is permitted in the particular embodiment, the operator 1930 can then confirm system-proposed query matches, or can create new identities, or can provide additional information. Depending upon the embodiment and the information provided as feedback, one or more of the processes described herein may iterate, 1935, and yield further search results.

The foregoing examples and embodiments of the invention involve image capture devices that are essentially stationary. While these examples and embodiments have many applications, there are a number of applications where it is desirable for the image capture device to be mobile, and to detect and identify objects, including but not limited to people, whose presence and movements can be captured by the mobile image capture device. As will be apparent from the following, the foregoing discussion of detecting, identifying, grouping and clustering faces or other objects, in general apply equally well to a data stream captured by a mobile device as to a data stream captured by a stationary device. By also capturing adding location data, the movements of the pedestrian can be combined with the data stream to enable detection, identification and monitoring of trailing objects along the route traveled by the pedestrian.

For example, in an embodiment, a pedestrian has a rearward-looking camera mounted to a helmet or other convenient mount. As the pedestrian follows a route, the camera captures images of the people behind the pedestrian. By applying the detection and identification processes described in detail hereinabove, an embodiment of the system of the present invention can detect and identify faces that occur frequently in the data stream. Further, using the grouping and clustering processes described above, images of the same person can be grouped and a representative image identified. The grouping can be based on the entire route, or the route can be divided into shorter portions, or route segments, for example based on a change in direction above a preset threshold, i.e., a “turn”.

Substantially the same technique can be used for data capture devices mounted on a lead vehicle, where the objective is to detect and identify other vehicles traveling at least some portion of the lead vehicle's route. In certain security situations, for example a high value individual traveling by car along a route, there can be a concern among the individual's security staff that the individual's transportation might be followed, i.e., “tailed”. One or more such tailing vehicles will generally try to avoid being detected by, among other techniques, trying to stay as far back as possible and behind other vehicles. When there are other vehicles on the road it can be surprisingly difficult to detect and identify trailing vehicles, particularly while simultaneously trying to operate the lead vehicle. For clarity and simplicity of explanation, the following discussion will focus on a lead vehicle and one or more trailing vehicles, but it will be understood by those skilled in the art that the processes described hereinafter apply equally well to a lead pedestrian and potentially trailing pedestrians or a combination of potentially trailing pedestrians and vehicles.

To assist a human operator in meeting the challenges described above, in an embodiment the present invention comprises a computer vision based solution configured to assist a human operator by providing at least one representative image of each of one or more potentially trailing vehicles where the images are displayed in a manner that permits the human operator to make a rapid assessment of each of the potentially trailing vehicles. In an embodiment, the process comprises capturing a data stream including images or other frames of data sufficient to distinguish one or more trailing vehicles, and further capturing location information, e.g., GPS data, for the lead vehicle. Optionally, the GPS data is overlaid or otherwise combined with map data for the route traveled by the lead vehicle. Referring next to FIG. 20, an embodiment of a system in accordance with this aspect of the invention can be better appreciated. A processor 2000 receives data inputs from one or more cameras 2005 and GPS unit 2010. The processor 2000 communicates bidirectionally with memory array 2015, which can provide control programs to the processor as well as store the data streams from camera(s) 2005 and GPS unit 2010. Optionally, the memory array 2015 also stores map data 2020 with which the GPS data can be combined. The processor receives inputs from and provides output data to either a local I/O 2025 or remote I/O 2030 through an internet cloud link 2035.

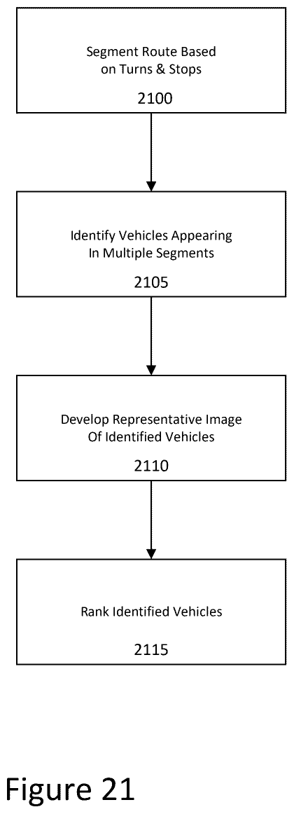

As with the pedestrian example discussed above, and with reference to FIG. 21, in some embodiments the process for vehicles further comprises dividing the route traveled by the lead vehicle into route segments representative of regions between turns and stops in the route, as shown at 2100. In these aspects of the invention, an understanding of the reasons for the use of segments based on turns or stops is important. If a lead vehicle is traveling on a roadway with no intersections, such that there is no opportunity for either a lead vehicle or a potentially trailing vehicle to turn away, any potentially trailing vehicle will appear repeatedly but no conclusions can be drawn as to whether the trailing vehicle is actually attempting to follow the lead vehicle. When traveling on such a roadway, there is no new information in repeated observations of the same vehicle or vehicles.

This changes, however, once the roadway has intersections that would allow either the lead vehicle or the trailing vehicle to turn off the original roadway. If the roadway comes to a Y intersection, where there is an equal probability of a vehicle taking either direction, then one bit of information is provided if the potentially trailing vehicle follows the lead vehicle through that intersection. The probability of a trailing vehicle following a lead vehicle through N such intersections is [1/2]**N. Again assuming that each route through each of the intersections has equal a priori probability, then to have a trailing vehicle follow a lead vehicle through multiple turns is unlikely to occur by chance. Where the intersections are more complex, such as a four-way intersection instead of a Y intersection, and again assuming equal probabilities at each of N intersections, the probability become [1/3]**N. Thus, referring again to FIG. 21, in at least some embodiments the process further comprises algorithmically analyzing in a processor-based system the data stream to detect and identify vehicles that most likely appeared in multiple frames. In at least some embodiments, the process of the invention further comprises determining algorithmically the vehicles that most likely appeared in the greatest number of segments, as shown at step 2105. A vehicle is said to appear in a segment simply if there is at least one frame in the segment where it is visible. A “count” for a vehicle is the number of segments in which a given vehicle appears.

While the foregoing discussion assumes that each choice at each intersection has equal probability, the addition of mapping information (FIG. 20) in FIG. 21 provides the system the ability to identify a latent state sequence of turns, rather than simply relying on GPS data, which is sometimes imprecise. By combining map data with GPS data, for example through the use of a Viterbi algorithm where the GPS signal is the observation and the Viterbi algorithm provides an analysis of the true latent state sequence of turns along the map, the hard routing rules of a map with the less precise, even “fuzzy”, GPS signal enables a forward-back type of algorithm where hard constraints of the map can be propagated to the entire drive to determine an optimal solution regarding turns. For example, if the route includes two turns very close to one another, but one has a turn restriction, the system knows that the route has to be at the turn that does not have the turn restriction even if the error in the GPS signal indicates otherwise.

Further, for embodiments where mapping is available, data associated with each of the arms of a given intersection indicates whether that arm is residential, arterial, highway, major highway, and so on, thus permitting the system to predict what the traffic on that segment of the route is likely to be. Consequently, the system can develop a more meaningful probability distribution for a random car taking a specific arm of an intersection, such a choosing a major artery over a residential side street. An additional benefit of map matching is that the system recognizes when the route goes through an intersection even if the lead vehicle drives straight through. By using anonymized GPS track information, the basic analysis of “which care is seen in multiple segments” can be replaced by an algorithm that detects vehicles that have followed the lead vehicle through the turns that would be least likely on an a priori basis. In such an embodiment, the segmentation logic of the system can be configured to prioritize observations of a trailing vehicle in segments that are between a turn not commonly taken by most drivers. If large scale navigation statistics are available, a purely data driven solution to estimating the a-priori probability of traversing any given route through an intersection could be used.

From the foregoing, it will be appreciated that, whether map matching is used or not in a particular embodiment, the objective is to identify trailing vehicles that appear in multiple segments of the lead vehicle's route, where the hierarchy of identifications is based, for example, the number of segments in which a given vehicle was detected although any other criteria that would allow a human user to make a rapid but effective assessment can also be used Thus, and still referring to FIG. 21, in step 2110, a representative image of identified vehicles is selected is developed. At step 2115, the identified vehicles are ranked according to confidence that a given vehicle is trailing the lead vehicle, which in at least some embodiments is based on count.

In some embodiments, the process of FIG. 21 can be optionally supplemented to comprise the steps of selection of a reference vehicle, and estimation of the likelihood that a specific reference vehicle is present in the captured data of a given route segment. When such options are included in an embodiment, step 2105 is modified to estimate the number of route segments in which a reference vehicle appears. The result is a three-way ranking of detected and identified vehicles, combined with selection of a representative thumbnail as a summary view that provides actionable data whereby a human operator can rapidly confirm or reject the vehicles selected through the detection and identification steps.

In embodiments where only GPS information is available, a segmentation algorithm based upon the Douglas-Peucker algorithm can be used to segment the GPS track of the route. In an embodiment, an iterative approach is used which can be implemented in real time scenarios as well, as shown below.

Define p₀ as the location of the first frame of the video. Then for every consecutive frame do the following:
1. At frame n after p₀, find the point pᵢ, 0<i<n, that is farthest from the line p₀→pₙ.
2. If pᵢ is farther than a predetermined threshold from the line, choose this pᵢ as the candidate point for segment split. Otherwise return to step 1.
3. If I₀ is defined, compare the angle between I₀ and the line p₀→pᵢ. If this angle is more than the threshold, then p₀ is a segment transition point, continue to step 4. If I₀ is not defined (i.e. this is the first segment of the route) go to step 4. Otherwise, return to step 1.
4. Set I₀ to the line p₀→pᵢ, and p₀→pᵢ. Go to step 1.

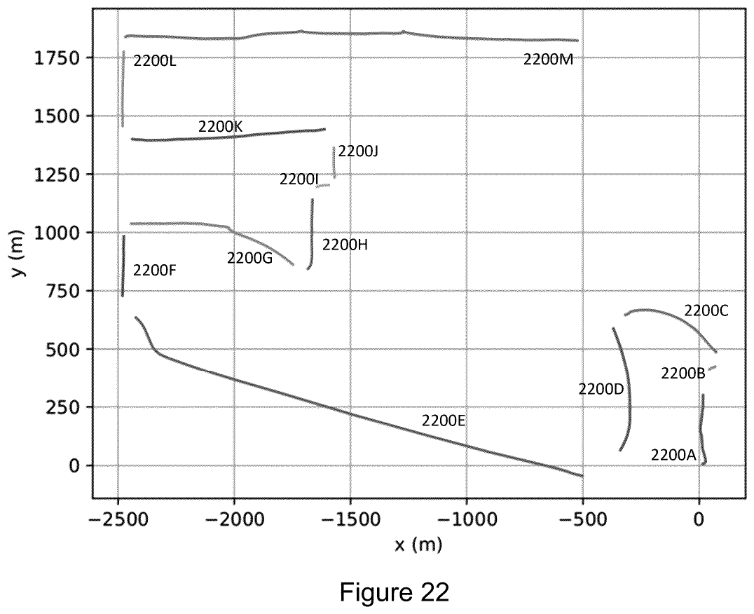

These steps can be viewed as an incremental Douglas-Peucker simplification of the GPS trace of the lead vehicle's route, followed by greedy clustering of the line segments. Steps 1 and 2 look for a point where a line segment should be formed in the simplified trace. A good threshold is preferably at least as large as any expected error in the GPS location. Simply selecting the points pᵢ would produce a Douglas-Peucker simplified line. To avoid splitting slowly curving paths, such as highways, into multiple segments, step 3 estimates the curvature by the angle between line segments and, if the angle between the segments is below a predetermined threshold angle (for example, ten degrees although a narrower or broader range is also acceptable for some implementations), effectively combines consecutive segments of the simplified curve into a single segment. The threshold angle defines the smallest allowed curve radius, and angle above that threshold are interpreted as a segmentation point. The results of the algorithm can be seen in FIG. 22, where the route of the lead vehicle is divided into segments 2200A-M.

As briefly discussed above in connection with step 2105, at this point in the process the video captured by the lead vehicle has been divided into segments, where each segment represents a recording of the route between intersections and possible turns. In addition, stops can, optionally in some embodiments, define a segment transition. Then, for every unique vehicle seen so far, determine or at least estimate the number of segments in which the vehicle appears, i.e., count. Then, as discussed above in connection with step 2115, the vehicles appearing in most number of segments are ranked and provided as an output for review by a human operator.

In practice, the inability to detect and identify vehicles perfectly through algorithmic analysis makes the foregoing analysis challenging. Computer vision/machine learning techniques consistent with those described in connection with FIGS. 2-13, above, are applied to train an object detector to detect vehicles, including the use of bounding boxes, etc. as discussed above. Typically, such a detector is subject to missed detections and false positives. To improve accuracy in determining whether two vehicle detections are the same vehicle, embodiments of the present invention use automatic license plate reading and vehicle embeddings. It is also desirable to reduce the number of vehicle detections by removing those that are unlikely to be of interest, such as detections originating from vehicles parked along the side of a roadway. Such detections add complexity to the analysis. By combining GPS information with the bounding box size evolution to estimate the relative motion of vehicles captured by the camera or other data capture device, and remove detections of vehicles that are not moving with respect to the ground can be removed.

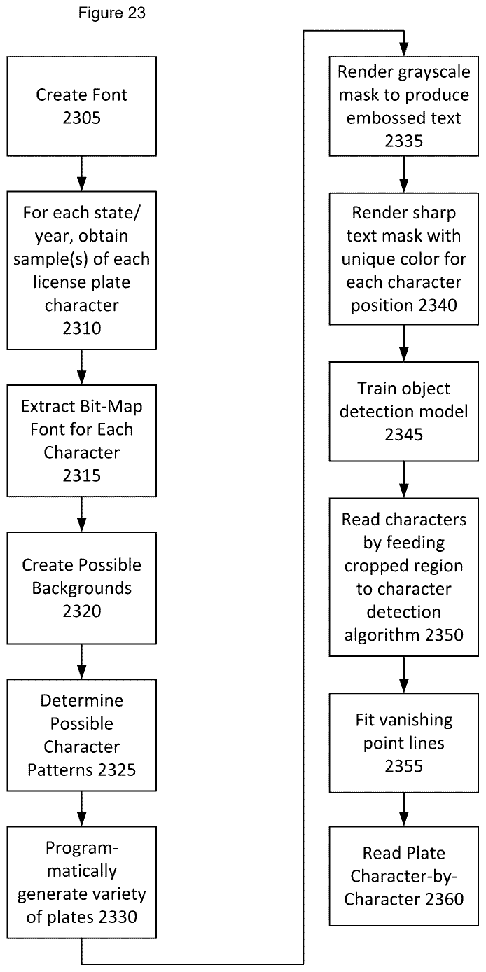

Referring next to FIG. 23, for automatic license plate recognition in an embodiment, a standard license plate detector is supplemented by adding an object detector trained to detect license plate characters using either synthetic license plate images or synthetic character images, depending upon the embodiment. In some embodiments, the license plate detector is trained to detect characters on a character-by-character basis.

Still with reference to FIG. 23, in such an embodiment, the synthetic license plate images are produced using the following process:
Create a font for the possible characters, 2305
Obtain enough samples of the license plate type (e.g. state/year of license plate) to have at least one sample of each possible character, 2310.
Extract a bit-map font using these images by cropping out characters, scaling and warping them to create a clean frontal view and turning each of them into a black and white image, 2315 Create possible backgrounds for the license plate (by, e.g., Photoshop), 2320
Determine possible character patterns, 2325

The resulting configuration looks like:

```
[
  {
    “name”: “California Standard”,
    “weight”: 3.0,
    “backgrounds”: [
    “render_artifacts/CA/CA.png”,
    “render_artifacts/CA/CAv2.png”,
    “render_artifacts/CA/CAv3.png”
    ],
    “fonts”: [“fonts/TTF Fonts/dealerplate_california.ttf”],
    “font_specs”: [[16, 215, 330]],
    “fontcolors”: [[0.007, 0.021, 0.163]],
    “patterns”: [[“#%%%###”, 0.9],
      [“???????”, 0.07],
      [“??????”, 0.01],
      [“?????”, 0.01],
      [“????”, 0.007],
      [“???”, 0.003]]
  },
  {
    “name”: “Virginia Standard”,
    “weight”: 2.0,
    “backgrounds”: [
    “render_artifacts/VA/VA1.png”,
    “render_artifacts/VA/VA2.png”,
    “render_artifacts/VA/VA3.png”
    ],
    “fonts”: [“fonts/TTF Fonts/dealerplate_virginia.ttf”],
    “font_specs”: [[16, 215, 300]],
    “fontcolors”: [[0.0015, 0.0135, 0.165]],
    “patterns”: [[“%%%-####”, 0.9],
      [“???????”, 0.07],
      [“??????”, 0.01],
      [“?????”, 0.01],
      [“????”, 0.007],
      [“???”, 0.003]]
  },...
]
```

An infinite variety of plates are then programmatically generated from the foregoing with random text, random orientation, random illumination as well as labels for each individual character in the rendering, as shown at 2330 in FIG. 23.

The synthetic text is injected into the rendering as an image texture which is manipulated in the rendering pipeline. By rendering the same mask as a grayscale image with blurred edges to produce an embossed text, 2335, as well as a sharp text with each character position in a unique color, 2340, two versions of the image are rendered: one that looks like a realistic license plate, and another that shows exactly the same viewpoint but provides a color-coded mask for the characters. In an embodiment, the mask includes any occlusions that might come from features such as bumpers or other features which may be modeled. By this approach, highly accurate character level labels can be created for every image. The resulting data is used to train an SSD-based object detection model, with each possible character being one “object class” to detect, step 2345 in FIG. 23.

Following the initial detection steps discussed above, some post-processing character detection steps can be helpful in at least some embodiments. By feeding a cropped region of the image around every license plate detection to a character detection algorithm, step 2350, a relatively clean read of the characters can be achieved. In an embodiment, this is further refined by fitting a line through the top and bottom corners of the character detections using an exhaustive variant of the RANSAC method, step 2355. Two characters are enough to determine the lines that follow the tops and bottoms of the characters. In oblique views, these represent the vanishing lines of the license plate and a mathematical model can be fit that accounts for the varying spacing and scaling of characters across the image. Because of the limited number of character detections, every possible combination can be tried and then pick the solution that has the most support in terms of number of characters that fit the vanishing lines, step 2360. Any character then not part of this best solution is discarded as an outlier/false detection.

When a license plate can be read, it is a highly reliable and accurate method for associating car detections to “identities”. The challenge with relying on license plates to confirm that two vehicle detections are the same vehicle is that license plates are typically small features in the video frames or still images even if taken by the lead vehicle at relatively short distances. Consequently, in many real world scenarios the license plate is not sufficiently readable that it can be relied upon for confirmation of the identity of a trailing vehicle. In situations where a reliable read of a license plate is not available, an embodiment of the system of the present invention relies upon vehicle embeddings, similar to the face embeddings used in face recognition and described above.

Training for vehicles is achieved in substantially the same way as training a face embedding network for recognizing people, by creating training data where cars that are visually identical are considered as samples of a specific “identity”. Visually identical cars are considered the same vehicle, although anomalous variations can be included in the training as discussed below. With such training, an embedding extraction deep neural network produces an N-dimensional, L2-normalized feature vector from which the input is classified to one of several identities as labeled in the training data.

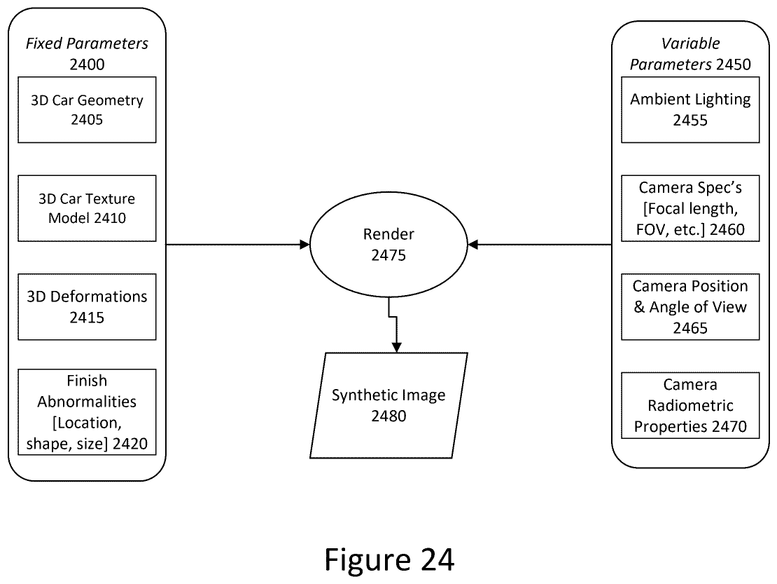

Similar to the use of synthetic data in reading license plates as discussed above, synthetic data can also be used in the generation of training sets for vehicles themselves, and can generate training data for details about a given vehicle that might make it unique, such as paint modifications or flaws, dents, decals, broken headlights, and so on, where detection of a vehicle with any such unique feature can yield a high confidence identification. The goal with such synthetic data is to take one particular car instance and simulate a large set of images of that car instance, systematically varying the many parameters of the image generation process. Car models (including the 3D geometry and textures) can be created or purchased from companies such as Hum3D, Turbosquid, etc. In an embodiment, the image generation process, shown in FIG. 24, can be carried out in any standard 3D based rendering software such as Blender which accepts all the classes of parameters discussed below.

In an embodiment, four classes of parameters are held constant for each vehicle, as shown at 2400 in FIG. 24: the 3D car geometry 2405, the color textures 2410, 3D deformations of the geometry 2415 to simulate things such as dents in various locations, and finish abnormalities 2420 to simulate paint modifications or damage, decals, special wheels, etc. In an alternative embodiment, some of the parameters are fixed, for example “red Honda Accord” and car texture, with the remaining two parameters allowed to vary within a reasonable random range. This allows simulation of, as just some examples, realistic dents or paint damage at various locations such as the left and right front quarter panels, left/right front/rear doors, left/right rear quarter panels, front/rear left/right side of bumpers, hood/trunk, windshield, side windows, rear window, wheels etc. Note that the 3D car geometry and associated deformations also apply to the interior of the car such as the rearview mirror, steering wheel and any coverings on it, any parking permits hanging from the rear view mirror, seat coverings, etc. Holding the four classes of parameters constant implies that only one particular vehicle is being referenced. For example there could be two red Honda accords but they may vary in the location of possible dents or paint damage, and represent two distinct cars of the same make, model, and color. By varying all of the other image generation parameters, as shown at 2450, such as ambient lighting 2455, camera specifications such as focal length, field of view, optical aberrations, camera position and angle of view 2465, camera radiometric properties 2470, etc., a wide variety of imaging conditions of the same car can be simulated in a rendering engine 2475 to yield synthetic images 2480. These images comprise training data for embeddings. By populating the training data set with a suitable volume of training images of distinguishing characteristics, and training the embedding generating neural network accordingly, embeddings that factor in distinguishing features can prove at least as reliable as license plate readings and can in some instances displace the benefit of a license plate image, for example a license plate image that is only partial, or is out of focus, or at an angle such that dewarping and other approaches to image correction are difficult.

Although the use of synthetic data for anomalous features can result in more accurate vehicle embeddings, in general a vehicle seen in side view is less likely to be following a lead vehicle as that side view means the vehicle is most often either already on a cross street or turning onto one, in which case side view observations can add noise to the detection process. In at least some instances, it is also easier to train a vehicle embedding focused on the front view of the vehicle than a generic view. Consequently, identity matching is generally much stronger for front views than side views and, in some embodiments, it is desirable to remove side view detections through the use of detection bounding boxes having an aspect ratio appropriate for a front view as a heuristic to remove side-view detections.

Whether a given group of detections is based on license plate readings, vehicle embeddings extracted without training sets using synthetic data, or vehicle embeddings where synthetic data is used to develop the training set, the objective is to estimate the probability that two or more detections represent the same vehicle. The embedding distance difference between the detections yields one version of this probability. Again, similar to faces, it is possible to track a vehicle through several frames in a video to form a “tracklet”: a sequence of consecutive detections where there is high confidence that the detections are of the same vehicle. In an embodiment, this is done by imposing stringent thresholds on similarity of either embedding, bounding box location or license plate read, or a combination of these, as discussed above in connection with FIGS. 7A and 8, where FIG. 8 provides an understanding of the tradeoffs between accuracy and data compression.

Next, in at least some embodiments the equality relationship between such tracklets is determined. Tracklets that indicate the same vehicle are expressed as id(track1)==id(track2), again based on license plate reading, or vehicle embeddings, or some combination of both that yield a desired level of confidence, substantially as described in FIG. 7B. A “representative embedding” for each tracklet is then determined using the same technique as used in face recognition, FIG. 13 above, to establish an average embedding with outliers either removed or reduced in influence, in at least some embodiments obtained through a RANSAC procedure. More specifically: the process can comprise randomly sampling some subset of candidate embeddings, then computing the distances to other embeddings in the set for each and counting the number of embeddings within some threshold. The sample that has the most embeddings within the threshold is selected, and the embeddings are averaged, after which it is desirable in at least some embodiment to normalize the resulting embedding to unit length, similar in manner to the approach discussed with respect to FIG. 13.

In embodiments that include a license plate reader process, for each frame a confidence metric is developed for each character at each position on the license plate. The location of the character detection, relative to the overall license plate detection, also provides an indication of the “position of the character”. This permits the system to insert spaces at any position in order to produce a standardized license plate string of fixed length.

However, the space estimation and does not always yield a reliable positioning of characters, particularly for license plates with short text and substantial leading or trailing space. Consequently, in at least some embodiments a fuzzy edit-distance is used to align the characters starting from the first observation.

Simultaneously, a statistical estimate is built of the character at each position on the license plate. The following is an example of the evolution of detection of the characters of the license plate:

| | Aligned view | Current Best Guess |
|---|---|---|
| 1^{st} Read: | 8 C D 7 1 2 3 | 8CD7123 |
| 2^{nd} Read: | A B C D 1 2 3 | ABCD7123 |
| 3^{rd} Read: | A 8 C D I 2 3 | A8CD123 |
| 4^{th} Read: | B C D 2 3 | BCD123 |
| 5^{th} Read: | B C D 1 2 3 | BCD123 |
| 6^{th} Read: | B C D 1 2 3 | BCD123 |
| 7^{th} Read: | B C D 1 2 3 | BCD123 |
| 8^{th} Read: | B C D 1 2 3 | BCD123 |

The example illustrates a few common situations. First, the early reads are often the poorest, as they originate from far away sightings when the vehicle first enters the camera's view. Although each of the characters comes with a detection confidence, that is omitted for this first step and for now equal confidence is assumed for all characters. Using the edit-distance, one can find the minimum edits required to match the read at time T+1 to the state at time T.

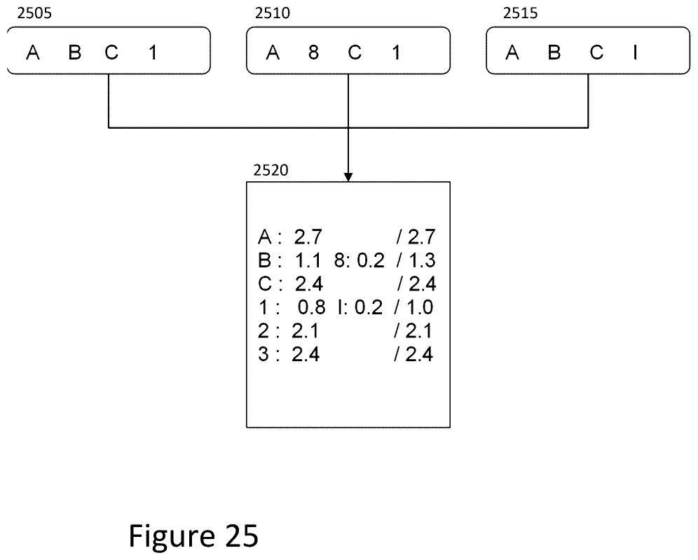

Then, in an embodiment, the detection confidence values associated with each character are aggregated. The current state at time T is represented by a “string” where each character is actually a probability distribution obtained by aggregating the confidences for each observed character, normalized by the total sum of confidences in that slot. Consequently, we can accumulate evidence for characters in each position over the tracklet. Multiple license plate reads then produce a “FuzzyString”, where each character is actually a probability distribution of characters, as shown in FIG. 25 where first, second and third reads are indicated at 2505, 2510 and 2515, where the resulting probability distributions are shown in table form at 2520.

A modified edit-distance based on the character probabilities is used to produce a confidence that two such distribution strings are equal, as well as to determine the optimal alignment of the next observation in the tracklet. In an embodiment, the Wagner-Fischer algorithm is used with “replacement cost” replaced by “probability that characters are the same” based on the accumulated character distributions. Constant penalty terms are used for insertion/deletion, where these can be thought of as relating to the probability of missing a character detection, or the probability of a false detection. In practice these can be tuned empirically to yield satisfactory results.

Depending upon the embodiment, there are various ways to estimate the “probability that characters are the same”. One is to consider every possible pair of the same character that has non-zero probability and sum these. For example, let c₁ be the distribution for a character in string 1, and c₂ a character in string 2. The probability P(c₁==c₂) can be computed as

$${\sum }_{x ∈ C} P ( {c}_{1} == x ) P ( {c}_{2} == x )$$

where P(c₁==x) is the normalized confidence. For example, for the second character in FIG. 25,

$$P ( c {==}^{′} {B}^{′} ) = \frac{1.1}{1.3} .$$

Thus, probability of two detections being the same can be converted into a cost by, e.g., considering −log probabilities.

Alternatively, and a preferred approach for at least some embodiments, take the most likely character for c₁ and c₂, denoted ĉ₁ and ĉ₂, respectively and compute the replacement cost as

$$( E ( {c}_{1} == {\hat{c}}_{1} ) - E ( {c}_{1} == {\hat{c}}_{2} ) ) \frac{E ( {c}_{2} == {\hat{c}}_{2} )}{E ( {c}_{2} == {\hat{c}}_{2} ) + E ( {c}_{2} == {\hat{c}}_{1} )}$$

where E denotes the un-normalized evidence for the character, e.g., a value of 2.7 for the character “A” in FIG. 25. This approach takes into account that characters in the other set may have originated from much cleaner pictures and so have considerably higher confidence in general. Because we use constants for the insertion and deletion penalty, the absolute magnitude is of little significance, because the other parameters can be tuned to match.

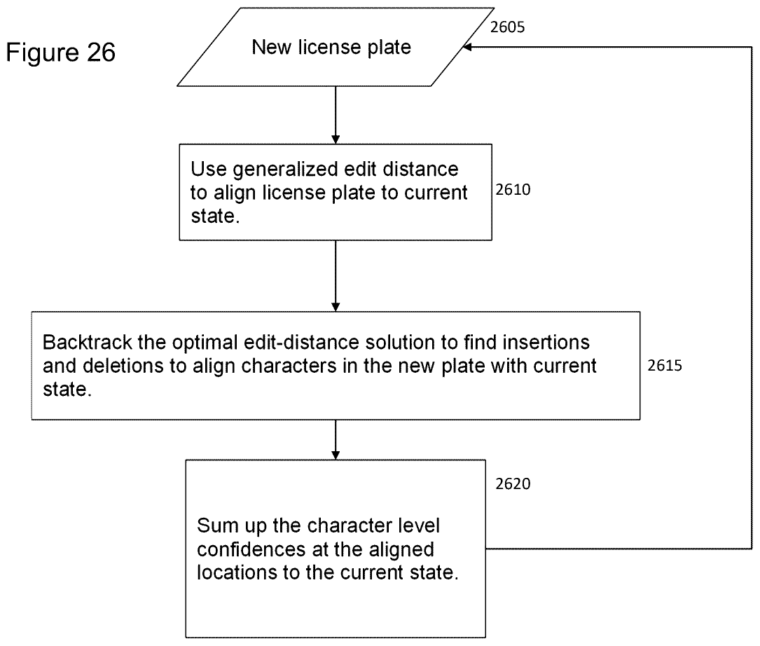

It will be appreciated from the foregoing that the replacement cost is designed to: (1) be high if one side is disproportionately confident of being different from the other, or (2) be minimal when both sides are equally likely to be the other side. By exploiting the accumulated evidence of what each character might be, the system and process of the present invention can produce a better estimate of how two strings might align. Further, by applying the “optimal edit sequence” thus obtained, we can assign each character in the new license plate text a position with respect to the current state, and combine the evidence at each character location by summing the character level confidences. In simplified terms, RANSAC-based outlier detection and averaging is used to produce a representative embedding for each tracklet, and generalized edit-distance is used to align license plate reads and accumulate character level evidence for the license plate for the tracklet. The foregoing is illustrated in simplified form in FIG. 26, where a new license plate is detected at 2605, generalized edit distance is used at 2610 to align the license plate to the current state, after which at 2615 the process backtracks the optimal edit-distance solution to find insertions and deletions to align characters in the new plate with the current state and, finally at 2620, sum the character level confidence values at the aligned locations to the current state.

This information can then be used to produce a “fuzzy logic truth value” for the statement “the two tracklets represent the same vehicle”. While not necessarily exactly equivalent, this can also be thought of as the probability that the two tracklets represent the same vehicle.

The same generalized edit distance can be used to compare the license plate character distribution strings of two tracklets. Again, any number of ways can be devised to combine the two modalities. For purposes of the present invention, in some embodiments if license plates were detected and any number of characters recognized, this is often a more reliable way to identify the vehicle than using embeddings that do not take into account anomalous details that uniquely identify a given vehicle. In such cases where anomalous details are not considered, identification is based on the use of license plates if available for both tracklets, and otherwise embedding-based confidence is used. Where the embeddings include consideration of anomalous details as described above, the embedding-based confidence can be compared to license plate confidence to yield a truth value. In an embodiment, an ad-hoc function can be used to map edit distance to the [0,1] range: α^{ed}, where α=0.25 is an arbitrary tuning parameter that should depend on the relative reliability of embedding and license plate reading. At α=1, probability is also 1 for being the same vehicle independent of the edit distance. At very low values, probability drops dramatically unless edit distance is exactly 0. If the probability value obtained this way is above a predetermined threshold, then this “probability” value is used. Otherwise, the probability value obtained from calibrated embedding distance is used.

Determining probabilities for vehicles is analogous to determining probabilities of faces, as discussed above in connection with FIG. 11, especially the equations shown there. In an embodiment, calibrated embedding distance refers to the following method. Using validation data, the probability of observing a given embedding distance can be estimated, given that the input pictures represent the same vehicle. Similarly, statistics can be collected reflecting the embedding distance between samples produced using images of different vehicles. For simplicity, denote these as P(d|positive) and P(d|negative), respectively. The value of interest is P(positive|d), in which case the Bayes rule yields:

$$P ( positive \vert d ) = \frac{P ( d \vert positive ) P ( positive )}{P ( d )} = \frac{P ( d \vert positive )}{\begin{matrix}P ( d \vert positive ) P ( positive ) + \\ P ( d \vert negative ) ( 1 - P ( positive ) )\end{matrix}} P ( positive )$$

As those skilled in the art will appreciate, this probability depends on the unknown prior probability of the two embeddings coming from the same vehicle. While in many circumstances precision/recall numbers are reported for embedding-distance-based techniques which amount to P(positive|d), these values are highly dependent on the validation set used. Such results are useful for comparing one embedding method to another, but not as useful when used in the context of a real world analysis.

For example, one might have 10,000 vehicle identities, with 100 pictures of each to train the vehicle embedding. In such a case, a system might use 90% of the images for training, and the remaining 10% for validation. In this set, P(positive)≈1:1000000. For this problem, when matching vehicles in nearby segments, we would expect the probability of picking tracklets of the same vehicle by chance to be somewhat higher than this. This is in contrast to face recognition applications. When searching for a specific face, the probability that a random face is the suspect is considerably smaller, even though the validation set for faces is similar.

So, we estimate the quantities P(d|positive) and P(d|negative) using the validation data. The accuracy of these estimates depends on the number of positive and negative pairs, respectively, but the shape does not. These can be thought of as histograms, and the process of estimating them from validation data as computing the expectation value using sample mean, and all statistical estimation theorems apply: more data, lower variance and so on. The prior probability P(positive), however, remains unknown and becomes a tuning parameter for the system.

With the tunable constant P(positive) given, and the conditional distributions estimated, the Bayes rule above can be used to turn the embedding distances into the likelihood of two tracklets representing the same vehicle. Again, we use this value if the license plate based value was below some threshold, or the embeddings include training for anomalous characteristics of a vehicle that permit identification as well or better than license plate reads. Stated more generally, if more training data is available to produce a stronger vehicle embedding so that the relative strength of license plate and embedding-based matching is more equal an embodiment might use, for example, either the max, mean, min or a weighted average of the two values. Alternatively, a human user can be permitted to vary the balance between license plate reads and embedding-based matching, as discussed in greater detail hereinafter.

In the end, here, we have produced a value that we can think of as P(tracklet1==tracklet2), which is based on properties of the embedding estimated from validation data, and confidences of character detection and aggregated evidence over multiple license plate reads within the tracklet.

In some embodiments, the next step in the overall process is to mine for a vehicle or vehicles most likely to appear in multiple segments by using the ability to estimate similarity of identity between tracklets. One challenge to such a step is, first, that detections of the same vehicle may be split into any number of tracklets within a segment and, second, that the identity relationship between tracklets is far from “the delta distribution”, i.e. it is not straightforward to determine unambiguously if two tracklets represent the same vehicle. Instead, only an estimate, i.e., a fuzzy likelihood that they are the same, can be achieved in many instances.

If P(tracklet1==tracklet2) was binary (i.e., a delta distribution), such that it's either 1 or 0, then the problem would be easy. Tracklets within each segment could be clustered unambiguously to individual vehicles, then compare the vehicles in each segment to unique vehicles in other segments to produce a map of unique vehicles overall and the number of segments in which each vehicle is seen. A kind of implicit clustering of tracklets to identities emerges.

Because the probability is not binary, however, then any arbitrary clustering of tracklets into identities can be seen to be possible, each one having some probability of being correct. Each possible clustering, also, produces some count of a potential vehicle identity appearing in some number of segments. To yield a helpful result to an analyst, embodiments of the system of the present invention look for clustering solutions that have a high probability of being correct, while simultaneously producing for at least one vehicle identity a high count indicating that that vehicle appears in multiple segments. Stated more simply, the aim is to produce a ranked list of possible solutions.

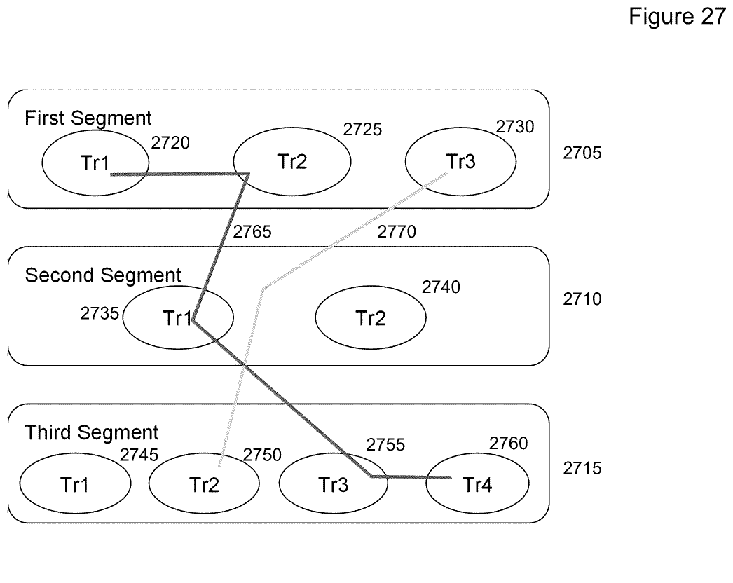

FIG. 27 depicts a few scenarios involving three segments 2705, 2710 and 2715. The first segment, 2705, includes three tracklets 2720, 2725, 2730, while the second segment contains tracklets 2735 and 2740 and the third segment contains tracklets 2745, 2750, 2755 and 2760. The line 2765 represents a situation where tracklets 2720 and 2725 in the first segment 2705 are images of the same vehicle V, tracklet 2735 in the second segment 2710 is also vehicle V, and tracklets 2755 and 2760 in third segment 2715 are also the same vehicle V. Thus, vehicle V appears in multiple segments. In contrast, the line 2770 illustrates a situation where a vehicle detected in the first and third segments 2705 and 2715 does not appear in the second segment 2710.

In some embodiments the only interest is in the identities that appear in the most segments, with clustering within segments of secondary importance. In such embodiments, each tracklet in each segment is treated as simply a reference point for a specific identity, i.e., a specific vehicle. Each segment can then be ranked individually based on its likelihood of matching the reference identify. Using the top-ranking tracklet in each segment, we can rank the segments by the most likely segment to contain the reference identity. Using an estimate of combined probability, such as the max likelihood in each segment, as the likelihood of the vehicle appearing in that segment, the system can produce an estimate of the number of segments in which the vehicle is seen.

Assume a reference tracklet has been picked, and has produced an estimate Pᵢ, i=1 . . . N of this identity appearing in tracklets 1 through N. We can now think of this as a generalized Bernoulli process, i.e. Pᵢ represents the probability that the i^{th} sample Xᵢ is 1, and of course 1−Pᵢ is the probability of 0.

It can be shown that the expected value of the sum of these values comes out to μ=E[Σᵢ Xᵢ]=Σᵢ E[Xᵢ]=Σᵢ Pᵢ. This average, however, yields the same count for a large number of very low confidence results—a condition which occurs naturally when the number of segments is large—as well as a solution comprising a few very high confidence matches. The latter is typically what we would see if a vehicle actually appears several times, especially if the license plate matching and/or embedding matching is strong.

Consequently, the variance of the sum is of interest. The probability of each possible integer count value P(Σᵢ Xᵢ=n) can be estimated by means of a discrete probability distribution with the following properties:

$$P ( {X}_{i} = 1 ) = {P}_{i}$$

$$P ( i = 0 ) = 1 - {P}_{i} , and$$

$$P ( {\sum }_{i = 1}^{k} {X}_{i} = j ) = P ( {\sum }_{i = 1}^{k - 1} {X}_{i} = j - 1 ) P ( {X}_{j} = 1 ) + P ( {\sum }_{i = 1}^{k - 1} {X}_{i} = j ) P ( {X}_{j} = 0 )$$

Thus, a dynamic programming algorithm that populates the matrix A, with

$${A}_{ij} = P ( {\sum }_{i = 1}^{i} {X}_{i} = j )$$

left to right, top to bottom using the above rules can be used to produce the desired probability distribution. Using the probabilities, it is possible to compute some useful “width” for the distribution.

In an embodiment, this distribution and interpolation is used to estimate the values n_{low} and n_{high} such that P(Σᵢ Xᵢ<n_{low})=θ_{low} and P(Σᵢ Xᵢ<n_{high})=θ_{high} for some tuning parameters θ_{low} and θ_{high}. In an embodiment, θ_{low}=0.2 and θ_{high}=0.5, with the results sorted based on the low count. This value represents the lower bound for the count, e.g. θ_{low}=0.2 means “we are 80% confident that the true count is higher than this value”. The θ_{high} value is used to prune results, such that θ_{high}=0.5 means that “we are 50% confident that the value is lower than this.” In some embodiments, results where n_{high}<1 are pruned out from further analysis to speed up processing.

The fuzzy count value obtained this way is sensitive to the shape of the distribution in the following way. For a binary distribution (i.e., Pᵢ∈{0,1}∀i) this value matches the count exactly. In general, the parameter θ_{low} controls how “sharp” the distribution needs to be. For θ_{low}=0, n_{low} will be the number of entries for which Pᵢ=1 and as θ_{low} approaches 1 it approaches the number of entries for which Pᵢ>0.

Using the full distribution allows for a variety of alternative approaches for meaningfully ranking the reference identities by order of the expected number of segments in which they appear.

In an alternative approach, good results can also be achieved by using, as a ranking measure the number of segments matching above a predetermined confidence level. A variant of this approach is to compare the confidence of the Nth best matching segment to the confidence threshold. It will be appreciated that, if the confidence for the Nth segment exceeds the threshold, then there are N−1 matching segments that have higher confidence values. Since the probability of vehicles or other objects of interest appearing randomly in multiple segments decays exponentially, using the Nth best confidence reduces the number of candidates for human review by a factor proportional to CAN where c is a value between 0 and 1. For example, using the second or third best confidence works well in practice. Higher numbers for N further reduces the data, but as N increases, the risk of discarding an actual vehicle or other object of interest increases.

To produce “search” results provided to a human analyst, the above method is used in some embodiments to determine the reference embedding that is expected to produce the highest count of segments in which it appears through exhaustive search over all tracklets. In an embodiment, this process can run in the background continuously, always repeating with the inclusion of all tracklets collected while the previous analysis was running. Parts of the computation can also be cached to reduce computational complexity.

The segments are then ranked against this reference identity, by the order of maximum probability of the vehicle appearing in that segment (i.e., Pᵢ) which can be estimated in various ways, for example by using the highest matching probability over all the tracklets in the segments, which is invariant to the number of tracklets in the segment and therefore not so sensitive to potential splitting of identities to multiple tracklets within the segment. This produces the rows of the search result.

Each row shows samples from the segment, ranked by similarity to the reference vehicle where similarity is based on the confidence value. Each entry is a thumbnail, representative of a tracklet. The thumbnail is the image associated with the embedding that is closest to the reference embedding as explained hereinabove.

For at least some embodiments, this can thus be thought of as a three fold process:
Find a reference tracklet that is expected to appear in the most number of segments
Rank segments (top to bottom) based on likelihood of having at least one observation of the reference vehicle
Rank tracklets within each segment (left to right) based on similarity to the reference embedding

One problem with this approach is that, if the process is repeated to find the “second best” reference tracklet, the result is usually another representative of the top reference tracklet. This can be overcome by removing all tracklets within a predetermined threshold of the top-reference tracklet and then repeating the three fold process from the beginning.

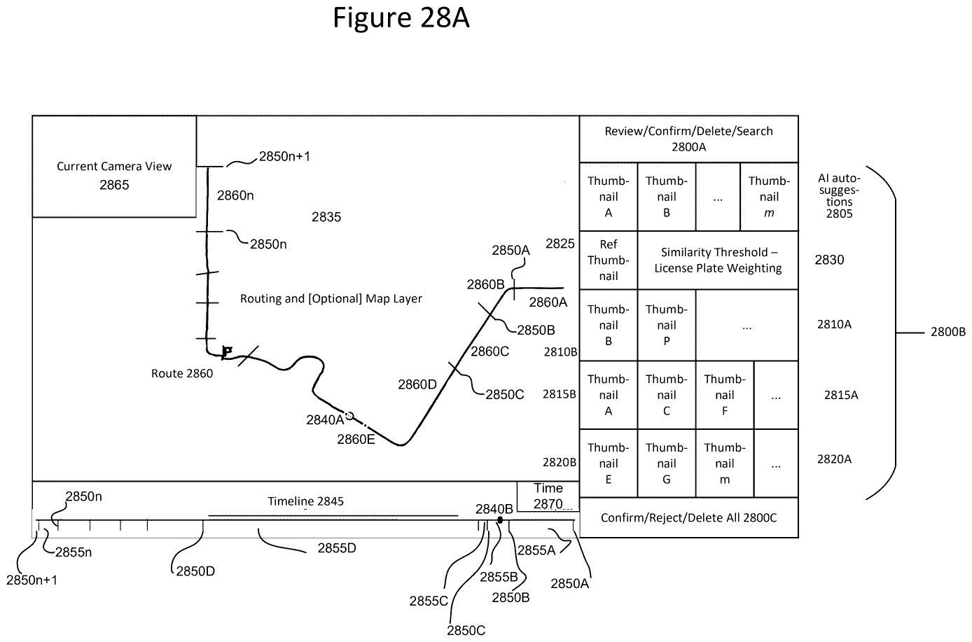

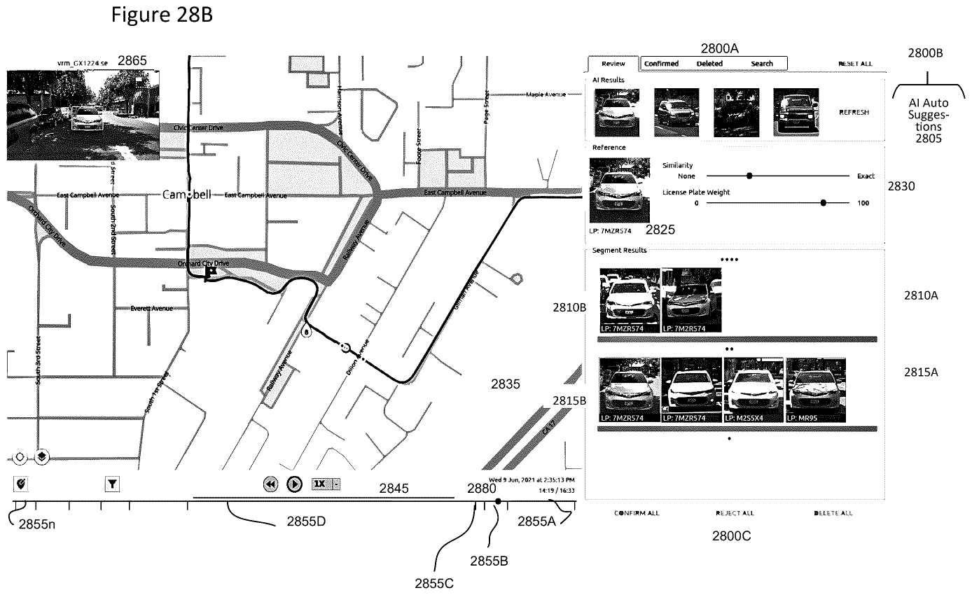

In an embodiment, the results of this iterative approach are displayed to the user as a series of thumbnails, representative of a tracklet. FIG. 28A shows a greatly simplified example of the display provided to the user by an embodiment of the system, reduced in detail for the sake of clarity where a more robust display is shown in FIG. 28B. A series of tabs, shown at 2800A and comprising Review, Confirm, Delete and Search, determines which thumbnails are shown in an “Observations” portion of the display indicated at 2800B. The Observations portion 2800B comprises a series of rows of thumbnails indicated at 2805, 2810A, 2815A and 2820A. Initially, the display begins in “Review” mode, in which case the row 2805 shows a group of thumbnails that the system automatically suggests as the most likely to be of interest as the result of the analysis discussed above. In an embodiment, the thumbnails in row 2805 are selected because those vehicles were determined to have appeared in multiple segments, and are ranked according to the number of segments in which they were determined to have appeared. Initially, the first vehicle in row 2805 is displayed as a reference vehicle 2825, but the reference vehicle 2825 can be changed by the user by clicking on any of the displayed thumbnails or a vehicle selection in connection with the Search function discussed below. The rows 2810A, 2815A and 2820A comprise a “Route Segment Results” portion of the display, where each row displays possible detections of the reference vehicle within a particular route segment, indicated as 2810B, 2815B, and 2820B, respectively, with the rows ranked according to likelihood that the reference vehicle appeared in that route segment. Thus, row 2810A shows thumbnails of vehicles that the system determines are the most likely to be the same as the reference vehicle 2825 and which appear in route segment 2810B. Row 2815A shows thumbnails of vehicles that appeared in route segment 2815B and determined by the system to be similar to the reference vehicle 2825 but with less confidence than the vehicles displayed in row 2810A. Similarly, row 2820A shows thumbnails of vehicles that appeared in route segment 2820B and that the system determined to be similar to the reference vehicle 2825 but with less confidence than the vehicles appearing in route segment 2815B. The confidence thresholds separating the rows can be established in any convenient manner, such that each row includes a range of confidence values. Thus, in FIG. 28A, row 2810A shows that there are two appearances in segment 2810B of vehicles determined with high confidence to be the same as reference vehicle 2825, three appearances in segment 2810B of vehicles determined with lower confidence to be the same as the reference vehicle, and three appearances in segment 2820B of vehicles determined with still lower confidence to be the same as the reference vehicle. Within each row, the thumbnails are organized according to confidence level within the range of that row.

At 2830 is shown an adjustable threshold control for varying the weighting assigned to license plate reads versus vehicle embeddings, and the displayed thumbnails are automatically updated as the weighting is changed by the user. The number of vehicles in row 2805 can be any suitable number, with four as just one example, and can be varied by the user. Further, the contents of row 2805 update automatically as the user takes action on any thumbnail in that row, such as by discarding an observation by deleting that thumbnail, or confirming a vehicle as being of interest, using the selection buttons shown at 28000, below the Segment Results portion of the display. The buttons at 28000 can also be used to confirm, reject, or delete all of a row by, for example, shift click or other convenient technique. The value of N can be varied, and can, for example, be three, four, or other number appropriate to the route and implementation. If the “Confirmed” tab at 2800A is selected rather than the “Review” tab, the row 2805 displays vehicle observations that have been confirmed as being of interest. If the “Deleted” tab at 2800A is selected, row 2805 shows vehicle observations that have been discarded. The “Search” tab at 2800A enables the user either to enter a partial or complete license plate number, or to select any vehicle appearing in the video, either of which causes the system to search for vehicles with similar license plates or with similar appearance to the selected vehicle.

In these types of search problems, the probability that the correct result is among top-N rankings is considerably higher than the probability that the most likely match provided by the system is an exactly correct one. In at least some embodiments, this property can be leveraged in several ways to provide a human operator the information necessary to assist in rapidly identifying a vehicle of interest (or person, if the objects being monitored are people as discussed above, or other object.) As discussed above for row 2805, the system picks multiple possible reference identities. As long as a good reference embedding has been picked by the system for the row 2805 that can be displayed on the user's screen, a human operator has a good chance to spot a vehicle of interest (or person or other object of interest.) By presenting a top-N number of segments, and as long as there are a few good route segments displayed, i.e., rows 2810A-2820A, the human or AI analyst is highly likely to see a few instances of the same vehicle in the Segment Results. Finally, for each segment, the analyst is presented a display of a top-M number of thumbnails, so if there are multiple potential matching tracklets in each segment and the correct one (or ones) is in the top-M, the analyst has been provided the desired output.

Still referring to FIG. 28A, to the left of the “observations” portion 2800B is a map portion 2835 where an icon 2840A marks the current position of the lead vehicle on its route 2860, as well as a timeline 2845 where a dot 2840B marks the current location of the lead vehicle. Also marked on the timeline 2845 are route segment boundaries 2850A-n and the route segments defined by them marked 2855A-n, with the corresponding route segments on the map indicated at 2860A-n. Thus, route segments 2810B, 2815B, and 2820B correspond to various ones of segments 2860A-n, e.g., 2810A might correspond to 2860B, 2815A might correspond to 2860E, etc. Not shown, due to size limitations, are markers 2840B-n for a predetermined number of vehicles, for example sixty-four, detected in each segment. A user can select any marker, and a thumbnail of that vehicle will pop up, at which time the user can confirm, reject, or delete the vehicle designated by that marker. A rejection designates that vehicle as not the same as the reference vehicle, but retains the vehicle for future searches, while a deletion is used to remove parked vehicles, or an object mistakenly identified as a vehicle from any further consideration. By selecting any point on the timeline 2845, or any point on the route 2860, at least one camera view, typically but not necessarily the camera view to the rear, corresponding to that time is displayed at 2865, and the time corresponding to that view is displayed at 2870. The camera may capture vehicles that did not appear among those in any of the rows 2800A, but which are of interest to the user or other operator. In such an instance, the user can select that vehicle, which in at least some embodiments is enclosed within a bounding box, which causes that vehicle to become the reference vehicle and further causes the system to perform a search and analysis for that vehicle in the same manner as described above.

FIG. 28B shows a more detailed version of FIG. 28A, with the same elements assigned the same reference numbers although map segment markings 2860A-n are omitted on FIG. 28B to preserve clarity. FIG. 28B shows the map overlay combined with GPS data discussed above in connection with FIG. 20, together with thumbnail vehicle images arranged as discussed above. The thumbnails can also display the license plate or whatever portion thereof has been successfully identified to assist the user is confirming, rejecting or deleting a given observation. The arrangement of ranked thumbnails based at least in part on confidence values is analogous to the layout of images discussed in connection with FIGS. 14A-15D. Those skilled in the art will appreciate that, even though the system may incorrectly determine that some detected vehicles are likely to be the same as the reference

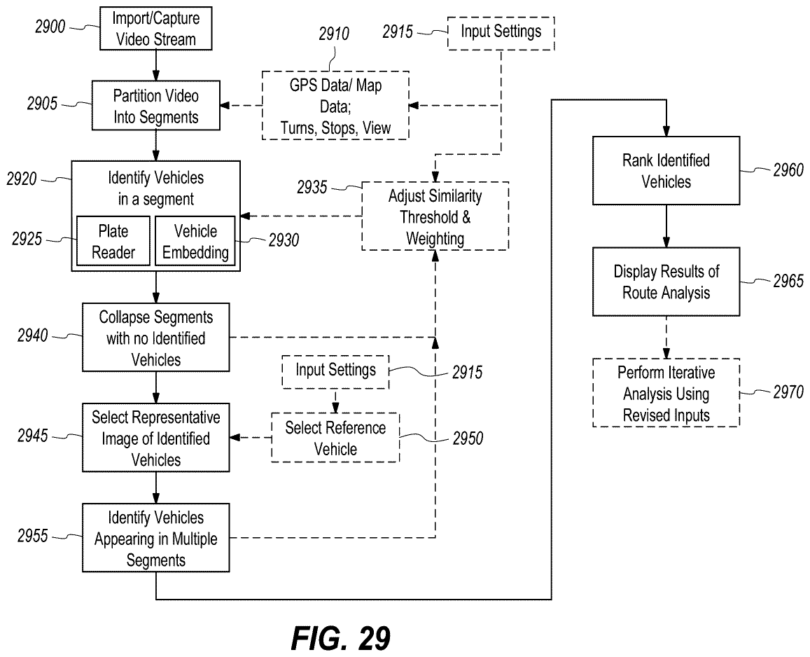

Referring next to FIG. 29, the operation of an embodiment of the system is summarized together with various options, where the detection and identification of vehicles is used as an example. Thus, at step 2900 a data stream such video is either captured, for near-real time processing, or retrieved for embodiments using post-processing. The video captures a vehicle moving along a route, and at 2905 the route is partitioned into route segments based on turns or other criteria, as discussed previously herein. Optionally, as shown at 2910, GPS data and/or maps may be overlaid on the routing. Likewise, based on input settings from an operator, 2915, the identification of turns, stops, map centering, or zoomed in/out view can, optionally, also be provided. Once the route has been partitioned into route segments, vehicles in each segment are identified, 2920, by either reading the license plate (2925) or through vehicle embeddings (2930). The operator-provided settings can adjust similarity threshold, and can also adjust the weighting of the results from the license plate reader versus the vehicle embeddings.

If no vehicles appear in a given route segment, that route segment is collapsed, or withdrawn from further analysis, step 2940. The collapse can also signal the system to adjust recognition thresholds, in some embodiments, via step 2935. A representative image of identified vehicles is selected at step 2945. The representative image can, in at least some embodiments, be a thumbnail image with a larger image available by selection of the thumbnail. A reference vehicle can be selected at step 2950, either automatically or based on input settings 2915. Vehicles identified as appearing in multiple segments are then identified at 2955, and ranked, step 2960, for example by number of segments in which an identified vehicle appears. The outcome of step 2955 can also signal that an adjustment in similarity threshold or weighting may be desirable, either based on an AI analysis or on input settings, as discussed hereinafter. The ranked representative images, and the representative image if one has been selected, are then displayed for review, 2965, and, potentially, further processing by an operator, which can be either a further AI algorithm or a human user, 2970.

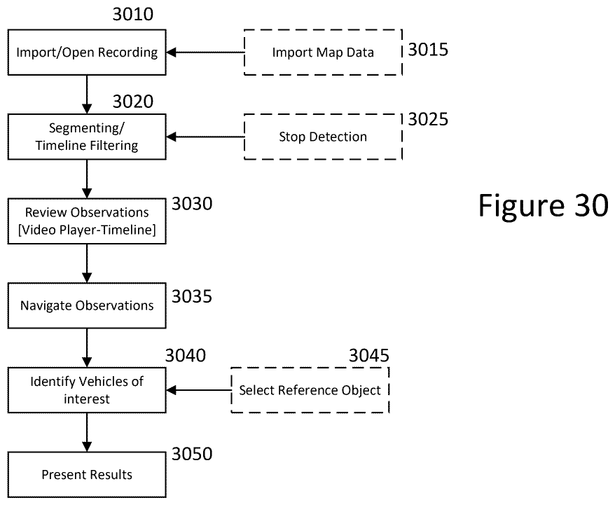

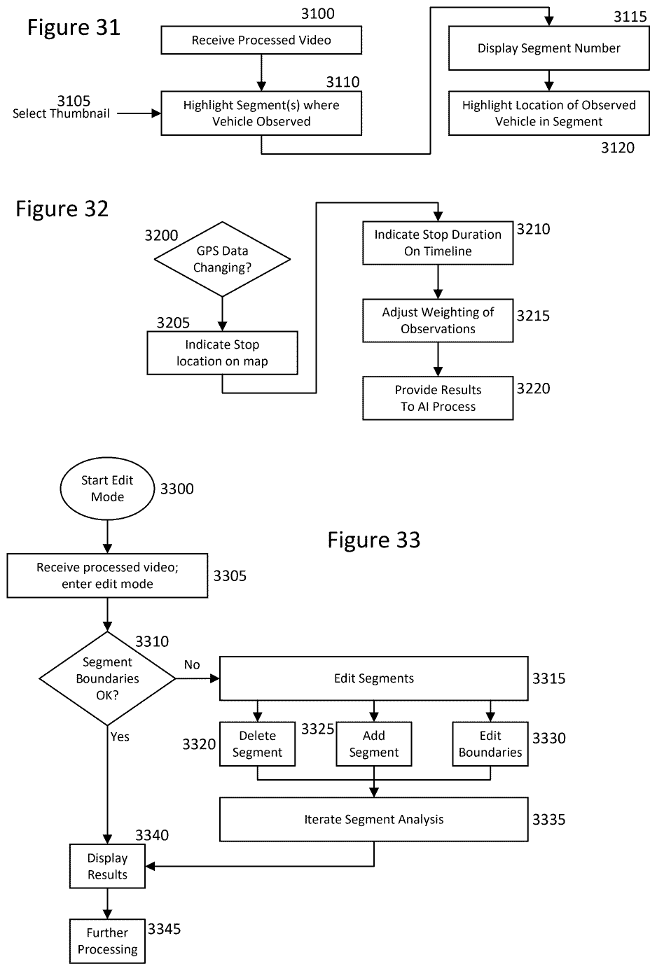

Next, with reference to FIG. 30, a generalized depiction of a user interface in accordance with an aspect of the invention is shown. At step 3010, a processed data stream based on input from at least one camera is displayed to an operator, further discussed in connection with FIG. 31. In an embodiment, the processed data stream substantially conforms to FIG. 28A. Optionally, map data can be overlaid as shown at 3015, and shown in greater detail in FIG. 28B. As shown in FIGS. 28A-28B, the route 2860 and a timeline 2845 for that route are displayed to enable revision of route segment boundaries as well as additions or deletions of route segments as shown as 3020 and discussed in greater detail in connection with FIG. 33. Optionally, detection of stops can be enabled as route segment boundaries, indicated at 3025 and explained in greater detail in connection with FIG. 32. Then, at step 3030, an operator can review the observations of vehicles determined by the invention as being of interest. To enable more thorough review of a portion of a route, step 3030 also permits selection of only specific route segments 2860A-n and the corresponding portions 2855A-n of the timeline 2845. The video displayed to a human operator can also be zoomed in or out for easier review.

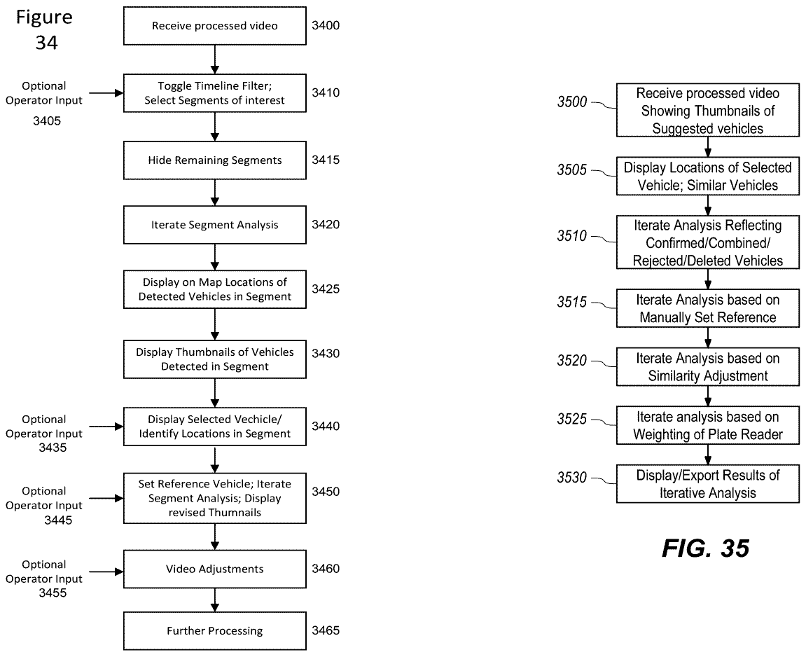

At step 3035, the observations—detections and identifications of vehicles—can be navigated by the user as explained in greater detail in connection with FIG. 34. At step 3040, an operator is able to review the vehicles identified by the previous iterations of the route processing, and to revise the identifications as well as selecting a reference vehicle, shown at 3045 as further explained in connection with FIG. 35, below. Finally, results of the iteratively processed video data stream, specifically the ranked vehicles, route information and other data shown in FIGS. 28A-28B, is displayed for the operator at 3050, enabling a decision maker to rapidly assess the final identifications and rankings and to act accordingly.

FIG. 31 illustrates the initial stages of an operator's review of the route and vehicle identifications provided by an embodiment of the system of the present invention. At 3100 the user interface receives processed video, which can be a data stream processed in near real time, or a previously captured and processed data stream. At 3110 route segments are displayed and route segments where vehicles have been observed are highlighted or identified in any other convenient manner, and the location of the lead vehicle is indicated substantially as shown in FIGS. 28A-28B.

Next, FIG. 32 provides an embodiment of a process for determining stops of a lead vehicle along a route, and detecting any vehicles that also stop analogous to tracking a trailing vehicle through a turn. At 3200 a check is made to determine whether the location data for the lead vehicle, such as GPS data, is changing. If yes, no stop has occurred. If no, a stop has occurred and the stop location is indicated on the map, step 3205. Stop duration is displayed on the timeline, 3210, after which at 3215 the operator is afforded the opportunity to adjust the weighting of observations. The results are forwarded to the system's processing at step 3220.

At FIG. 33, an embodiment of a process for revising segment boundaries is shown, including editing/moving one or more segment boundaries, adding one or more new segment boundaries to create a new segment, or deleting segment boundaries. After a start at 3300, processed video data is accessed, 3305, and a check is made at 3310 where a “yes” allows the operator to leave segments as they are, while a “no” enable an operator to enter edit mode and to choose to revise segment boundaries and the associated segments. If the segment boundaries are to be modified, the process branches to 3315 where the operator is permitted to delete a segment, add a segment, or edit segment boundaries, shown at 3320, 325 and 3330, respectively. During editing, the route segments and associated boundary markers can, optionally, be highlighted or otherwise made more easily identifiable by color change, blinking or other suitable indicia. Point-selectable icons or other indicia for adding, deleting, etc., can be displayed at any convenient location on the display, but are omitted from FIGS. 28A-28B to improve clarity.

The segment boundaries 2850A-2850n+1 can be moved by clicking on the relevant boundary marker on the timeline, and dragging the marker to its new location. The corresponding boundary marker will automatically move to the appropriate location on the route shown in the map portion. Alternatively, the segment boundary markers can be moved on the map, and the corresponding marker will move on the timeline. A new segment can be added by selecting, using a mouse or other pointer, a location on either the map or the timeline where a boundary marker does not already exist and choosing “add” by, for example, depressing the “+” key or selecting the “+” icon on the screen. A new boundary marker then appears on both the map and the timeline, and the segment numbering automatically updates. This approach allows a single route segment to be divided into two or more route segments, etc. Similarly, a boundary marker can be deleted by selecting a boundary marker and depressing the “−” key or selecting the “−” icon.

To limit the system's automated analysis to less than the entire route, one of the boundary markers 2850A-2850n+1 can be designated as a “start” marker and another as an “end” marker, where the start and end boundary markers can be identified either by different icons, different colors, or other suitably distinguishing indicia. Alternatively, “start” and “end” markers can be provided in addition to boundary markers 2850A-2850n+1. Segments outside the “start” and “end” markers will not be excluded from subsequent analysis. Once the route segment boundaries are revised, the system iterates the analysis of the data stream in accordance with the revisions made by the operator at steps 3320, 3325 and 3330, and at 3340 updates the observations displayed in FIGS. 28A-28B. If no segment boundaries were to be modified, i.e., a “yes” outcome at step 3310 also displays at 3340 the results observations based on the analysis where no segment boundaries have been altered. The process then advances to permit further processing, step 3345.

FIG. 34 illustrates in flow diagram form an embodiment of a process by which a subset of a route can be examined, either by selecting a portion of the timeline or, alternatively, a portion of the route on the map. A suitable icon, such as a funnel or other indicia, can be provided to indicate entry into a timeline edit mode, and clicking on that icon toggles route or timeline filtering. In such a filtering mode, a filter bar can be overlaid on timeline 2845 of FIG. 28A, with separate start and end indicia adjustable in substantially the same manner as boundary markers. The filter bar and associated start and end markers are omitted from FIG. 28A to minimize clutter and improve clarity. The vehicle observations will update based solely on segments within the filtered portion of the timeline. In at least some embodiments, including a plurality of route segments within the filtered portion of the route is desirable for yielding a more accurate analysis. For example, including at least three segments in any filtered analysis is preferred to yield higher confidences that an observed vehicle is in fact trailing the lead vehicle. It will be appreciated that, in at least some instances, the filtered portion of the route will encompass the entire route. In an embodiment, by default the filter boundaries will be the entire route.

Still referring to FIG. 34, in an embodiment the process starts at 3400 where processed video is accessed, and at 3410 the filtering mode is toggled on and route segments of interest are selected. The remaining segments are then hidden, 3415, and the observations are updated at 3420 by iterating the analysis of the data stream based on just that portion of the route. Optionally, at 3425 the display on the map can be updated to indicate where observed vehicles were detected in each segment, and the timeline may be likewise updated with indicia unique to each observed vehicle. Thumbnails of observed vehicles are displayed in the observations portion, step 3430. In the event the operator selects a specific vehicle for review, at 3440 that thumbnail can be displayed in the map portion and the route segments in which that vehicle appears can be highlighted or otherwise made distinguishable on the map and timeline of FIGS. 28A-28B. Further, the location of the selected vehicle within each segment can be highlighted or otherwise indicated. The operator may select a plurality of vehicles in sequence or, in some embodiments, can select a plurality of vehicles where the location of each selected vehicle is distinguishably identified on the map and/or timeline. In this manner teams can be more easily identified. Following such operator analysis, the operator is able to set a reference vehicle at 3450, which in turn causes the analysis to iterate and updated observations are displayed. In an embodiment, at 3460 the camera image or any other portion of the display can be increased or decreased in size via a zoom functionality. Further processing can then proceed, step 3465.

Referring next to FIG. 35, an embodiment of a process by which an operator can review and confirm, delete, or otherwise characterize the vehicle observations provided automatically by the system. FIG. 35 will again be best understood when considered in combination with the displays of FIGS. 28A-28B. At 3500, processed video is accessed and observations made automatically by aspects of the invention discussed previously are shown as thumbnails of vehicles of interest, and may, for example, be vehicle observations identified by the above-discussed aspects of the invention as most similar to a reference vehicle as discussed at step 3450 (FIG. 34). Typically, a plurality of “suggested” vehicle observations will be displayed in the section marked 2805 on FIG. 28A, and, during the initial stage, that section may be enlarged to show any number of suggested vehicles appropriate for a given implementation. For example, in an embodiment, as many as sixty-four thumbnails may be provided for operator consideration, although on a given route far fewer vehicles may be automatically suggested as being of interest.

In comparing vehicles of interest to a reference vehicle, the operator can confirm, reject, defer, or otherwise characterize each of the suggested vehicles as being the same as, or different from, or unable to decide, etc. The suggested vehicles can be characterized either individually or in one or more batches. As suggested vehicles are characterized, e.g., confirmed as being the same as the reference vehicle or rejected as being different from the reference vehicle, the observations portion of FIGS. 28A-28B automatically update, shown at 3510. Further, confirmation creates an association between the reference vehicle (thumbnail) and the segment result observations, and moves the confirmed vehicle into one of the “observed in” displays shown at 2810-2820 of FIG. 28A. If a vehicle is confirmed, in an embodiment a dialog will present, asking whether the vehicle is a new confirmed vehicle, or is another instance of a vehicle previously confirmed in a different segment. As the same vehicle is confirmed as being in more segments, that vehicle is moved upwards within the displays 2810-2820, where 2810 shows the most frequently observed vehicles. Similarly, observed vehicles from the same segment can be merged if determined to be the same vehicle. Confirmed vehicles can also be ranked by the operator, for example by being starred, numbered, or otherwise ranked as being of special interest, to facilitate easier subsequent review.

The reference vehicle can also be changed by operator action, 3515, in which case the observations automatically update to show suggested vehicles relevant to the newly-selected reference. For example, while reviewing the suggested observations, the operator may determine that one of those suggested is a better representation of a vehicle of interest than the previously selected reference, and updated the choice of reference vehicle will simplify and improve subsequent analysis. Likewise, the similarity threshold can be adjusted, step 3520, or the relative weighting of the license plate reader versus vehicle embeddings can be adjusted, 3525, where in each case an iteration of the automated analysis occurs and the displayed observations are automatically updated accordingly. The results of that iterative analysis is then displayed or exported, step 3530.

It will be appreciated that the steps shown in the Figures, for example FIGS. 30-35, can be performed in a different order than shown, and the sequence presented in those figures is shown in that order primarily for convenience. Likewise, at least some of the steps shown are optional and can be omitted altogether in some implementations of the invention. The order in which either shown or described herein is not to be taken as limiting either in terms of sequence or their use at all. Having fully described a preferred embodiment of the invention and various alternatives, those skilled in the art will recognize, given the teachings herein, that numerous alternatives and equivalents exist which do not depart from the invention. It is therefore intended that the invention not be limited by the foregoing description, but only by the appended claims.

1. A method for tracking movement of an object through a route comprising the steps of
dividing the route into a plurality of route segments where the route segments are determined at least in part by one of a turn in the route, GPS data, map data, stops, and view,
receiving a sequence of images representative of at least one object visible in at least one route segment,
for at least some images in the sequence of images, identifying one or more of the at least one object by developing a representative embedding of each identified object,
determining the number of segments in which each identified object appears based at least in part on the embeddings, and
providing a representation of each identified object together with an indicia representative of the number of route segments in which that identified object appears based at least in part on the representative embeddings.

2. The method of claim 1 wherein each of the at least one object is a vehicle.

3. The method of claim 2 the vehicle has a license plate and further comprising the step of determining the characters on the license plate of at least some of the vehicles.

4. The method of claim 3 further comprising the step of using synthetic data to assist in determining the characters.

5. The method of claim 3 further comprising the step of improving a confidence value in the determination of the characters of a license plate by combining the determination of the characters of that license plate in a plurality of frames.

6. The method of claim 1 wherein each of the at least one object is a person.

7. The method of claim 1 further comprising the step of developing a tracklet of images of an identified object for each route segment in which the identified object appears.

8. The method of claim 7 further comprising the step of selecting a representative image of an identified object for each tracklet in which the identified object appears.

9. The method of claim 8 further comprising the step of ranking the identified objects based at least in part on the number of segments in which each identified object appears.

10. A method of identifying vehicles following a lead vehicle comprising the steps of
providing a sequence of images that capture a view of a roadway behind a lead vehicle,
partitioning the sequence of images into route segments based at least in part on at least one of GPS data, map data, turns, stops, and view,
if any vehicles appear in a route segment, identifying one or more such vehicles by at least one of reading a vehicle license plate or detecting unique or anomalous details, and developing an embedding representative of each identified vehicle,
developing a thumbnail image representative of each identified vehicle,
ranking the identified vehicles based at least in part on the number of route segments in which an identified vehicle appeared.

11. A system for permitting a user to rapidly assess one or more identified trailing objects observed by a lead object comprising
a display comprising a route traveled by a lead object and indicating a plurality of route segments, a timeline of the route, a plurality of representative images organized according to the identified trailing objects that appeared most frequently among the route segments,
a user interface for permitting the user to selectively examine one or more of the appearances of each trailing object in the timeline and one or more of the appearances of each identified trailing object in each route segment.

12. The method of claim 10 wherein the step of reading the vehicle license plate or detecting unique or anomalous details comprises training a machine-learned model through the use of synthetic data.

13. The method of claim 10 wherein the step of reading the vehicle license plate further comprises assessing each character of the license plate in a plurality of frames.

14. The method of claim 10 wherein the step of detecting unique or anomalous details comprises assessing such details in a plurality of substantially consecutive frames.

15. The method of claim 10 wherein the step of reading the vehicle license plate further comprises computing a confidence value for each character shown on the license plate.

16. The method of claim 15 wherein computing a confidence value further comprises aligning the appearances of a character shown on the license plate across multiple images in the sequence of images.

17. The method of claim 10 further comprising excluding from further analysis vehicles unlikely to be of interest based on a determination of a lack of relative motion of an identified vehicle with respect to the lead vehicle.

18. The system of claim 11 wherein each of the representative images is determined from a plurality of tracklets, a representative image is determined for each such tracklet, and the user can selectively view each representative tracklet image and an associated sequence of images from which the tracklet was developed.

19. The system of claim 11 wherein the trailing objects are identified through the use of a machine-learned model.

20. The system of claim 11 wherein the trailing objects are one of people or vehicles.
